(19) United States
(12) Patent Application Publication
(10) Pub. No.: US 2022/0320597 A1
(43) Pub. Date: Oct. 6, 2022

(54) IN-SITU REGENERABLE PROTON-ZINC BATTERY

(71) Applicant: Hunt Energy Enterprises, L.L.C., Dallas, TX (US)

(72) Inventors: Fantai Kong, McKinney, TX (US); Denyce Alvarez, Little Elm, TX (US); Nestor Orlando Pimentel Solorio, Dallas, TX (US); Jin-Myoung Lim, Coppell, TX (US)

(21) Appl. No.: 17/713,066

(22) Filed: Apr. 4, 2022

Related U.S. Application Data
(60) Provisional application No. 63/170,204, filed on Apr. 2, 2021.

(51) Int. Cl. H01M 10/36; H01M 10/42; H01M 10/0563; H01M 10/48

(52) U.S. Cl. CPC H01M 10/36; H01M 10/425; H01M 10/0563; H01M 10/484; H01M 2010/4292

(57) ABSTRACT

Zinc ion battery systems and methods for battery regeneration are disclosed. The Zinc ion battery system includes a battery including a plurality of cells, each cell including a cathode comprising cathode electrode materials disposed on a current collector, an anode comprising anode electrode materials disposed on a current collector, a separator or spacer disposed between the cathode and the anode, an electrolyte to fill the battery in the spaces between electrodes and an electrolyte circulation system.

### CROSS REFERENCE TO RELATED APPLICATIONS

This application claims priority to U.S. Provisional Application No. 63/170,204 filed Apr. 2, 2021 entitled “In-Situ Regenerable Proton-Zinc Battery” by Fantai Kong, Denyce Alvarez, Nestor Orlando Pimentel Solorio, and Jin-Myoung Lim, the contents of which are hereby incorporated by reference

### TECHNICAL FIELD

This disclosure relates to energy storage devices and electrical storage in general.

### BACKGROUND

Renewable energy sources such as wind and solar are becoming much more prevalent in the supply of electrical power to transmission grids. Their variable nature has created electrical transmission grid management problems and crippling downward pricing pressure on renewable power generators. Large scale storage is a potential solution to these problems, but the scale and attendant costs are enormous. As an example, in a single hour, one wind turbine can fully charge ten of the largest capacity electric automobile battery piles available today. These piles represent over ten tons of highly engineered and expensive materials for merely one hour of electric service. Even though Li ion batteries are the major rechargeable battery technology applied to EV applications, supplies of critical metals (e.g., Li, Ni, Co) are already creating concerns on the future growth of EV fleet which is projected to reach 500 million vehicles by 2040. Moreover, Li ion batteries utilizing flammable electrolyte expose high fire risk upon large scale deploy. Even larger scale energy storage applications are needed for grid scale energy storage which will enable the intermittent generation from solar and wind power sources to supply steady electricity over the power grid. To achieve such long-term energy storage goals, it would be important to develop energy storage system composed of earth abundant elements and nonflammable materials. For example, Zn, H, Mn, and O are very abundant elements in the earth crust and atmosphere, and these elements can be combined to operate at aqueous Zn ion battery without any practical limitations of critical metals currently used in Li ion batteries. However, energy storage requires over 5000 cycling stability at duration 1 hour to 10 hours scope and conventional Zn ion batteries normally cannot achieve such stability with low capital or operational costs.

### SUMMARY OF THE INVENTION

A battery technology enabling in-situ capacity regeneration and in-situ battery regeneration is developed for grid scale energy storage. The battery system is using proton and zinc ion as dual charge carriers, and mainly composed of geo-abundant benign materials including MnO₂, Zn metal, and H₂O. The features of the present disclosure on two types of regeneration methods enable the economics and durability of both MnO₂ cathode and Zn anode. These concepts have been proved by demonstrating 3,000-6,000 cycling stability at 1C rate and areal capacities of 0.2-20 mAh/cm². The integrated controllable electrolyte circulation system may effectively improve battery kinetics, suppresses side reaction induced resistance buildup and reduce electrolyte salt consumption. Higher areal capacity of 50 mAh/cm² was achieved as well with electrolyte circulation design. Example batteries of the present disclosure technology shows high cycling durability, wide durations, high safety, low cost, and high recyclability, which are desired for the next generation grid scale energy storage.

Embodiments of the present disclosure include a battery system including a battery comprising a plurality of cells. Each cell includes a cathode comprising cathode electrode materials disposed on a first current collector. Each cell incudes an anode comprising anode electrode materials disposed on a second current collector. Each cell incudes a separator or spacer disposed between the cathode and the anode. Each cell incudes an electrolyte to fill the battery in the spaces between electrodes. The battery comprises an electrolyte circulation system.

In example embodiments of the battery system, the electrolyte circulation system includes a controller with a processor and a memory, the memory including executable instructions that, when executed, cause the processor to control one or more of a circulation time and a circulation frequency.

In example embodiments of the battery system, the controller further includes executable instructions that, when executed cause the processor to control one or more of a flow rates, an electrolyte level, an electrolyte volume, an electrolyte concentration, and an electrolyte composition.

In example embodiments of the battery system, the controller further includes executable instructions that, when executed cause the processor to perform a healing reaction in the battery.

In example embodiments of the battery system, one or more of the first current collector and second current collector comprise conductive materials are selected from the group consisting of carbon paper, carbon cloth, carbon felt, carbon foil, carbon foam, conductive polymers, metal sheet, metal mesh, mesh screen, metal foam, wherein metal in the metal sheet, metal mesh, metal screen, or metal foam includes one or more of Ni, carbon steel, Cr, copper, aluminum, and stainless steel.

In example embodiments of the battery system, the first current collector and the second current collector each include a surface coated in one or more of carbon black, conductive graphite, carbon nanotube, activated carbon, amorphous carbon, conductive polymer, metal particles, Ni, Cr, copper, aluminum, stainless steel.

In example embodiments of the battery system, the cathode electrode materials include one or more of manganese oxide, nickel oxide, vanadium oxide, titanium oxide, iron oxide and further wherein the cathode electrode materials further comprise metal doping selected from the group consisting of aluminum, nickel, lead, magnesium, boron, cobalt, titanium, chromium, vanadium.

In example embodiments of the battery system, the anode electrode materials include one or more of zinc, aluminum, copper, nickel, lead, magnesium, boron, cobalt, titanium, chromium, vanadium, carbon nanotube, carbon black, amorphous carbon, activated carbon, hard carbon, polyvinylidene fluoride (PVDF), polytetrafluoroethylene (PTFE), conductive polymers, and sodium vanadium phosphate.

Example battery systems further include a current collector comprising multiple dimensions of surfaces, metal foam, metal mesh, carbon felt, and cloth.

In example embodiments of the battery system, the anode electrode materials are coated with conductive polymers, oxides, carbides, carbon, surfactants.

In example embodiments of the battery system, the electrolyte includes one or more solvents selected from the group consisting of water and organic solvents, one or more additive cations selected from the group consisting of Zn2+, Mn2+, proton, Al3+, Na+, K+, Mg2+, Ni2+, Cu2+, Fe3+, Co2+, and NH4+; and anions selected from the group consisting of PO43−, SO42−, CH3COO−, Cl−, Br− and NO3−; and one or more polymer additives selected from the group consisting of ionomers, pyrrole, aniline, carbonate, vinyl acetate, ethylene glycol, and methyl methacrylate.

In example embodiments of the battery system, the separator includes one or more of filter paper, fiberglass paper, fiber cloths, cellulose, wood fibers, polyethylene separator, and plastic mesh.

In example embodiments of the battery system, the electrolyte circulation system comprises one or more of liquid transfer tubes connected to battery case, pumps, propellers, circulation controllers, valves and liquid tanks.

In example embodiments of the battery system, the pump comprises one or more of a rotary lobe pump, a progressive cavity pump, a rotary gear pump, a piston pump, a diaphragm pump, a screw pump, a gear pump, a hydraulic pump, a rotary vane pump, a peristaltic pump, a rope pump, a flexible impeller pump, and a magnetic pump.

In example embodiments of the battery system, the circulation controller is configured to determine one or more of battery voltage, current, capacity, power, time to control the pump on/off time/frequency and flow rate.

In example embodiments of the battery system, the electrode includes a current collector, electrode materials, and an interface coating layer in-between.

In example embodiments of the battery system, the interface coating includes one or more of a conductive polymer, carbon nanotubes, black carbon, graphite, carbon fibers, indium tin oxide, indium oxide, tin oxide, lead oxide, and tungsten carbide.

Embodiments of the present disclosure include a battery regeneration method, the method including etching an anode by providing an anode etching liquid in a battery case, etching a cathode by providing an cathode etching liquid in the battery case, regenerating an anode by providing an anode regeneration liquid in the battery case, and regenerating a cathode by providing a cathode regeneration liquid in the battery case.

In example embodiments of the battery regeneration method, one or more of the anode etching liquid or the cathode etching liquid include one or more acidic solvents selected from the group consisting of hydrochloric acid, sulfuric acid, nitric acid, phosphoric acid, oxalic acid, citric acid. Example of the method further include preforming one or more physical treatments selected from the group consisting of applied electric field, heating, circulation, and sonication during etching.

In example embodiments of the battery regeneration method, one or more of the cathode regeneration liquid and the anode regeneration liquid include one or more solvents selected from the group consisting of water and organic solvents; additive cations selected from the group consisting of Zn2+, Mn2+, proton, Al3+, Na+, K+, Mg2+, Ni2+, Cu2+, Fe3+, Co2+, and NH4+ and anions selected from the group consisting of PO43−, SO42−, CH3COO−, Cl−, Br− and NO3−; and wherein the method further includes preforming one or more physical treatments selected from the group consisting of applied electric field, heating, circulation, and sonication during regeneration.

In example embodiments of the battery regeneration method, the battery includes a cathode and an anode.

In example embodiments of the battery regeneration method, the battery includes a cathode, an anode and a counter electrode, wherein the counter electrode comprises one or more of stainless steel, graphite, glassy carbon, Ti, Pt and Au.

Example embodiments of the battery regeneration method include heating a solution to between 400° C. and 1200° C. under air, O2, N2 or Argon environment for 1 hour to 24 hours, adding a NaOH salt to the solution for metal solid precipitation; and adding an acid comprising one or more of H2SO4, HNO3 and HCl to dissolve precipitated solid and decomposed metal oxide.

### BRIEF DESCRIPTION OF THE DRAWINGS

These drawings illustrate certain aspects of some of the embodiments of the present disclosure and should not be used to limit or define the claims.

FIG. 1A is a block diagram of an example battery system.

FIG. 1B is a chart of areal capacity versus cycles for the example battery system.

FIGS. 2A-2C are block diagrams of battery systems.

FIGS. 3A-3C are block diagram of battery systems.

FIGS. 4A and 4B are graphs of voltage (V) versus capacity (Ah or mAh) for charging and discharging battery system with and without electrolyte circulation.

FIG. 5 is a battery voltage-capacity profile.

FIGS. 6, 7, and 8 are process diagrams of example onsite or in-situ electrode regeneration.

FIG. 9 is a block diagram of an example cell configuration that can control electrolyte composition and electrolyte liquid switching.

FIG. 10 is a flow chart of an example process for post-treating the etched cathode or anode solution.

FIG. 11 is a battery voltage-capacity profile before and after cathode regeneration

FIGS. 12A and 12B are charts of areal capacity versus cycles of cycling durability test before and after cathode regeneration.

FIG. 13A is a chart of voltage versus capacity for charging and discharging for a battery before and after anode regeneration.

FIG. 13B is a chart of cycling durability test before and after anode regenerations.

FIGS. 14A and 14B are block diagrams of carbon fiber current collectors.

FIGS. 15A and 15B are non-3D current collectors.

FIGS. 15C and 15D are block diagrams of 3D current collectors.

FIG. 16 is a plot of the voltage-time profile of the cell with 3D substrate.

FIGS. 17A-17C are plots of voltage versus test times for cells with 2D and 3D substrates.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRPTION

The innovated concept of introducing a controllable Capacity Regeneration Reaction into battery system is demonstrated to deliver high durability. This reaction is mainly applied to cathode to address the well-known instability challenge of Mn-based materials. For example, the Energy Storage Reaction happens at the cathode is Zn ion battery using manganese oxides as the cathode materials following work reactions on cathode side: xZn²⁺+MnO₂+2xe⁻↔ZnₓMnO₂, yH⁺+MnO₂+ye⁻↔H_{y}MnO₂; and on anode side: Zn↔Zn²⁺+2e⁻. And the example for Capacity Regeneration Reaction is expressed as: Mn²⁺+2H₂O→MnO₂+4H⁺+2e⁻. The electrolyte is mild-acidic aqueous solution with PH range of 4 to 7. It contains 0.5M to 2M ZnSO4 and 0.1M to 0.5M MnSO4. As seen from the reaction, extra MnO₂ can be regenerated to function as fresh cathode materials and provide required capacity. Inc example embodiments, the capacity regeneration reaction requires consumption of Mn salts. The circulation of electrolyte may help to increase the performance of the battery with higher battery kinetics and suppressed battery side reactions. These side reactions may, in turn, increase the electrode resistance and lead to greater need for capacity regeneration reaction and associated Mn salt consumption. With the integration of electrolyte circulation, a concept of in-situ battery regeneration is introduced to regenerate battery performance in a low-cost way and enable the recycling of Zn and Mn salts.

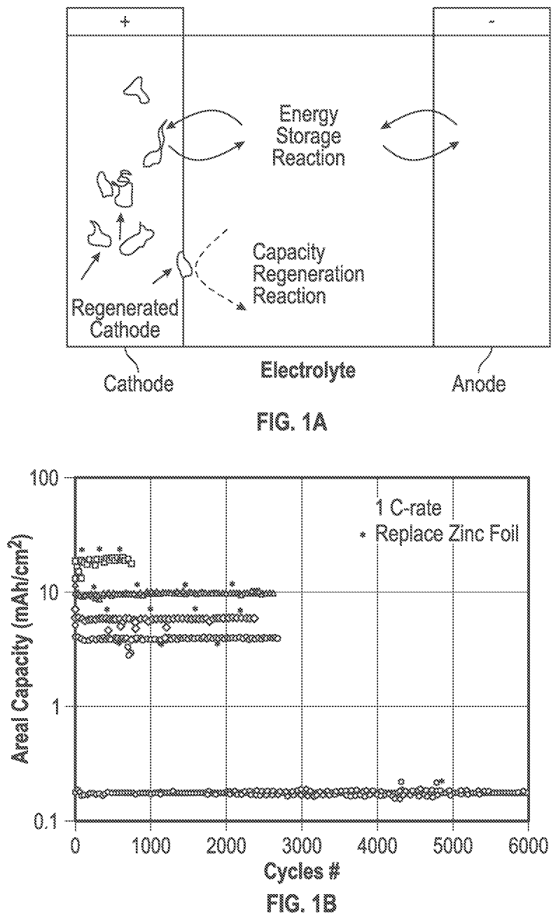

FIG. 1 is a block diagram of an example battery with a cathode 105, anode 110, and electrolyte 115. FIG. 1 show that the battery has both an energy storage reaction and a capacity regeneration reaction to regenerate cathode 105. In some example embodiments, the capacity regeneration reaction is realized with controllable electrode-electrolyte in-situ reaction to generate new active materials for charge storage with control of specific voltage, time and current. This way, capacity loss through cyclic ion intercalation induced lattice change, structure reconstruction, surface degradation, phase conversion, etc., can be compensated by the regenerated capacity from new active materials that enables high durability. FIG. 1B is a chart of area capacity (mAh/cm2) versus number of energy storage cycles of a proof-of-concept battery cycling performance at 1C and various areal capacities (0.2 mAh/cm² to 20 mAh/cm²). The cell adopted beaker setup with excess electrolyte supply for controllable and sustainable capacity regeneration. The cells with 0.2 mAh/cm² have shown 6,000 cycles with no degradation. Higher areal capacities ranging from 4 to 20 mAh/cm² also approach 3,000 cycles with no degradation. During this cycling test, Zn foil reference is used as anode and replaced every few hundred cycles.

In example embodiments of the battery and system, a plate-type cathode and anode are separated by a spacer or separator, composed of filter paper, fiberglass paper, fiber cloths, polyethylene separator, plastic mesh and their combinations. The current collectors may use carbon paper, carbon cloth, carbon felt, carbon foil, carbon foam, conductive polymers, metal sheet, metal mesh, metal foam, wherein metal includes zinc, nickel, carbon steel, chromium, copper, aluminum, stainless steel, and their combinations. The current collector may be coated with electrically conductive materials, such as carbon black, conductive graphite, carbon nanotube, activated carbon, amorphous carbon, conductive polymer, metal particle such as zinc, nickel, chromium, copper, aluminum, stainless steel. To obtain good coating effect, the coating materials may mix with polymer binders such as Polyvinylidene fluoride (PVDF), Polytetrafluoroethylene (PTFE), Polyvinyl butyral (PVB), Carboxymethyl cellulose (CMC), Styrene-Butadiene Rubber (SBR), Poly(ethylene oxide) (PEO), in solvents such as N-Methyl-2-Pyrrolidone (NMP), ethanol, acetone, and water. The resulted slurry may be applied onto current collector through methods such as brush painting, spin coating, blade coating, dip-coating to improve electronic conductivity. The cathode electrode materials comprise manganese oxide, nickel oxide, zinc oxide, magnesium oxide, calcium oxide, or vanadium oxide. The anode electrode materials could comprise zinc, aluminum, nickel, lead, magnesium, boron, cobalt, titanium, chromium, vanadium, graphite, activated carbon, hard carbon, or sodium vanadium phosphate. In example embodiments of the battery and system, electrolyte is filled within the case. The electrolyte comprises aqueous or organic solution composed of cations such as Zn2+, Mn2+, proton, Al3+, Na+, K+, Mg2+, Ni2+, Cu2+, Fe3+, Co2+, Ca2+, NH4+, etc. and anions such as PO43−, SO42−, CH3COO−, Cl−, F−, Br−, NO3−, etc. Electrolyte also may include polymer additives selected from the group consisting of ionomers, pyrrole, aniline, carbonate, vinyl acetate, ethylene glycol, and methyl methacrylate. Between electrodes is the separator which comprises one or more of filter paper, fiberglass paper, fiber cloths, cellulose, wood fibers, polyethylene separator, and plastic mesh.

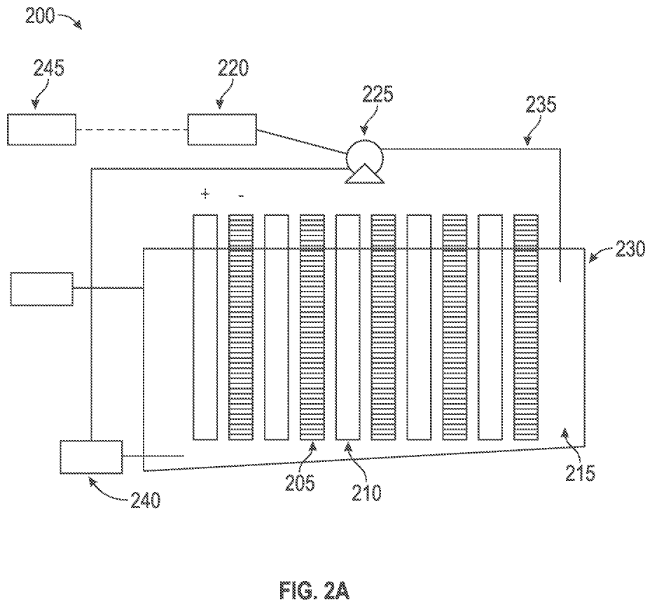

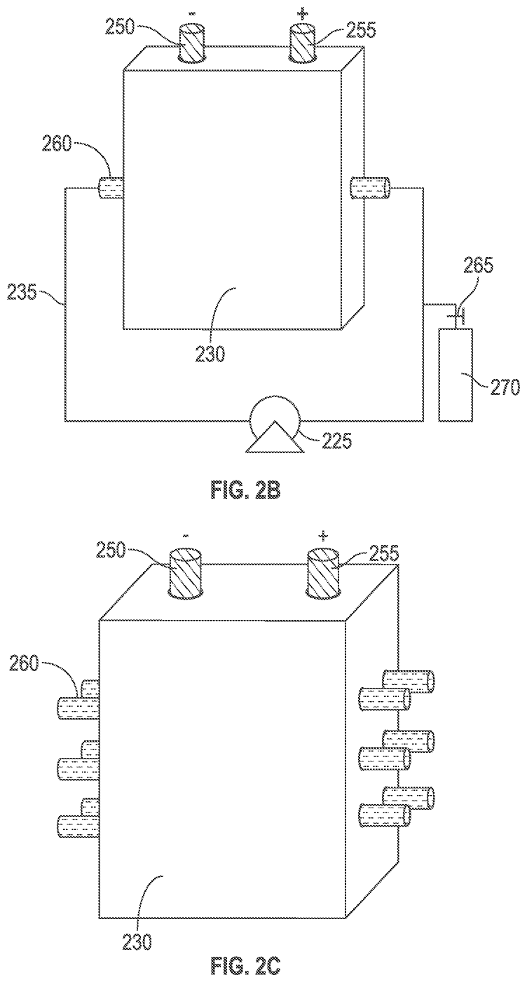

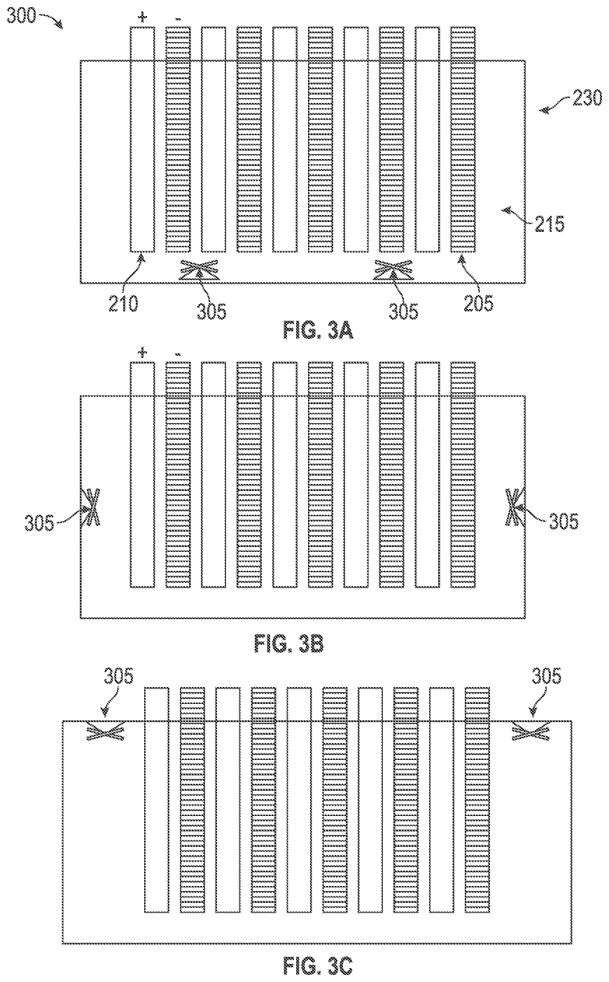

In example embodiments, electrolyte circulation is enabled by pumping or stirring methods by, for example, connecting with the battery case through tubes with a pump. The circulation enhanced the kinetics of the electrolyte both improved the battery performance and the achievement of high areal capacity. In certain example embodiments, the electrolyte circulation may also suppress side reaction at electrolyte-electrode interface that increases the battery performance. With an example Zn ion battery, in which Zn metal is anode, MnO2 is cathode and ZnSO4-MnSO4 mixed solution as electrolyte, during charging/discharging process, a layer of zinc hydroxide sulphate hydrate with formula of Zn₄SO₄-(OH)₆-xH₂O can form at the cathode-electrolyte interface, which increases the electrode resistance. In example embodiments, the layer forms when proton intercalates into the MnO2 and releases extra OH− which then react with ZnSO4 and Zn2+. Zinc hydroxide sulphate hydrate can block efficient transportation of Zn ion, proton, and electron, thus increases the battery resistance. With the applied electrolyte circulation, proton and Zn ion can more efficiently diffuse into the porous surface of the electrode. This enables higher battery kinetics and more efficient dissolution of Zinc hydroxide sulphate hydrate. Moreover, the circulation can wash off inactive electrode materials particles or dendrites that can be transferred to a converter that converts electrode particles into desired ion solution for electrolyte usage. The example configuration of electrolyte circulation enabled by pumping or stirring methods are presented in FIGS. 2A-C and FIG. 3A-C.

FIG. 2A-2C are the examples battery 200 including a pumping system to enable electrolyte circulation. The electrodes of the cathodes 205 and electrodes of the anodes 210 are assembled into a battery case 230 with filled electrolyte 215. The external tubes 235 connect the battery case 230 with a pump 225. Example pumps 225 may be one or more of a rotary lobe pump, a progressive cavity pump, a rotary gear pump, a piston pump, a diaphragm pump, a screw pump, a gear pump, a hydraulic pump, a rotary vane pump, a peristaltic pump, a rope pump, a flexible impeller pump, a magnetic pump. One or more of the pump flow rates, pressure, usage frequency may be controlled by a circulation controller 220 to obtain the desired effect on the battery and the highest system energy efficiency. Example batteries 200 may or may not include a salt converter 240. The salt converter 240 may collect fallen electrode particles, dissolve the fallen electrode particles, for example in acid, such as H2SO4, and then convert the dissolved fallen electrode particles back as sulfate electrolyte. Circulation controller 220 may control pump on/off time and frequency, flow rate, by recording and responding the battery information including voltage, current, time, capacity, power. In example embodiments, the circulation controllers 220 determines the battery voltage such as 1.3V, 1.4V, 1.5 V, 1.6V, 1.7 V, and respond by switching on or off the circulation. Another controller is configured to measure the charging or discharging time and determine when the time reaches a predetermined charging or discharging time, for example, 5 mins, 10 mins, 20 mins, 30 mins, 40 mins, 50 mins, 60 mins, 1 hour, 1.5 hours, 2 hours, 2.5 hours, 3 hours, 3.5 hours, 4 hours, 4.5 hours, 5 hours, 5.5 hours, 6 hours, 6.5 hours, 7 hours, 7.5 hours, 8 hours, 8.5 hours, 9 hours, 9.5 hours, 10 hours. Example circulation controllers 220 then responds by switching on or off the circulation. The example flow rates from the circulation ranges from 1 mL/min/Ah to 10,000 mL/min/Ah with intervals of 1 mL/min/Ah. The example of the frequency of circulation is on during both charging and discharging steps, circulation is on during charging and off during discharging, circulation is off during charging and on during discharging. Whether circulation is on or off may depend on, for example, the voltage of battery. For example, the circulation controller 220 may turn on circulation when the charging voltage reaches 1.5V, 1.6V or 1.7V, and the circulation may continue until charging finishes, and when discharging voltages reaches 1.4 V, 1.3V or 1.2V, the circulation turns on until discharging is finished. The circulation depends on time of charging and discharging. For example, circulation is on for 1 min to 1 hour with intervals of 1 min, then off for 1 min to 1 hour with intervals of 1 min, and repeats the patten until charging or discharging is finished. The battery controller can control the charging and discharging voltage, current, and time. For example, the battery is controlled to charge with a constant current until voltage reaches 1.7 V, 1.71V, 1.72V, 1.73 V, 1.74 V, 1.75 V, 1.76 V, 1.77 V, 1.78 V, 1.79 V, 1.8V, 1.81V, 1.82V, 1.83 V, 1.84 V, 1.85 V, 1.86 V, 1.87 V, 1.88 V, 1.89 V, 1.9V, 1.91V, 1.92V, 1.93 V, 1.94 V, 1.95 V, 1.96 V, 1.97 V, 1.98 V, 1.99 V, or 2.0 V, then hold at this voltage for a constant voltage charging step until reaching target capacity. For example, the battery is controlled to discharge with a constant current until voltage reaches 1.0 V, 1.01V, 1.02V, 1.03 V, 1.04 V, 1.05 V, 1.06 V, 1.07 V, 1.08 V, 1.09 V, 1.1V, 1.11V, 1.12V, 1.13 V, 1.14 V, 1.15 V, 1.16 V, 1.17 V, 1.18 V, 1.19 V, 1.2 V, 1.21V, 1.22V, 1.23 V, 1.24 V, 1.25 V, 1.26 V, 1.27 V, 1.28 V, 1.29 V, 1.3V, 1.31V, 1.32V, 1.33 V, 1.34 V, 1.35 V, 1.36 V, 1.37 V, 1.38 V, 1.39 V, 1.4V, 1.41V, 1.42V, 1.43 V, 1.44 V, 1.45 V, 1.46 V, 1.47 V, 1.48 V, 1.49 V, 1.5 V, 1.51V, 1.52V, 1.53 V, 1.54 V, 1.55 V, 1.56 V, 1.57 V, 1.58 V, 1.59 V, or 1.6 V, then hold at this voltage for a constant voltage discharging step until reaching target capacity. FIG. 2B is showing the configuration with electrolyte circulation enabled by pump. The tube connectors 260 connect conventional battery case 230 with pump 225 and tube 235. The example battery system also includes a liquid refill tank 270 and control valve 265 that can control one or more of the electrolyte level, volume, concentration, and composition. In example embodiments, the battery system may also be configured to add liquid from liquid refill tank 270 at predefined intervals, for example every 100 cycle, 200 cycles, 300 cycles, 400 cycles, 500 cycles, 600 cycles, 700 cycles, 800 cycles, 900 cycles, 1000 cycles, 1100 cycles, 1200 cycles, 1300 cycles, 1400 cycles, 1500 cycles, 1600 cycles, 1700 cycles, 1800 cycles, 1900 cycles, 2000 cycles. The liquid in the tank is composed of one or more of water, MnSO4 solution, ZnSO4 solution, Na2SO4 solution, H2SO4, NaOH, Zn acetate solution, Mn acetate solution, Na acetate solution, ZnCl2 solution, Zn nitrate solution, boric acid, and their combinations. The tube connectors 260 can be one or many on each face of the battery case. FIG. 2C shows an example with 6 tubes on one face of the case. One or more pumps can connect to one or more of the tube connectors. The battery systems of FIGS. 2B and 2C further include positive electrode 255 and negative electrode 250.

In example embodiments, circulation controller 220 may be controlled in whole or in part by batter controller 245. In example embodiments, battery controller 245 may control battery charging, discharging, or capacity regeneration cycling.

Example embodiments may include one or more controllers. In some embodiments, battery controllers 245 and/or circulation controller 220 may include one more processors, such as processor. Processor may include, for example, a microprocessor, microcontroller, digital signal processor (DSP), application specific integrated circuit (ASIC), or any other digital or analog circuitry configured to interpret and/or execute program instructions and/or process data. In some embodiments, processor may be communicatively coupled to memory. Processor may be configured to interpret and/or execute non-transitory program instructions and/or data stored in memory. Program instructions or data may constitute portions of software for carrying out fluid system modeling, as described herein. Memory may include any system, device, or apparatus configured to hold and/or house one or more memory modules; for example, memory may include read-only memory, random access memory, solid state memory, or disk-based memory. Each memory module may include any system, device or apparatus configured to retain program instructions and/or data for a period of time (e.g., computer-readable non-transitory media).

FIGS. 3A-3C are block illustrations of a proton-zinc ion battery 300 with electrolyte circulation through stirring method. The stirring is realized by installing stirring mechanism 305 inside the battery case. The stirring mechanisms can be magnetic, propeller, paddle, anchor, turbine, etc. FIGS. 3A-3C are examples of battery 300 with a stirring system to enable electrolyte circulation. One or more stirring mechanisms 305 are installed inside the battery case 230 to stir the electrolyte 215 is realized by installing stirrer inside the battery case. Example stirring mechanism 305 are installed at or near the top, at or near the side, or at or near the bottom positions inside the battery case 230. The stirring mechanism 305 stirring speed and usage frequency is controlled to obtain the desired effect on the battery and the highest system energy efficiency. Example stirring rates ranges from 1 rpm to 1,000 rpm with intervals of 0.1 rpm. Example stirring rates include one or more of 1 rpm, 1.1 rpm, 1.2 rpm, 1.3 rpm, 1.4 rpm, 1.5 rpm, 1.6 rpm, 1.7 rpm, 1.8 rpm, 1.9 rpm, 2 rpm, 2.1 rpm, 2.2 rpm, 2.3 rpm, 2.4 rpm, 2.5 rpm, 2.6 rpm, 2.7 rpm, 2.8 rpm, 2.9 rpm, 3 rpm, 3.1 rpm, 3.2 rpm, 3.3 rpm, 3.4 rpm, 3.5 rpm, 3.6 rpm, 3.7 rpm, 3.8 rpm, 3.9 rpm, 4 rpm, 4.1 rpm, 4.2 rpm, 4.3 rpm, 4.4 rpm, 4.5 rpm, 4.6 rpm, 4.7 rpm, 4.8 rpm, 4.9 rpm, 5 rpm, 5.1 rpm, 5.2 rpm, 5.3 rpm, 5.4 rpm, 5.5 rpm, 5.6 rpm, 5.7 rpm, 5.8 rpm, 5.9 rpm, 6 rpm, 6.1 rpm, 6.2 rpm, 6.3 rpm, 6.4 rpm, 6.5 rpm, 6.6 rpm, 6.7 rpm, 6.8 rpm, 6.9 rpm, 7 rpm, 7.1 rpm, 7.2 rpm, 7.3 rpm, 7.4 rpm, 7.5 rpm, 7.6 rpm, 7.7 rpm, 7.8 rpm, 7.9 rpm, 8 rpm, 8.1 rpm, 8.2 rpm, 8.3 rpm, 8.4 rpm, 8.5 rpm, 8.6 rpm, 8.7 rpm, 8.8 rpm, 8.9 rpm, 9 rpm, 9.1 rpm, 9.2 rpm, 9.3 rpm, 9.4 rpm, 9.5 rpm, 9.6 rpm, 9.7 rpm, 9.8 rpm, 9.9 rpm, 10 rpm, 10.1 rpm, 10.2 rpm, 10.3 rpm, 10.4 rpm, 10.5 rpm, 10.6 rpm, 10.7 rpm, 10.8 rpm, 10.9 rpm, 11 rpm, 11.1 rpm, 11.2 rpm, 11.3 rpm, 11.4 rpm, 11.5 rpm, 11.6 rpm, 11.7 rpm, 11.8 rpm, 11.9 rpm, 12 rpm, 12.1 rpm, 12.2 rpm, 12.3 rpm, 12.4 rpm, 12.5 rpm, 12.6 rpm, 12.7 rpm, 12.8 rpm, 12.9 rpm, 13 rpm, 13.1 rpm, 13.2 rpm, 13.3 rpm, 13.4 rpm, 13.5 rpm, 13.6 rpm, 13.7 rpm, 13.8 rpm, 13.9 rpm, 14 rpm, 14.1 rpm, 14.2 rpm, 14.3 rpm, 14.4 rpm, 14.5 rpm, 14.6 rpm, 14.7 rpm, 14.8 rpm, 14.9 rpm, 15 rpm, 15.1 rpm, 15.2 rpm, 15.3 rpm, 15.4 rpm, 15.5 rpm, 15.6 rpm, 15.7 rpm, 15.8 rpm, 15.9 rpm, 16 rpm, 16.1 rpm, 16.2 rpm, 16.3 rpm, 16.4 rpm, 16.5 rpm, 16.6 rpm, 16.7 rpm, 16.8 rpm, 16.9 rpm, 17 rpm, 17.1 rpm, 17.2 rpm, 17.3 rpm, 17.4 rpm, 17.5 rpm, 17.6 rpm, 17.7 rpm, 17.8 rpm, 17.9 rpm, 18 rpm, 18.1 rpm, 18.2 rpm, 18.3 rpm, 18.4 rpm, 18.5 rpm, 18.6 rpm, 18.7 rpm, 18.8 rpm, 18.9 rpm, 19 rpm, 19.1 rpm, 19.2 rpm, 19.3 rpm, 19.4 rpm, 19.5 rpm, 19.6 rpm, 19.7 rpm, 19.8 rpm, 19.9 rpm, 20 rpm, 20.1 rpm, 20.2 rpm, 20.3 rpm, 20.4 rpm, 20.5 rpm, 20.6 rpm, 20.7 rpm, 20.8 rpm, 20.9 rpm, 21 rpm, 21.1 rpm, 21.2 rpm, 21.3 rpm, 21.4 rpm, 21.5 rpm, 21.6 rpm, 21.7 rpm, 21.8 rpm, 21.9 rpm, 22 rpm, 22.1 rpm, 22.2 rpm, 22.3 rpm, 22.4 rpm, 22.5 rpm, 22.6 rpm, 22.7 rpm, 22.8 rpm, 22.9 rpm, 23 rpm, 23.1 rpm, 23.2 rpm, 23.3 rpm, 23.4 rpm, 23.5 rpm, 23.6 rpm, 23.7 rpm, 23.8 rpm, 23.9 rpm, 24 rpm, 24.1 rpm, 24.2 rpm, 24.3 rpm, 24.4 rpm, 24.5 rpm, 24.6 rpm, 24.7 rpm, 24.8 rpm, 24.9 rpm, 25 rpm, 25.1 rpm, 25.2 rpm, 25.3 rpm, 25.4 rpm, 25.5 rpm, 25.6 rpm, 25.7 rpm, 25.8 rpm, 25.9 rpm, 26 rpm, 26.1 rpm, 26.2 rpm, 26.3 rpm, 26.4 rpm, 26.5 rpm, 26.6 rpm, 26.7 rpm, 26.8 rpm, 26.9 rpm, 27 rpm, 27.1 rpm, 27.2 rpm, 27.3 rpm, 27.4 rpm, 27.5 rpm, 27.6 rpm, 27.7 rpm, 27.8 rpm, 27.9 rpm, 28 rpm, 28.1 rpm, 28.2 rpm, 28.3 rpm, 28.4 rpm, 28.5 rpm, 28.6 rpm, 28.7 rpm, 28.8 rpm, 28.9 rpm, 29 rpm, 29.1 rpm, 29.2 rpm, 29.3 rpm, 29.4 rpm, 29.5 rpm, 29.6 rpm, 29.7 rpm, 29.8 rpm, 29.9 rpm, 30 rpm, 30.1 rpm, 30.2 rpm, 30.3 rpm, 30.4 rpm, 30.5 rpm, 30.6 rpm, 30.7 rpm, 30.8 rpm, 30.9 rpm, 31 rpm, 31.1 rpm, 31.2 rpm, 31.3 rpm, 31.4 rpm, 31.5 rpm, 31.6 rpm, 31.7 rpm, 31.8 rpm, 31.9 rpm, 32 rpm, 32.1 rpm, 32.2 rpm, 32.3 rpm, 32.4 rpm, 32.5 rpm, 32.6 rpm, 32.7 rpm, 32.8 rpm, 32.9 rpm, 33 rpm, 33.1 rpm, 33.2 rpm, 33.3 rpm, 33.4 rpm, 33.5 rpm, 33.6 rpm, 33.7 rpm, 33.8 rpm, 33.9 rpm, 34 rpm, 34.1 rpm, 34.2 rpm, 34.3 rpm, 34.4 rpm, 34.5 rpm, 34.6 rpm, 34.7 rpm, 34.8 rpm, 34.9 rpm, 35 rpm, 35.1 rpm, 35.2 rpm, 35.3 rpm, 35.4 rpm, 35.5 rpm, 35.6 rpm, 35.7 rpm, 35.8 rpm, 35.9 rpm, 36 rpm, 36.1 rpm, 36.2 rpm, 36.3 rpm, 36.4 rpm, 36.5 rpm, 36.6 rpm, 36.7 rpm, 36.8 rpm, 36.9 rpm, 37 rpm, 37.1 rpm, 37.2 rpm, 37.3 rpm, 37.4 rpm, 37.5 rpm, 37.6 rpm, 37.7 rpm, 37.8 rpm, 37.9 rpm, 38 rpm, 38.1 rpm, 38.2 rpm, 38.3 rpm, 38.4 rpm, 38.5 rpm, 38.6 rpm, 38.7 rpm, 38.8 rpm, 38.9 rpm, 39 rpm, 39.1 rpm, 39.2 rpm, 39.3 rpm, 39.4 rpm, 39.5 rpm, 39.6 rpm, 39.7 rpm, 39.8 rpm, 39.9 rpm, 40 rpm, 40.1 rpm, 40.2 rpm, 40.3 rpm, 40.4 rpm, 40.5 rpm, 40.6 rpm, 40.7 rpm, 40.8 rpm, 40.9 rpm, 41 rpm, 41.1 rpm, 41.2 rpm, 41.3 rpm, 41.4 rpm, 41.5 rpm, 41.6 rpm, 41.7 rpm, 41.8 rpm, 41.9 rpm, 42 rpm, 42.1 rpm, 42.2 rpm, 42.3 rpm, 42.4 rpm, 42.5 rpm, 42.6 rpm, 42.7 rpm, 42.8 rpm, 42.9 rpm, 43 rpm, 43.1 rpm, 43.2 rpm, 43.3 rpm, 43.4 rpm, 43.5 rpm, 43.6 rpm, 43.7 rpm, 43.8 rpm, 43.9 rpm, 44 rpm, 44.1 rpm, 44.2 rpm, 44.3 rpm, 44.4 rpm, 44.5 rpm, 44.6 rpm, 44.7 rpm, 44.8 rpm, 44.9 rpm, 45 rpm, 45.1 rpm, 45.2 rpm, 45.3 rpm, 45.4 rpm, 45.5 rpm, 45.6 rpm, 45.7 rpm, 45.8 rpm, 45.9 rpm, 46 rpm, 46.1 rpm, 46.2 rpm, 46.3 rpm, 46.4 rpm, 46.5 rpm, 46.6 rpm, 46.7 rpm, 46.8 rpm, 46.9 rpm, 47 rpm, 47.1 rpm, 47.2 rpm, 47.3 rpm, 47.4 rpm, 47.5 rpm, 47.6 rpm, 47.7 rpm, 47.8 rpm, 47.9 rpm, 48 rpm, 48.1 rpm, 48.2 rpm, 48.3 rpm, 48.4 rpm, 48.5 rpm, 48.6 rpm, 48.7 rpm, 48.8 rpm, 48.9 rpm, 49 rpm, 49.1 rpm, 49.2 rpm, 49.3 rpm, 49.4 rpm, 49.5 rpm, 49.6 rpm, 49.7 rpm, 49.8 rpm, 49.9 rpm, 50 rpm, 50.1 rpm, 50.2 rpm, 50.3 rpm, 50.4 rpm, 50.5 rpm, 50.6 rpm, 50.7 rpm, 50.8 rpm, 50.9 rpm, 51 rpm, 51.1 rpm, 51.2 rpm, 51.3 rpm, 51.4 rpm, 51.5 rpm, 51.6 rpm, 51.7 rpm, 51.8 rpm, 51.9 rpm, 52 rpm, 52.1 rpm, 52.2 rpm, 52.3 rpm, 52.4 rpm, 52.5 rpm, 52.6 rpm, 52.7 rpm, 52.8 rpm, 52.9 rpm, 53 rpm, 53.1 rpm, 53.2 rpm, 53.3 rpm, 53.4 rpm, 53.5 rpm, 53.6 rpm, 53.7 rpm, 53.8 rpm, 53.9 rpm, 54 rpm, 54.1 rpm, 54.2 rpm, 54.3 rpm, 54.4 rpm, 54.5 rpm, 54.6 rpm, 54.7 rpm, 54.8 rpm, 54.9 rpm, 55 rpm, 55.1 rpm, 55.2 rpm, 55.3 rpm, 55.4 rpm, 55.5 rpm, 55.6 rpm, 55.7 rpm, 55.8 rpm, 55.9 rpm, 56 rpm, 56.1 rpm, 56.2 rpm, 56.3 rpm, 56.4 rpm, 56.5 rpm, 56.6 rpm, 56.7 rpm, 56.8 rpm, 56.9 rpm, 57 rpm, 57.1 rpm, 57.2 rpm, 57.3 rpm, 57.4 rpm, 57.5 rpm, 57.6 rpm, 57.7 rpm, 57.8 rpm, 57.9 rpm, 58 rpm, 58.1 rpm, 58.2 rpm, 58.3 rpm, 58.4 rpm, 58.5 rpm, 58.6 rpm, 58.7 rpm, 58.8 rpm, 58.9 rpm, 59 rpm, 59.1 rpm, 59.2 rpm, 59.3 rpm, 59.4 rpm, 59.5 rpm, 59.6 rpm, 59.7 rpm, 59.8 rpm, 59.9 rpm, 60 rpm, 60.1 rpm, 60.2 rpm, 60.3 rpm, 60.4 rpm, 60.5 rpm, 60.6 rpm, 60.7 rpm, 60.8 rpm, 60.9 rpm, 61 rpm, 61.1 rpm, 61.2 rpm, 61.3 rpm, 61.4 rpm, 61.5 rpm, 61.6 rpm, 61.7 rpm, 61.8 rpm, 61.9 rpm, 62 rpm, 62.1 rpm, 62.2 rpm, 62.3 rpm, 62.4 rpm, 62.5 rpm, 62.6 rpm, 62.7 rpm, 62.8 rpm, 62.9 rpm, 63 rpm, 63.1 rpm, 63.2 rpm, 63.3 rpm, 63.4 rpm, 63.5 rpm, 63.6 rpm, 63.7 rpm, 63.8 rpm, 63.9 rpm, 64 rpm, 64.1 rpm, 64.2 rpm, 64.3 rpm, 64.4 rpm, 64.5 rpm, 64.6 rpm, 64.7 rpm, 64.8 rpm, 64.9 rpm, 65 rpm, 65.1 rpm, 65.2 rpm, 65.3 rpm, 65.4 rpm, 65.5 rpm, 65.6 rpm, 65.7 rpm, 65.8 rpm, 65.9 rpm, 66 rpm, 66.1 rpm, 66.2 rpm, 66.3 rpm, 66.4 rpm, 66.5 rpm, 66.6 rpm, 66.7 rpm, 66.8 rpm, 66.9 rpm, 67 rpm, 67.1 rpm, 67.2 rpm, 67.3 rpm, 67.4 rpm, 67.5 rpm, 67.6 rpm, 67.7 rpm, 67.8 rpm, 67.9 rpm, 68 rpm, 68.1 rpm, 68.2 rpm, 68.3 rpm, 68.4 rpm, 68.5 rpm, 68.6 rpm, 68.7 rpm, 68.8 rpm, 68.9 rpm, 69 rpm, 69.1 rpm, 69.2 rpm, 69.3 rpm, 69.4 rpm, 69.5 rpm, 69.6 rpm, 69.7 rpm, 69.8 rpm, 69.9 rpm, 70 rpm, 70.1 rpm, 70.2 rpm, 70.3 rpm, 70.4 rpm, 70.5 rpm, 70.6 rpm, 70.7 rpm, 70.8 rpm, 70.9 rpm, 71 rpm, 71.1 rpm, 71.2 rpm, 71.3 rpm, 71.4 rpm, 71.5 rpm, 71.6 rpm, 71.7 rpm, 71.8 rpm, 71.9 rpm, 72 rpm, 72.1 rpm, 72.2 rpm, 72.3 rpm, 72.4 rpm, 72.5 rpm, 72.6 rpm, 72.7 rpm, 72.8 rpm, 72.9 rpm, 73 rpm, 73.1 rpm, 73.2 rpm, 73.3 rpm, 73.4 rpm, 73.5 rpm, 73.6 rpm, 73.7 rpm, 73.8 rpm, 73.9 rpm, 74 rpm, 74.1 rpm, 74.2 rpm, 74.3 rpm, 74.4 rpm, 74.5 rpm, 74.6 rpm, 74.7 rpm, 74.8 rpm, 74.9 rpm, 75 rpm, 75.1 rpm, 75.2 rpm, 75.3 rpm, 75.4 rpm, 75.5 rpm, 75.6 rpm, 75.7 rpm, 75.8 rpm, 75.9 rpm, 76 rpm, 76.1 rpm, 76.2 rpm, 76.3 rpm, 76.4 rpm, 76.5 rpm, 76.6 rpm, 76.7 rpm, 76.8 rpm, 76.9 rpm, 77 rpm, 77.1 rpm, 77.2 rpm, 77.3 rpm, 77.4 rpm, 77.5 rpm, 77.6 rpm, 77.7 rpm, 77.8 rpm, 77.9 rpm, 78 rpm, 78.1 rpm, 78.2 rpm, 78.3 rpm, 78.4 rpm, 78.5 rpm, 78.6 rpm, 78.7 rpm, 78.8 rpm, 78.9 rpm, 79 rpm, 79.1 rpm, 79.2 rpm, 79.3 rpm, 79.4 rpm, 79.5 rpm, 79.6 rpm, 79.7 rpm, 79.8 rpm, 79.9 rpm, 80 rpm, 80.1 rpm, 80.2 rpm, 80.3 rpm, 80.4 rpm, 80.5 rpm, 80.6 rpm, 80.7 rpm, 80.8 rpm, 80.9 rpm, 81 rpm, 81.1 rpm, 81.2 rpm, 81.3 rpm, 81.4 rpm, 81.5 rpm, 81.6 rpm, 81.7 rpm, 81.8 rpm, 81.9 rpm, 82 rpm, 82.1 rpm, 82.2 rpm, 82.3 rpm, 82.4 rpm, 82.5 rpm, 82.6 rpm, 82.7 rpm, 82.8 rpm, 82.9 rpm, 83 rpm, 83.1 rpm, 83.2 rpm, 83.3 rpm, 83.4 rpm, 83.5 rpm, 83.6 rpm, 83.7 rpm, 83.8 rpm, 83.9 rpm, 84 rpm, 84.1 rpm, 84.2 rpm, 84.3 rpm, 84.4 rpm, 84.5 rpm, 84.6 rpm, 84.7 rpm, 84.8 rpm, 84.9 rpm, 85 rpm, 85.1 rpm, 85.2 rpm, 85.3 rpm, 85.4 rpm, 85.5 rpm, 85.6 rpm, 85.7 rpm, 85.8 rpm, 85.9 rpm, 86 rpm, 86.1 rpm, 86.2 rpm, 86.3 rpm, 86.4 rpm, 86.5 rpm, 86.6 rpm, 86.7 rpm, 86.8 rpm, 86.9 rpm, 87 rpm, 87.1 rpm, 87.2 rpm, 87.3 rpm, 87.4 rpm, 87.5 rpm, 87.6 rpm, 87.7 rpm, 87.8 rpm, 87.9 rpm, 88 rpm, 88.1 rpm, 88.2 rpm, 88.3 rpm, 88.4 rpm, 88.5 rpm, 88.6 rpm, 88.7 rpm, 88.8 rpm, 88.9 rpm, 89 rpm, 89.1 rpm, 89.2 rpm, 89.3 rpm, 89.4 rpm, 89.5 rpm, 89.6 rpm, 89.7 rpm, 89.8 rpm, 89.9 rpm, 90 rpm, 90.1 rpm, 90.2 rpm, 90.3 rpm, 90.4 rpm, 90.5 rpm, 90.6 rpm, 90.7 rpm, 90.8 rpm, 90.9 rpm, 91 rpm, 91.1 rpm, 91.2 rpm, 91.3 rpm, 91.4 rpm, 91.5 rpm, 91.6 rpm, 91.7 rpm, 91.8 rpm, 91.9 rpm, 92 rpm, 92.1 rpm, 92.2 rpm, 92.3 rpm, 92.4 rpm, 92.5 rpm, 92.6 rpm, 92.7 rpm, 92.8 rpm, 92.9 rpm, 93 rpm, 93.1 rpm, 93.2 rpm, 93.3 rpm, 93.4 rpm, 93.5 rpm, 93.6 rpm, 93.7 rpm, 93.8 rpm, 93.9 rpm, 94 rpm, 94.1 rpm, 94.2 rpm, 94.3 rpm, 94.4 rpm, 94.5 rpm, 94.6 rpm, 94.7 rpm, 94.8 rpm, 94.9 rpm, 95 rpm, 95.1 rpm, 95.2 rpm, 95.3 rpm, 95.4 rpm, 95.5 rpm, 95.6 rpm, 95.7 rpm, 95.8 rpm, 95.9 rpm, 96 rpm, 96.1 rpm, 96.2 rpm, 96.3 rpm, 96.4 rpm, 96.5 rpm, 96.6 rpm, 96.7 rpm, 96.8 rpm, 96.9 rpm, 97 rpm, 97.1 rpm, 97.2 rpm, 97.3 rpm, 97.4 rpm, 97.5 rpm, 97.6 rpm, 97.7 rpm, 97.8 rpm, 97.9 rpm, 98 rpm, 98.1 rpm, 98.2 rpm, 98.3 rpm, 98.4 rpm, 98.5 rpm, 98.6 rpm, 98.7 rpm, 98.8 rpm, 98.9 rpm, 99 rpm, 99.1 rpm, 99.2 rpm, 99.3 rpm, 99.4 rpm, 99.5 rpm, 99.6 rpm, 99.7 rpm, 99.8 rpm, 99.9 rpm, 100 rpm, 100.1 rpm, 100.2 rpm, 100.3 rpm, 100.4 rpm, 100.5 rpm, 100.6 rpm, 100.7 rpm, 100.8 rpm, 100.9 rpm, 101 rpm, 101.1 rpm, 101.2 rpm, 101.3 rpm, 101.4 rpm, 101.5 rpm, 101.6 rpm, 101.7 rpm, 101.8 rpm, 101.9 rpm, 102 rpm, 102.1 rpm, 102.2 rpm, 102.3 rpm, 102.4 rpm, 102.5 rpm, 102.6 rpm, 102.7 rpm, 102.8 rpm, 102.9 rpm, 103 rpm, 103.1 rpm, 103.2 rpm, 103.3 rpm, 103.4 rpm, 103.5 rpm, 103.6 rpm, 103.7 rpm, 103.8 rpm, 103.9 rpm, 104 rpm, 104.1 rpm, 104.2 rpm, 104.3 rpm, 104.4 rpm, 104.5 rpm, 104.6 rpm, 104.7 rpm, 104.8 rpm, 104.9 rpm, 105 rpm, 105.1 rpm, 105.2 rpm, 105.3 rpm, 105.4 rpm, 105.5 rpm, 105.6 rpm, 105.7 rpm, 105.8 rpm, 105.9 rpm, 106 rpm, 106.1 rpm, 106.2 rpm, 106.3 rpm, 106.4 rpm, 106.5 rpm, 106.6 rpm, 106.7 rpm, 106.8 rpm, 106.9 rpm, 107 rpm, 107.1 rpm, 107.2 rpm, 107.3 rpm, 107.4 rpm, 107.5 rpm, 107.6 rpm, 107.7 rpm, 107.8 rpm, 107.9 rpm, 108 rpm, 108.1 rpm, 108.2 rpm, 108.3 rpm, 108.4 rpm, 108.5 rpm, 108.6 rpm, 108.7 rpm, 108.8 rpm, 108.9 rpm, 109 rpm, 109.1 rpm, 109.2 rpm, 109.3 rpm, 109.4 rpm, 109.5 rpm, 109.6 rpm, 109.7 rpm, 109.8 rpm, 109.9 rpm, 110 rpm, 110.1 rpm, 110.2 rpm, 110.3 rpm, 110.4 rpm, 110.5 rpm, 110.6 rpm, 110.7 rpm, 110.8 rpm, 110.9 rpm, 111 rpm, 111.1 rpm, 111.2 rpm, 111.3 rpm, 111.4 rpm, 111.5 rpm, 111.6 rpm, 111.7 rpm, 111.8 rpm, 111.9 rpm, 112 rpm, 112.1 rpm, 112.2 rpm, 112.3 rpm, 112.4 rpm, 112.5 rpm, 112.6 rpm, 112.7 rpm, 112.8 rpm, 112.9 rpm, 113 rpm, 113.1 rpm, 113.2 rpm, 113.3 rpm, 113.4 rpm, 113.5 rpm, 113.6 rpm, 113.7 rpm, 113.8 rpm, 113.9 rpm, 114 rpm, 114.1 rpm, 114.2 rpm, 114.3 rpm, 114.4 rpm, 114.5 rpm, 114.6 rpm, 114.7 rpm, 114.8 rpm, 114.9 rpm, 115 rpm, 115.1 rpm, 115.2 rpm, 115.3 rpm, 115.4 rpm, 115.5 rpm, 115.6 rpm, 115.7 rpm, 115.8 rpm, 115.9 rpm, 116 rpm, 116.1 rpm, 116.2 rpm, 116.3 rpm, 116.4 rpm, 116.5 rpm, 116.6 rpm, 116.7 rpm, 116.8 rpm, 116.9 rpm, 117 rpm, 117.1 rpm, 117.2 rpm, 117.3 rpm, 117.4 rpm, 117.5 rpm, 117.6 rpm, 117.7 rpm, 117.8 rpm, 117.9 rpm, 118 rpm, 118.1 rpm, 118.2 rpm, 118.3 rpm, 118.4 rpm, 118.5 rpm, 118.6 rpm, 118.7 rpm, 118.8 rpm, 118.9 rpm, 119 rpm, 119.1 rpm, 119.2 rpm, 119.3 rpm, 119.4 rpm, 119.5 rpm, 119.6 rpm, 119.7 rpm, 119.8 rpm, 119.9 rpm, 120 rpm, 120.1 rpm, 120.2 rpm, 120.3 rpm, 120.4 rpm, 120.5 rpm, 120.6 rpm, 120.7 rpm, 120.8 rpm, 120.9 rpm, 121 rpm, 121.1 rpm, 121.2 rpm, 121.3 rpm, 121.4 rpm, 121.5 rpm, 121.6 rpm, 121.7 rpm, 121.8 rpm, 121.9 rpm, 122 rpm, 122.1 rpm, 122.2 rpm, 122.3 rpm, 122.4 rpm, 122.5 rpm, 122.6 rpm, 122.7 rpm, 122.8 rpm, 122.9 rpm, 123 rpm, 123.1 rpm, 123.2 rpm, 123.3 rpm, 123.4 rpm, 123.5 rpm, 123.6 rpm, 123.7 rpm, 123.8 rpm, 123.9 rpm, 124 rpm, 124.1 rpm, 124.2 rpm, 124.3 rpm, 124.4 rpm, 124.5 rpm, 124.6 rpm, 124.7 rpm, 124.8 rpm, 124.9 rpm, 125 rpm, 125.1 rpm, 125.2 rpm, 125.3 rpm, 125.4 rpm, 125.5 rpm, 125.6 rpm, 125.7 rpm, 125.8 rpm, 125.9 rpm, 126 rpm, 126.1 rpm, 126.2 rpm, 126.3 rpm, 126.4 rpm, 126.5 rpm, 126.6 rpm, 126.7 rpm, 126.8 rpm, 126.9 rpm, 127 rpm, 127.1 rpm, 127.2 rpm, 127.3 rpm, 127.4 rpm, 127.5 rpm, 127.6 rpm, 127.7 rpm, 127.8 rpm, 127.9 rpm, 128 rpm, 128.1 rpm, 128.2 rpm, 128.3 rpm, 128.4 rpm, 128.5 rpm, 128.6 rpm, 128.7 rpm, 128.8 rpm, 128.9 rpm, 129 rpm, 129.1 rpm, 129.2 rpm, 129.3 rpm, 129.4 rpm, 129.5 rpm, 129.6 rpm, 129.7 rpm, 129.8 rpm, 129.9 rpm, 130 rpm, 130.1 rpm, 130.2 rpm, 130.3 rpm, 130.4 rpm, 130.5 rpm, 130.6 rpm, 130.7 rpm, 130.8 rpm, 130.9 rpm, 131 rpm, 131.1 rpm, 131.2 rpm, 131.3 rpm, 131.4 rpm, 131.5 rpm, 131.6 rpm, 131.7 rpm, 131.8 rpm, 131.9 rpm, 132 rpm, 132.1 rpm, 132.2 rpm, 132.3 rpm, 132.4 rpm, 132.5 rpm, 132.6 rpm, 132.7 rpm, 132.8 rpm, 132.9 rpm, 133 rpm, 133.1 rpm, 133.2 rpm, 133.3 rpm, 133.4 rpm, 133.5 rpm, 133.6 rpm, 133.7 rpm, 133.8 rpm, 133.9 rpm, 134 rpm, 134.1 rpm, 134.2 rpm, 134.3 rpm, 134.4 rpm, 134.5 rpm, 134.6 rpm, 134.7 rpm, 134.8 rpm, 134.9 rpm, 135 rpm, 135.1 rpm, 135.2 rpm, 135.3 rpm, 135.4 rpm, 135.5 rpm, 135.6 rpm, 135.7 rpm, 135.8 rpm, 135.9 rpm, 136 rpm, 136.1 rpm, 136.2 rpm, 136.3 rpm, 136.4 rpm, 136.5 rpm, 136.6 rpm, 136.7 rpm, 136.8 rpm, 136.9 rpm, 137 rpm, 137.1 rpm, 137.2 rpm, 137.3 rpm, 137.4 rpm, 137.5 rpm, 137.6 rpm, 137.7 rpm, 137.8 rpm, 137.9 rpm, 138 rpm, 138.1 rpm, 138.2 rpm, 138.3 rpm, 138.4 rpm, 138.5 rpm, 138.6 rpm, 138.7 rpm, 138.8 rpm, 138.9 rpm, 139 rpm, 139.1 rpm, 139.2 rpm, 139.3 rpm, 139.4 rpm, 139.5 rpm, 139.6 rpm, 139.7 rpm, 139.8 rpm, 139.9 rpm, 140 rpm, 140.1 rpm, 140.2 rpm, 140.3 rpm, 140.4 rpm, 140.5 rpm, 140.6 rpm, 140.7 rpm, 140.8 rpm, 140.9 rpm, 141 rpm, 141.1 rpm, 141.2 rpm, 141.3 rpm, 141.4 rpm, 141.5 rpm, 141.6 rpm, 141.7 rpm, 141.8 rpm, 141.9 rpm, 142 rpm, 142.1 rpm, 142.2 rpm, 142.3 rpm, 142.4 rpm, 142.5 rpm, 142.6 rpm, 142.7 rpm, 142.8 rpm, 142.9 rpm, 143 rpm, 143.1 rpm, 143.2 rpm, 143.3 rpm, 143.4 rpm, 143.5 rpm, 143.6 rpm, 143.7 rpm, 143.8 rpm, 143.9 rpm, 144 rpm, 144.1 rpm, 144.2 rpm, 144.3 rpm, 144.4 rpm, 144.5 rpm, 144.6 rpm, 144.7 rpm, 144.8 rpm, 144.9 rpm, 145 rpm, 145.1 rpm, 145.2 rpm, 145.3 rpm, 145.4 rpm, 145.5 rpm, 145.6 rpm, 145.7 rpm, 145.8 rpm, 145.9 rpm, 146 rpm, 146.1 rpm, 146.2 rpm, 146.3 rpm, 146.4 rpm, 146.5 rpm, 146.6 rpm, 146.7 rpm, 146.8 rpm, 146.9 rpm, 147 rpm, 147.1 rpm, 147.2 rpm, 147.3 rpm, 147.4 rpm, 147.5 rpm, 147.6 rpm, 147.7 rpm, 147.8 rpm, 147.9 rpm, 148 rpm, 148.1 rpm, 148.2 rpm, 148.3 rpm, 148.4 rpm, 148.5 rpm, 148.6 rpm, 148.7 rpm, 148.8 rpm, 148.9 rpm, 149 rpm, 149.1 rpm, 149.2 rpm, 149.3 rpm, 149.4 rpm, 149.5 rpm, 149.6 rpm, 149.7 rpm, 149.8 rpm, 149.9 rpm, 150 rpm, 150.1 rpm, 150.2 rpm, 150.3 rpm, 150.4 rpm, 150.5 rpm, 150.6 rpm, 150.7 rpm, 150.8 rpm, 150.9 rpm, 151 rpm, 151.1 rpm, 151.2 rpm, 151.3 rpm, 151.4 rpm, 151.5 rpm, 151.6 rpm, 151.7 rpm, 151.8 rpm, 151.9 rpm, 152 rpm, 152.1 rpm, 152.2 rpm, 152.3 rpm, 152.4 rpm, 152.5 rpm, 152.6 rpm, 152.7 rpm, 152.8 rpm, 152.9 rpm, 153 rpm, 153.1 rpm, 153.2 rpm, 153.3 rpm, 153.4 rpm, 153.5 rpm, 153.6 rpm, 153.7 rpm, 153.8 rpm, 153.9 rpm, 154 rpm, 154.1 rpm, 154.2 rpm, 154.3 rpm, 154.4 rpm, 154.5 rpm, 154.6 rpm, 154.7 rpm, 154.8 rpm, 154.9 rpm, 155 rpm, 155.1 rpm, 155.2 rpm, 155.3 rpm, 155.4 rpm, 155.5 rpm, 155.6 rpm, 155.7 rpm, 155.8 rpm, 155.9 rpm, 156 rpm, 156.1 rpm, 156.2 rpm, 156.3 rpm, 156.4 rpm, 156.5 rpm, 156.6 rpm, 156.7 rpm, 156.8 rpm, 156.9 rpm, 157 rpm, 157.1 rpm, 157.2 rpm, 157.3 rpm, 157.4 rpm, 157.5 rpm, 157.6 rpm, 157.7 rpm, 157.8 rpm, 157.9 rpm, 158 rpm, 158.1 rpm, 158.2 rpm, 158.3 rpm, 158.4 rpm, 158.5 rpm, 158.6 rpm, 158.7 rpm, 158.8 rpm, 158.9 rpm, 159 rpm, 159.1 rpm, 159.2 rpm, 159.3 rpm, 159.4 rpm, 159.5 rpm, 159.6 rpm, 159.7 rpm, 159.8 rpm, 159.9 rpm, 160 rpm, 160.1 rpm, 160.2 rpm, 160.3 rpm, 160.4 rpm, 160.5 rpm, 160.6 rpm, 160.7 rpm, 160.8 rpm, 160.9 rpm, 161 rpm, 161.1 rpm, 161.2 rpm, 161.3 rpm, 161.4 rpm, 161.5 rpm, 161.6 rpm, 161.7 rpm, 161.8 rpm, 161.9 rpm, 162 rpm, 162.1 rpm, 162.2 rpm, 162.3 rpm, 162.4 rpm, 162.5 rpm, 162.6 rpm, 162.7 rpm, 162.8 rpm, 162.9 rpm, 163 rpm, 163.1 rpm, 163.2 rpm, 163.3 rpm, 163.4 rpm, 163.5 rpm, 163.6 rpm, 163.7 rpm, 163.8 rpm, 163.9 rpm, 164 rpm, 164.1 rpm, 164.2 rpm, 164.3 rpm, 164.4 rpm, 164.5 rpm, 164.6 rpm, 164.7 rpm, 164.8 rpm, 164.9 rpm, 165 rpm, 165.1 rpm, 165.2 rpm, 165.3 rpm, 165.4 rpm, 165.5 rpm, 165.6 rpm, 165.7 rpm, 165.8 rpm, 165.9 rpm, 166 rpm, 166.1 rpm, 166.2 rpm, 166.3 rpm, 166.4 rpm, 166.5 rpm, 166.6 rpm, 166.7 rpm, 166.8 rpm, 166.9 rpm, 167 rpm, 167.1 rpm, 167.2 rpm, 167.3 rpm, 167.4 rpm, 167.5 rpm, 167.6 rpm, 167.7 rpm, 167.8 rpm, 167.9 rpm, 168 rpm, 168.1 rpm, 168.2 rpm, 168.3 rpm, 168.4 rpm, 168.5 rpm, 168.6 rpm, 168.7 rpm, 168.8 rpm, 168.9 rpm, 169 rpm, 169.1 rpm, 169.2 rpm, 169.3 rpm, 169.4 rpm, 169.5 rpm, 169.6 rpm, 169.7 rpm, 169.8 rpm, 169.9 rpm, 170 rpm, 170.1 rpm, 170.2 rpm, 170.3 rpm, 170.4 rpm, 170.5 rpm, 170.6 rpm, 170.7 rpm, 170.8 rpm, 170.9 rpm, 171 rpm, 171.1 rpm, 171.2 rpm, 171.3 rpm, 171.4 rpm, 171.5 rpm, 171.6 rpm, 171.7 rpm, 171.8 rpm, 171.9 rpm, 172 rpm, 172.1 rpm, 172.2 rpm, 172.3 rpm, 172.4 rpm, 172.5 rpm, 172.6 rpm, 172.7 rpm, 172.8 rpm, 172.9 rpm, 173 rpm, 173.1 rpm, 173.2 rpm, 173.3 rpm, 173.4 rpm, 173.5 rpm, 173.6 rpm, 173.7 rpm, 173.8 rpm, 173.9 rpm, 174 rpm, 174.1 rpm, 174.2 rpm, 174.3 rpm, 174.4 rpm, 174.5 rpm, 174.6 rpm, 174.7 rpm, 174.8 rpm, 174.9 rpm, 175 rpm, 175.1 rpm, 175.2 rpm, 175.3 rpm, 175.4 rpm, 175.5 rpm, 175.6 rpm, 175.7 rpm, 175.8 rpm, 175.9 rpm, 176 rpm, 176.1 rpm, 176.2 rpm, 176.3 rpm, 176.4 rpm, 176.5 rpm, 176.6 rpm, 176.7 rpm, 176.8 rpm, 176.9 rpm, 177 rpm, 177.1 rpm, 177.2 rpm, 177.3 rpm, 177.4 rpm, 177.5 rpm, 177.6 rpm, 177.7 rpm, 177.8 rpm, 177.9 rpm, 178 rpm, 178.1 rpm, 178.2 rpm, 178.3 rpm, 178.4 rpm, 178.5 rpm, 178.6 rpm, 178.7 rpm, 178.8 rpm, 178.9 rpm, 179 rpm, 179.1 rpm, 179.2 rpm, 179.3 rpm, 179.4 rpm, 179.5 rpm, 179.6 rpm, 179.7 rpm, 179.8 rpm, 179.9 rpm, 180 rpm, 180.1 rpm, 180.2 rpm, 180.3 rpm, 180.4 rpm, 180.5 rpm, 180.6 rpm, 180.7 rpm, 180.8 rpm, 180.9 rpm, 181 rpm, 181.1 rpm, 181.2 rpm, 181.3 rpm, 181.4 rpm, 181.5 rpm, 181.6 rpm, 181.7 rpm, 181.8 rpm, 181.9 rpm, 182 rpm, 182.1 rpm, 182.2 rpm, 182.3 rpm, 182.4 rpm, 182.5 rpm, 182.6 rpm, 182.7 rpm, 182.8 rpm, 182.9 rpm, 183 rpm, 183.1 rpm, 183.2 rpm, 183.3 rpm, 183.4 rpm, 183.5 rpm, 183.6 rpm, 183.7 rpm, 183.8 rpm, 183.9 rpm, 184 rpm, 184.1 rpm, 184.2 rpm, 184.3 rpm, 184.4 rpm, 184.5 rpm, 184.6 rpm, 184.7 rpm, 184.8 rpm, 184.9 rpm, 185 rpm, 185.1 rpm, 185.2 rpm, 185.3 rpm, 185.4 rpm, 185.5 rpm, 185.6 rpm, 185.7 rpm, 185.8 rpm, 185.9 rpm, 186 rpm, 186.1 rpm, 186.2 rpm, 186.3 rpm, 186.4 rpm, 186.5 rpm, 186.6 rpm, 186.7 rpm, 186.8 rpm, 186.9 rpm, 187 rpm, 187.1 rpm, 187.2 rpm, 187.3 rpm, 187.4 rpm, 187.5 rpm, 187.6 rpm, 187.7 rpm, 187.8 rpm, 187.9 rpm, 188 rpm, 188.1 rpm, 188.2 rpm, 188.3 rpm, 188.4 rpm, 188.5 rpm, 188.6 rpm, 188.7 rpm, 188.8 rpm, 188.9 rpm, 189 rpm, 189.1 rpm, 189.2 rpm, 189.3 rpm, 189.4 rpm, 189.5 rpm, 189.6 rpm, 189.7 rpm, 189.8 rpm, 189.9 rpm, 190 rpm, 190.1 rpm, 190.2 rpm, 190.3 rpm, 190.4 rpm, 190.5 rpm, 190.6 rpm, 190.7 rpm, 190.8 rpm, 190.9 rpm, 191 rpm, 191.1 rpm, 191.2 rpm, 191.3 rpm, 191.4 rpm, 191.5 rpm, 191.6 rpm, 191.7 rpm, 191.8 rpm, 191.9 rpm, 192 rpm, 192.1 rpm, 192.2 rpm, 192.3 rpm, 192.4 rpm, 192.5 rpm, 192.6 rpm, 192.7 rpm, 192.8 rpm, 192.9 rpm, 193 rpm, 193.1 rpm, 193.2 rpm, 193.3 rpm, 193.4 rpm, 193.5 rpm, 193.6 rpm, 193.7 rpm, 193.8 rpm, 193.9 rpm, 194 rpm, 194.1 rpm, 194.2 rpm, 194.3 rpm, 194.4 rpm, 194.5 rpm, 194.6 rpm, 194.7 rpm, 194.8 rpm, 194.9 rpm, 195 rpm, 195.1 rpm, 195.2 rpm, 195.3 rpm, 195.4 rpm, 195.5 rpm, 195.6 rpm, 195.7 rpm, 195.8 rpm, 195.9 rpm, 196 rpm, 196.1 rpm, 196.2 rpm, 196.3 rpm, 196.4 rpm, 196.5 rpm, 196.6 rpm, 196.7 rpm, 196.8 rpm, 196.9 rpm, 197 rpm, 197.1 rpm, 197.2 rpm, 197.3 rpm, 197.4 rpm, 197.5 rpm, 197.6 rpm, 197.7 rpm, 197.8 rpm, 197.9 rpm, 198 rpm, 198.1 rpm, 198.2 rpm, 198.3 rpm, 198.4 rpm, 198.5 rpm, 198.6 rpm, 198.7 rpm, 198.8 rpm, 198.9 rpm, 199 rpm, 199.1 rpm, 199.2 rpm, 199.3 rpm, 199.4 rpm, 199.5 rpm, 199.6 rpm, 199.7 rpm, 199.8 rpm, 199.9 rpm, 200 rpm, 200.1 rpm, 200.2 rpm, 200.3 rpm, 200.4 rpm, 200.5 rpm, 200.6 rpm, 200.7 rpm, 200.8 rpm, 200.9 rpm, 201 rpm, 201.1 rpm, 201.2 rpm, 201.3 rpm, 201.4 rpm, 201.5 rpm, 201.6 rpm, 201.7 rpm, 201.8 rpm, 201.9 rpm, 202 rpm, 202.1 rpm, 202.2 rpm, 202.3 rpm, 202.4 rpm, 202.5 rpm, 202.6 rpm, 202.7 rpm, 202.8 rpm, 202.9 rpm, 203 rpm, 203.1 rpm, 203.2 rpm, 203.3 rpm, 203.4 rpm, 203.5 rpm, 203.6 rpm, 203.7 rpm, 203.8 rpm, 203.9 rpm, 204 rpm, 204.1 rpm, 204.2 rpm, 204.3 rpm, 204.4 rpm, 204.5 rpm, 204.6 rpm, 204.7 rpm, 204.8 rpm, 204.9 rpm, 205 rpm, 205.1 rpm, 205.2 rpm, 205.3 rpm, 205.4 rpm, 205.5 rpm, 205.6 rpm, 205.7 rpm, 205.8 rpm, 205.9 rpm, 206 rpm, 206.1 rpm, 206.2 rpm, 206.3 rpm, 206.4 rpm, 206.5 rpm, 206.6 rpm, 206.7 rpm, 206.8 rpm, 206.9 rpm, 207 rpm, 207.1 rpm, 207.2 rpm, 207.3 rpm, 207.4 rpm, 207.5 rpm, 207.6 rpm, 207.7 rpm, 207.8 rpm, 207.9 rpm, 208 rpm, 208.1 rpm, 208.2 rpm, 208.3 rpm, 208.4 rpm, 208.5 rpm, 208.6 rpm, 208.7 rpm, 208.8 rpm, 208.9 rpm, 209 rpm, 209.1 rpm, 209.2 rpm, 209.3 rpm, 209.4 rpm, 209.5 rpm, 209.6 rpm, 209.7 rpm, 209.8 rpm, 209.9 rpm, 210 rpm, 210.1 rpm, 210.2 rpm, 210.3 rpm, 210.4 rpm, 210.5 rpm, 210.6 rpm, 210.7 rpm, 210.8 rpm, 210.9 rpm, 211 rpm, 211.1 rpm, 211.2 rpm, 211.3 rpm, 211.4 rpm, 211.5 rpm, 211.6 rpm, 211.7 rpm, 211.8 rpm, 211.9 rpm, 212 rpm, 212.1 rpm, 212.2 rpm, 212.3 rpm, 212.4 rpm, 212.5 rpm, 212.6 rpm, 212.7 rpm, 212.8 rpm, 212.9 rpm, 213 rpm, 213.1 rpm, 213.2 rpm, 213.3 rpm, 213.4 rpm, 213.5 rpm, 213.6 rpm, 213.7 rpm, 213.8 rpm, 213.9 rpm, 214 rpm, 214.1 rpm, 214.2 rpm, 214.3 rpm, 214.4 rpm, 214.5 rpm, 214.6 rpm, 214.7 rpm, 214.8 rpm, 214.9 rpm, 215 rpm, 215.1 rpm, 215.2 rpm, 215.3 rpm, 215.4 rpm, 215.5 rpm, 215.6 rpm, 215.7 rpm, 215.8 rpm, 215.9 rpm, 216 rpm, 216.1 rpm, 216.2 rpm, 216.3 rpm, 216.4 rpm, 216.5 rpm, 216.6 rpm, 216.7 rpm, 216.8 rpm, 216.9 rpm, 217 rpm, 217.1 rpm, 217.2 rpm, 217.3 rpm, 217.4 rpm, 217.5 rpm, 217.6 rpm, 217.7 rpm, 217.8 rpm, 217.9 rpm, 218 rpm, 218.1 rpm, 218.2 rpm, 218.3 rpm, 218.4 rpm, 218.5 rpm, 218.6 rpm, 218.7 rpm, 218.8 rpm, 218.9 rpm, 219 rpm, 219.1 rpm, 219.2 rpm, 219.3 rpm, 219.4 rpm, 219.5 rpm, 219.6 rpm, 219.7 rpm, 219.8 rpm, 219.9 rpm, 220 rpm, 220.1 rpm, 220.2 rpm, 220.3 rpm, 220.4 rpm, 220.5 rpm, 220.6 rpm, 220.7 rpm, 220.8 rpm, 220.9 rpm, 221 rpm, 221.1 rpm, 221.2 rpm, 221.3 rpm, 221.4 rpm, 221.5 rpm, 221.6 rpm, 221.7 rpm, 221.8 rpm, 221.9 rpm, 222 rpm, 222.1 rpm, 222.2 rpm, 222.3 rpm, 222.4 rpm, 222.5 rpm, 222.6 rpm, 222.7 rpm, 222.8 rpm, 222.9 rpm, 223 rpm, 223.1 rpm, 223.2 rpm, 223.3 rpm, 223.4 rpm, 223.5 rpm, 223.6 rpm, 223.7 rpm, 223.8 rpm, 223.9 rpm, 224 rpm, 224.1 rpm, 224.2 rpm, 224.3 rpm, 224.4 rpm, 224.5 rpm, 224.6 rpm, 224.7 rpm, 224.8 rpm, 224.9 rpm, 225 rpm, 225.1 rpm, 225.2 rpm, 225.3 rpm, 225.4 rpm, 225.5 rpm, 225.6 rpm, 225.7 rpm, 225.8 rpm, 225.9 rpm, 226 rpm, 226.1 rpm, 226.2 rpm, 226.3 rpm, 226.4 rpm, 226.5 rpm, 226.6 rpm, 226.7 rpm, 226.8 rpm, 226.9 rpm, 227 rpm, 227.1 rpm, 227.2 rpm, 227.3 rpm, 227.4 rpm, 227.5 rpm, 227.6 rpm, 227.7 rpm, 227.8 rpm, 227.9 rpm, 228 rpm, 228.1 rpm, 228.2 rpm, 228.3 rpm, 228.4 rpm, 228.5 rpm, 228.6 rpm, 228.7 rpm, 228.8 rpm, 228.9 rpm, 229 rpm, 229.1 rpm, 229.2 rpm, 229.3 rpm, 229.4 rpm, 229.5 rpm, 229.6 rpm, 229.7 rpm, 229.8 rpm, 229.9 rpm, 230 rpm, 230.1 rpm, 230.2 rpm, 230.3 rpm, 230.4 rpm, 230.5 rpm, 230.6 rpm, 230.7 rpm, 230.8 rpm, 230.9 rpm, 231 rpm, 231.1 rpm, 231.2 rpm, 231.3 rpm, 231.4 rpm, 231.5 rpm, 231.6 rpm, 231.7 rpm, 231.8 rpm, 231.9 rpm, 232 rpm, 232.1 rpm, 232.2 rpm, 232.3 rpm, 232.4 rpm, 232.5 rpm, 232.6 rpm, 232.7 rpm, 232.8 rpm, 232.9 rpm, 233 rpm, 233.1 rpm, 233.2 rpm, 233.3 rpm, 233.4 rpm, 233.5 rpm, 233.6 rpm, 233.7 rpm, 233.8 rpm, 233.9 rpm, 234 rpm, 234.1 rpm, 234.2 rpm, 234.3 rpm, 234.4 rpm, 234.5 rpm, 234.6 rpm, 234.7 rpm, 234.8 rpm, 234.9 rpm, 235 rpm, 235.1 rpm, 235.2 rpm, 235.3 rpm, 235.4 rpm, 235.5 rpm, 235.6 rpm, 235.7 rpm, 235.8 rpm, 235.9 rpm, 236 rpm, 236.1 rpm, 236.2 rpm, 236.3 rpm, 236.4 rpm, 236.5 rpm, 236.6 rpm, 236.7 rpm, 236.8 rpm, 236.9 rpm, 237 rpm, 237.1 rpm, 237.2 rpm, 237.3 rpm, 237.4 rpm, 237.5 rpm, 237.6 rpm, 237.7 rpm, 237.8 rpm, 237.9 rpm, 238 rpm, 238.1 rpm, 238.2 rpm, 238.3 rpm, 238.4 rpm, 238.5 rpm, 238.6 rpm, 238.7 rpm, 238.8 rpm, 238.9 rpm, 239 rpm, 239.1 rpm, 239.2 rpm, 239.3 rpm, 239.4 rpm, 239.5 rpm, 239.6 rpm, 239.7 rpm, 239.8 rpm, 239.9 rpm, 240 rpm, 240.1 rpm, 240.2 rpm, 240.3 rpm, 240.4 rpm, 240.5 rpm, 240.6 rpm, 240.7 rpm, 240.8 rpm, 240.9 rpm, 241 rpm, 241.1 rpm, 241.2 rpm, 241.3 rpm, 241.4 rpm, 241.5 rpm, 241.6 rpm, 241.7 rpm, 241.8 rpm, 241.9 rpm, 242 rpm, 242.1 rpm, 242.2 rpm, 242.3 rpm, 242.4 rpm, 242.5 rpm, 242.6 rpm, 242.7 rpm, 242.8 rpm, 242.9 rpm, 243 rpm, 243.1 rpm, 243.2 rpm, 243.3 rpm, 243.4 rpm, 243.5 rpm, 243.6 rpm, 243.7 rpm, 243.8 rpm, 243.9 rpm, 244 rpm, 244.1 rpm, 244.2 rpm, 244.3 rpm, 244.4 rpm, 244.5 rpm, 244.6 rpm, 244.7 rpm, 244.8 rpm, 244.9 rpm, 245 rpm, 245.1 rpm, 245.2 rpm, 245.3 rpm, 245.4 rpm, 245.5 rpm, 245.6 rpm, 245.7 rpm, 245.8 rpm, 245.9 rpm, 246 rpm, 246.1 rpm, 246.2 rpm, 246.3 rpm, 246.4 rpm, 246.5 rpm, 246.6 rpm, 246.7 rpm, 246.8 rpm, 246.9 rpm, 247 rpm, 247.1 rpm, 247.2 rpm, 247.3 rpm, 247.4 rpm, 247.5 rpm, 247.6 rpm, 247.7 rpm, 247.8 rpm, 247.9 rpm, 248 rpm, 248.1 rpm, 248.2 rpm, 248.3 rpm, 248.4 rpm, 248.5 rpm, 248.6 rpm, 248.7 rpm, 248.8 rpm, 248.9 rpm, 249 rpm, 249.1 rpm, 249.2 rpm, 249.3 rpm, 249.4 rpm, 249.5 rpm, 249.6 rpm, 249.7 rpm, 249.8 rpm, 249.9 rpm, 250 rpm, 250.1 rpm, 250.2 rpm, 250.3 rpm, 250.4 rpm, 250.5 rpm, 250.6 rpm, 250.7 rpm, 250.8 rpm, 250.9 rpm, 251 rpm, 251.1 rpm, 251.2 rpm, 251.3 rpm, 251.4 rpm, 251.5 rpm, 251.6 rpm, 251.7 rpm, 251.8 rpm, 251.9 rpm, 252 rpm, 252.1 rpm, 252.2 rpm, 252.3 rpm, 252.4 rpm, 252.5 rpm, 252.6 rpm, 252.7 rpm, 252.8 rpm, 252.9 rpm, 253 rpm, 253.1 rpm, 253.2 rpm, 253.3 rpm, 253.4 rpm, 253.5 rpm, 253.6 rpm, 253.7 rpm, 253.8 rpm, 253.9 rpm, 254 rpm, 254.1 rpm, 254.2 rpm, 254.3 rpm, 254.4 rpm, 254.5 rpm, 254.6 rpm, 254.7 rpm, 254.8 rpm, 254.9 rpm, 255 rpm, 255.1 rpm, 255.2 rpm, 255.3 rpm, 255.4 rpm, 255.5 rpm, 255.6 rpm, 255.7 rpm, 255.8 rpm, 255.9 rpm, 256 rpm, 256.1 rpm, 256.2 rpm, 256.3 rpm, 256.4 rpm, 256.5 rpm, 256.6 rpm, 256.7 rpm, 256.8 rpm, 256.9 rpm, 257 rpm, 257.1 rpm, 257.2 rpm, 257.3 rpm, 257.4 rpm, 257.5 rpm, 257.6 rpm, 257.7 rpm, 257.8 rpm, 257.9 rpm, 258 rpm, 258.1 rpm, 258.2 rpm, 258.3 rpm, 258.4 rpm, 258.5 rpm, 258.6 rpm, 258.7 rpm, 258.8 rpm, 258.9 rpm, 259 rpm, 259.1 rpm, 259.2 rpm, 259.3 rpm, 259.4 rpm, 259.5 rpm, 259.6 rpm, 259.7 rpm, 259.8 rpm, 259.9 rpm, 260 rpm, 260.1 rpm, 260.2 rpm, 260.3 rpm, 260.4 rpm, 260.5 rpm, 260.6 rpm, 260.7 rpm, 260.8 rpm, 260.9 rpm, 261 rpm, 261.1 rpm, 261.2 rpm, 261.3 rpm, 261.4 rpm, 261.5 rpm, 261.6 rpm, 261.7 rpm, 261.8 rpm, 261.9 rpm, 262 rpm, 262.1 rpm, 262.2 rpm, 262.3 rpm, 262.4 rpm, 262.5 rpm, 262.6 rpm, 262.7 rpm, 262.8 rpm, 262.9 rpm, 263 rpm, 263.1 rpm, 263.2 rpm, 263.3 rpm, 263.4 rpm, 263.5 rpm, 263.6 rpm, 263.7 rpm, 263.8 rpm, 263.9 rpm, 264 rpm, 264.1 rpm, 264.2 rpm, 264.3 rpm, 264.4 rpm, 264.5 rpm, 264.6 rpm, 264.7 rpm, 264.8 rpm, 264.9 rpm, 265 rpm, 265.1 rpm, 265.2 rpm, 265.3 rpm, 265.4 rpm, 265.5 rpm, 265.6 rpm, 265.7 rpm, 265.8 rpm, 265.9 rpm, 266 rpm, 266.1 rpm, 266.2 rpm, 266.3 rpm, 266.4 rpm, 266.5 rpm, 266.6 rpm, 266.7 rpm, 266.8 rpm, 266.9 rpm, 267 rpm, 267.1 rpm, 267.2 rpm, 267.3 rpm, 267.4 rpm, 267.5 rpm, 267.6 rpm, 267.7 rpm, 267.8 rpm, 267.9 rpm, 268 rpm, 268.1 rpm, 268.2 rpm, 268.3 rpm, 268.4 rpm, 268.5 rpm, 268.6 rpm, 268.7 rpm, 268.8 rpm, 268.9 rpm, 269 rpm, 269.1 rpm, 269.2 rpm, 269.3 rpm, 269.4 rpm, 269.5 rpm, 269.6 rpm, 269.7 rpm, 269.8 rpm, 269.9 rpm, 270 rpm, 270.1 rpm, 270.2 rpm, 270.3 rpm, 270.4 rpm, 270.5 rpm, 270.6 rpm, 270.7 rpm, 270.8 rpm, 270.9 rpm, 271 rpm, 271.1 rpm, 271.2 rpm, 271.3 rpm, 271.4 rpm, 271.5 rpm, 271.6 rpm, 271.7 rpm, 271.8 rpm, 271.9 rpm, 272 rpm, 272.1 rpm, 272.2 rpm, 272.3 rpm, 272.4 rpm, 272.5 rpm, 272.6 rpm, 272.7 rpm, 272.8 rpm, 272.9 rpm, 273 rpm, 273.1 rpm, 273.2 rpm, 273.3 rpm, 273.4 rpm, 273.5 rpm, 273.6 rpm, 273.7 rpm, 273.8 rpm, 273.9 rpm, 274 rpm, 274.1 rpm, 274.2 rpm, 274.3 rpm, 274.4 rpm, 274.5 rpm, 274.6 rpm, 274.7 rpm, 274.8 rpm, 274.9 rpm, 275 rpm, 275.1 rpm, 275.2 rpm, 275.3 rpm, 275.4 rpm, 275.5 rpm, 275.6 rpm, 275.7 rpm, 275.8 rpm, 275.9 rpm, 276 rpm, 276.1 rpm, 276.2 rpm, 276.3 rpm, 276.4 rpm, 276.5 rpm, 276.6 rpm, 276.7 rpm, 276.8 rpm, 276.9 rpm, 277 rpm, 277.1 rpm, 277.2 rpm, 277.3 rpm, 277.4 rpm, 277.5 rpm, 277.6 rpm, 277.7 rpm, 277.8 rpm, 277.9 rpm, 278 rpm, 278.1 rpm, 278.2 rpm, 278.3 rpm, 278.4 rpm, 278.5 rpm, 278.6 rpm, 278.7 rpm, 278.8 rpm, 278.9 rpm, 279 rpm, 279.1 rpm, 279.2 rpm, 279.3 rpm, 279.4 rpm, 279.5 rpm, 279.6 rpm, 279.7 rpm, 279.8 rpm, 279.9 rpm, 280 rpm, 280.1 rpm, 280.2 rpm, 280.3 rpm, 280.4 rpm, 280.5 rpm, 280.6 rpm, 280.7 rpm, 280.8 rpm, 280.9 rpm, 281 rpm, 281.1 rpm, 281.2 rpm, 281.3 rpm, 281.4 rpm, 281.5 rpm, 281.6 rpm, 281.7 rpm, 281.8 rpm, 281.9 rpm, 282 rpm, 282.1 rpm, 282.2 rpm, 282.3 rpm, 282.4 rpm, 282.5 rpm, 282.6 rpm, 282.7 rpm, 282.8 rpm, 282.9 rpm, 283 rpm, 283.1 rpm, 283.2 rpm, 283.3 rpm, 283.4 rpm, 283.5 rpm, 283.6 rpm, 283.7 rpm, 283.8 rpm, 283.9 rpm, 284 rpm, 284.1 rpm, 284.2 rpm, 284.3 rpm, 284.4 rpm, 284.5 rpm, 284.6 rpm, 284.7 rpm, 284.8 rpm, 284.9 rpm, 285 rpm, 285.1 rpm, 285.2 rpm, 285.3 rpm, 285.4 rpm, 285.5 rpm, 285.6 rpm, 285.7 rpm, 285.8 rpm, 285.9 rpm, 286 rpm, 286.1 rpm, 286.2 rpm, 286.3 rpm, 286.4 rpm, 286.5 rpm, 286.6 rpm, 286.7 rpm, 286.8 rpm, 286.9 rpm, 287 rpm, 287.1 rpm, 287.2 rpm, 287.3 rpm, 287.4 rpm, 287.5 rpm, 287.6 rpm, 287.7 rpm, 287.8 rpm, 287.9 rpm, 288 rpm, 288.1 rpm, 288.2 rpm, 288.3 rpm, 288.4 rpm, 288.5 rpm, 288.6 rpm, 288.7 rpm, 288.8 rpm, 288.9 rpm, 289 rpm, 289.1 rpm, 289.2 rpm, 289.3 rpm, 289.4 rpm, 289.5 rpm, 289.6 rpm, 289.7 rpm, 289.8 rpm, 289.9 rpm, 290 rpm, 290.1 rpm, 290.2 rpm, 290.3 rpm, 290.4 rpm, 290.5 rpm, 290.6 rpm, 290.7 rpm, 290.8 rpm, 290.9 rpm, 291 rpm, 291.1 rpm, 291.2 rpm, 291.3 rpm, 291.4 rpm, 291.5 rpm, 291.6 rpm, 291.7 rpm, 291.8 rpm, 291.9 rpm, 292 rpm, 292.1 rpm, 292.2 rpm, 292.3 rpm, 292.4 rpm, 292.5 rpm, 292.6 rpm, 292.7 rpm, 292.8 rpm, 292.9 rpm, 293 rpm, 293.1 rpm, 293.2 rpm, 293.3 rpm, 293.4 rpm, 293.5 rpm, 293.6 rpm, 293.7 rpm, 293.8 rpm, 293.9 rpm, 294 rpm, 294.1 rpm, 294.2 rpm, 294.3 rpm, 294.4 rpm, 294.5 rpm, 294.6 rpm, 294.7 rpm, 294.8 rpm, 294.9 rpm, 295 rpm, 295.1 rpm, 295.2 rpm, 295.3 rpm, 295.4 rpm, 295.5 rpm, 295.6 rpm, 295.7 rpm, 295.8 rpm, 295.9 rpm, 296 rpm, 296.1 rpm, 296.2 rpm, 296.3 rpm, 296.4 rpm, 296.5 rpm, 296.6 rpm, 296.7 rpm, 296.8 rpm, 296.9 rpm, 297 rpm, 297.1 rpm, 297.2 rpm, 297.3 rpm, 297.4 rpm, 297.5 rpm, 297.6 rpm, 297.7 rpm, 297.8 rpm, 297.9 rpm, 298 rpm, 298.1 rpm, 298.2 rpm, 298.3 rpm, 298.4 rpm, 298.5 rpm, 298.6 rpm, 298.7 rpm, 298.8 rpm, 298.9 rpm, 299 rpm, 299.1 rpm, 299.2 rpm, 299.3 rpm, 299.4 rpm, 299.5 rpm, 299.6 rpm, 299.7 rpm, 299.8 rpm, 299.9 rpm, 300 rpm, 300.1 rpm, 300.2 rpm, 300.3 rpm, 300.4 rpm, 300.5 rpm, 300.6 rpm, 300.7 rpm, 300.8 rpm, 300.9 rpm, 301 rpm, 301.1 rpm, 301.2 rpm, 301.3 rpm, 301.4 rpm, 301.5 rpm, 301.6 rpm, 301.7 rpm, 301.8 rpm, 301.9 rpm, 302 rpm, 302.1 rpm, 302.2 rpm, 302.3 rpm, 302.4 rpm, 302.5 rpm, 302.6 rpm, 302.7 rpm, 302.8 rpm, 302.9 rpm, 303 rpm, 303.1 rpm, 303.2 rpm, 303.3 rpm, 303.4 rpm, 303.5 rpm, 303.6 rpm, 303.7 rpm, 303.8 rpm, 303.9 rpm, 304 rpm, 304.1 rpm, 304.2 rpm, 304.3 rpm, 304.4 rpm, 304.5 rpm, 304.6 rpm, 304.7 rpm, 304.8 rpm, 304.9 rpm, 305 rpm, 305.1 rpm, 305.2 rpm, 305.3 rpm, 305.4 rpm, 305.5 rpm, 305.6 rpm, 305.7 rpm, 305.8 rpm, 305.9 rpm, 306 rpm, 306.1 rpm, 306.2 rpm, 306.3 rpm, 306.4 rpm, 306.5 rpm, 306.6 rpm, 306.7 rpm, 306.8 rpm, 306.9 rpm, 307 rpm, 307.1 rpm, 307.2 rpm, 307.3 rpm, 307.4 rpm, 307.5 rpm, 307.6 rpm, 307.7 rpm, 307.8 rpm, 307.9 rpm, 308 rpm, 308.1 rpm, 308.2 rpm, 308.3 rpm, 308.4 rpm, 308.5 rpm, 308.6 rpm, 308.7 rpm, 308.8 rpm, 308.9 rpm, 309 rpm, 309.1 rpm, 309.2 rpm, 309.3 rpm, 309.4 rpm, 309.5 rpm, 309.6 rpm, 309.7 rpm, 309.8 rpm, 309.9 rpm, 310 rpm, 310.1 rpm, 310.2 rpm, 310.3 rpm, 310.4 rpm, 310.5 rpm, 310.6 rpm, 310.7 rpm, 310.8 rpm, 310.9 rpm, 311 rpm, 311.1 rpm, 311.2 rpm, 311.3 rpm, 311.4 rpm, 311.5 rpm, 311.6 rpm, 311.7 rpm, 311.8 rpm, 311.9 rpm, 312 rpm, 312.1 rpm, 312.2 rpm, 312.3 rpm, 312.4 rpm, 312.5 rpm, 312.6 rpm, 312.7 rpm, 312.8 rpm, 312.9 rpm, 313 rpm, 313.1 rpm, 313.2 rpm, 313.3 rpm, 313.4 rpm, 313.5 rpm, 313.6 rpm, 313.7 rpm, 313.8 rpm, 313.9 rpm, 314 rpm, 314.1 rpm, 314.2 rpm, 314.3 rpm, 314.4 rpm, 314.5 rpm, 314.6 rpm, 314.7 rpm, 314.8 rpm, 314.9 rpm, 315 rpm, 315.1 rpm, 315.2 rpm, 315.3 rpm, 315.4 rpm, 315.5 rpm, 315.6 rpm, 315.7 rpm, 315.8 rpm, 315.9 rpm, 316 rpm, 316.1 rpm, 316.2 rpm, 316.3 rpm, 316.4 rpm, 316.5 rpm, 316.6 rpm, 316.7 rpm, 316.8 rpm, 316.9 rpm, 317 rpm, 317.1 rpm, 317.2 rpm, 317.3 rpm, 317.4 rpm, 317.5 rpm, 317.6 rpm, 317.7 rpm, 317.8 rpm, 317.9 rpm, 318 rpm, 318.1 rpm, 318.2 rpm, 318.3 rpm, 318.4 rpm, 318.5 rpm, 318.6 rpm, 318.7 rpm, 318.8 rpm, 318.9 rpm, 319 rpm, 319.1 rpm, 319.2 rpm, 319.3 rpm, 319.4 rpm, 319.5 rpm, 319.6 rpm, 319.7 rpm, 319.8 rpm, 319.9 rpm, 320 rpm, 320.1 rpm, 320.2 rpm, 320.3 rpm, 320.4 rpm, 320.5 rpm, 320.6 rpm, 320.7 rpm, 320.8 rpm, 320.9 rpm, 321 rpm, 321.1 rpm, 321.2 rpm, 321.3 rpm, 321.4 rpm, 321.5 rpm, 321.6 rpm, 321.7 rpm, 321.8 rpm, 321.9 rpm, 322 rpm, 322.1 rpm, 322.2 rpm, 322.3 rpm, 322.4 rpm, 322.5 rpm, 322.6 rpm, 322.7 rpm, 322.8 rpm, 322.9 rpm, 323 rpm, 323.1 rpm, 323.2 rpm, 323.3 rpm, 323.4 rpm, 323.5 rpm, 323.6 rpm, 323.7 rpm, 323.8 rpm, 323.9 rpm, 324 rpm, 324.1 rpm, 324.2 rpm, 324.3 rpm, 324.4 rpm, 324.5 rpm, 324.6 rpm, 324.7 rpm, 324.8 rpm, 324.9 rpm, 325 rpm, 325.1 rpm, 325.2 rpm, 325.3 rpm, 325.4 rpm, 325.5 rpm, 325.6 rpm, 325.7 rpm, 325.8 rpm, 325.9 rpm, 326 rpm, 326.1 rpm, 326.2 rpm, 326.3 rpm, 326.4 rpm, 326.5 rpm, 326.6 rpm, 326.7 rpm, 326.8 rpm, 326.9 rpm, 327 rpm, 327.1 rpm, 327.2 rpm, 327.3 rpm, 327.4 rpm, 327.5 rpm, 327.6 rpm, 327.7 rpm, 327.8 rpm, 327.9 rpm, 328 rpm, 328.1 rpm, 328.2 rpm, 328.3 rpm, 328.4 rpm, 328.5 rpm, 328.6 rpm, 328.7 rpm, 328.8 rpm, 328.9 rpm, 329 rpm, 329.1 rpm, 329.2 rpm, 329.3 rpm, 329.4 rpm, 329.5 rpm, 329.6 rpm, 329.7 rpm, 329.8 rpm, 329.9 rpm, 330 rpm, 330.1 rpm, 330.2 rpm, 330.3 rpm, 330.4 rpm, 330.5 rpm, 330.6 rpm, 330.7 rpm, 330.8 rpm, 330.9 rpm, 331 rpm, 331.1 rpm, 331.2 rpm, 331.3 rpm, 331.4 rpm, 331.5 rpm, 331.6 rpm, 331.7 rpm, 331.8 rpm, 331.9 rpm, 332 rpm, 332.1 rpm, 332.2 rpm, 332.3 rpm, 332.4 rpm, 332.5 rpm, 332.6 rpm, 332.7 rpm, 332.8 rpm, 332.9 rpm, 333 rpm, 333.1 rpm, 333.2 rpm, 333.3 rpm, 333.4 rpm, 333.5 rpm, 333.6 rpm, 333.7 rpm, 333.8 rpm, 333.9 rpm, 334 rpm, 334.1 rpm, 334.2 rpm, 334.3 rpm, 334.4 rpm, 334.5 rpm, 334.6 rpm, 334.7 rpm, 334.8 rpm, 334.9 rpm, 335 rpm, 335.1 rpm, 335.2 rpm, 335.3 rpm, 335.4 rpm, 335.5 rpm, 335.6 rpm, 335.7 rpm, 335.8 rpm, 335.9 rpm, 336 rpm, 336.1 rpm, 336.2 rpm, 336.3 rpm, 336.4 rpm, 336.5 rpm, 336.6 rpm, 336.7 rpm, 336.8 rpm, 336.9 rpm, 337 rpm, 337.1 rpm, 337.2 rpm, 337.3 rpm, 337.4 rpm, 337.5 rpm, 337.6 rpm, 337.7 rpm, 337.8 rpm, 337.9 rpm, 338 rpm, 338.1 rpm, 338.2 rpm, 338.3 rpm, 338.4 rpm, 338.5 rpm, 338.6 rpm, 338.7 rpm, 338.8 rpm, 338.9 rpm, 339 rpm, 339.1 rpm, 339.2 rpm, 339.3 rpm, 339.4 rpm, 339.5 rpm, 339.6 rpm, 339.7 rpm, 339.8 rpm, 339.9 rpm, 340 rpm, 340.1 rpm, 340.2 rpm, 340.3 rpm, 340.4 rpm, 340.5 rpm, 340.6 rpm, 340.7 rpm, 340.8 rpm, 340.9 rpm, 341 rpm, 341.1 rpm, 341.2 rpm, 341.3 rpm, 341.4 rpm, 341.5 rpm, 341.6 rpm, 341.7 rpm, 341.8 rpm, 341.9 rpm, 342 rpm, 342.1 rpm, 342.2 rpm, 342.3 rpm, 342.4 rpm, 342.5 rpm, 342.6 rpm, 342.7 rpm, 342.8 rpm, 342.9 rpm, 343 rpm, 343.1 rpm, 343.2 rpm, 343.3 rpm, 343.4 rpm, 343.5 rpm, 343.6 rpm, 343.7 rpm, 343.8 rpm, 343.9 rpm, 344 rpm, 344.1 rpm, 344.2 rpm, 344.3 rpm, 344.4 rpm, 344.5 rpm, 344.6 rpm, 344.7 rpm, 344.8 rpm, 344.9 rpm, 345 rpm, 345.1 rpm, 345.2 rpm, 345.3 rpm, 345.4 rpm, 345.5 rpm, 345.6 rpm, 345.7 rpm, 345.8 rpm, 345.9 rpm, 346 rpm, 346.1 rpm, 346.2 rpm, 346.3 rpm, 346.4 rpm, 346.5 rpm, 346.6 rpm, 346.7 rpm, 346.8 rpm, 346.9 rpm, 347 rpm, 347.1 rpm, 347.2 rpm, 347.3 rpm, 347.4 rpm, 347.5 rpm, 347.6 rpm, 347.7 rpm, 347.8 rpm, 347.9 rpm, 348 rpm, 348.1 rpm, 348.2 rpm, 348.3 rpm, 348.4 rpm, 348.5 rpm, 348.6 rpm, 348.7 rpm, 348.8 rpm, 348.9 rpm, 349 rpm, 349.1 rpm, 349.2 rpm, 349.3 rpm, 349.4 rpm, 349.5 rpm, 349.6 rpm, 349.7 rpm, 349.8 rpm, 349.9 rpm, 350 rpm, 350.1 rpm, 350.2 rpm, 350.3 rpm, 350.4 rpm, 350.5 rpm, 350.6 rpm, 350.7 rpm, 350.8 rpm, 350.9 rpm, 351 rpm, 351.1 rpm, 351.2 rpm, 351.3 rpm, 351.4 rpm, 351.5 rpm, 351.6 rpm, 351.7 rpm, 351.8 rpm, 351.9 rpm, 352 rpm, 352.1 rpm, 352.2 rpm, 352.3 rpm, 352.4 rpm, 352.5 rpm, 352.6 rpm, 352.7 rpm, 352.8 rpm, 352.9 rpm, 353 rpm, 353.1 rpm, 353.2 rpm, 353.3 rpm, 353.4 rpm, 353.5 rpm, 353.6 rpm, 353.7 rpm, 353.8 rpm, 353.9 rpm, 354 rpm, 354.1 rpm, 354.2 rpm, 354.3 rpm, 354.4 rpm, 354.5 rpm, 354.6 rpm, 354.7 rpm, 354.8 rpm, 354.9 rpm, 355 rpm, 355.1 rpm, 355.2 rpm, 355.3 rpm, 355.4 rpm, 355.5 rpm, 355.6 rpm, 355.7 rpm, 355.8 rpm, 355.9 rpm, 356 rpm, 356.1 rpm, 356.2 rpm, 356.3 rpm, 356.4 rpm, 356.5 rpm, 356.6 rpm, 356.7 rpm, 356.8 rpm, 356.9 rpm, 357 rpm, 357.1 rpm, 357.2 rpm, 357.3 rpm, 357.4 rpm, 357.5 rpm, 357.6 rpm, 357.7 rpm, 357.8 rpm, 357.9 rpm, 358 rpm, 358.1 rpm, 358.2 rpm, 358.3 rpm, 358.4 rpm, 358.5 rpm, 358.6 rpm, 358.7 rpm, 358.8 rpm, 358.9 rpm, 359 rpm, 359.1 rpm, 359.2 rpm, 359.3 rpm, 359.4 rpm, 359.5 rpm, 359.6 rpm, 359.7 rpm, 359.8 rpm, 359.9 rpm, 360 rpm, 360.1 rpm, 360.2 rpm, 360.3 rpm, 360.4 rpm, 360.5 rpm, 360.6 rpm, 360.7 rpm, 360.8 rpm, 360.9 rpm, 361 rpm, 361.1 rpm, 361.2 rpm, 361.3 rpm, 361.4 rpm, 361.5 rpm, 361.6 rpm, 361.7 rpm, 361.8 rpm, 361.9 rpm, 362 rpm, 362.1 rpm, 362.2 rpm, 362.3 rpm, 362.4 rpm, 362.5 rpm, 362.6 rpm, 362.7 rpm, 362.8 rpm, 362.9 rpm, 363 rpm, 363.1 rpm, 363.2 rpm, 363.3 rpm, 363.4 rpm, 363.5 rpm, 363.6 rpm, 363.7 rpm, 363.8 rpm, 363.9 rpm, 364 rpm, 364.1 rpm, 364.2 rpm, 364.3 rpm, 364.4 rpm, 364.5 rpm, 364.6 rpm, 364.7 rpm, 364.8 rpm, 364.9 rpm, 365 rpm, 365.1 rpm, 365.2 rpm, 365.3 rpm, 365.4 rpm, 365.5 rpm, 365.6 rpm, 365.7 rpm, 365.8 rpm, 365.9 rpm, 366 rpm, 366.1 rpm, 366.2 rpm, 366.3 rpm, 366.4 rpm, 366.5 rpm, 366.6 rpm, 366.7 rpm, 366.8 rpm, 366.9 rpm, 367 rpm, 367.1 rpm, 367.2 rpm, 367.3 rpm, 367.4 rpm, 367.5 rpm, 367.6 rpm, 367.7 rpm, 367.8 rpm, 367.9 rpm, 368 rpm, 368.1 rpm, 368.2 rpm, 368.3 rpm, 368.4 rpm, 368.5 rpm, 368.6 rpm, 368.7 rpm, 368.8 rpm, 368.9 rpm, 369 rpm, 369.1 rpm, 369.2 rpm, 369.3 rpm, 369.4 rpm, 369.5 rpm, 369.6 rpm, 369.7 rpm, 369.8 rpm, 369.9 rpm, 370 rpm, 370.1 rpm, 370.2 rpm, 370.3 rpm, 370.4 rpm, 370.5 rpm, 370.6 rpm, 370.7 rpm, 370.8 rpm, 370.9 rpm, 371 rpm, 371.1 rpm, 371.2 rpm, 371.3 rpm, 371.4 rpm, 371.5 rpm, 371.6 rpm, 371.7 rpm, 371.8 rpm, 371.9 rpm, 372 rpm, 372.1 rpm, 372.2 rpm, 372.3 rpm, 372.4 rpm, 372.5 rpm, 372.6 rpm, 372.7 rpm, 372.8 rpm, 372.9 rpm, 373 rpm, 373.1 rpm, 373.2 rpm, 373.3 rpm, 373.4 rpm, 373.5 rpm, 373.6 rpm, 373.7 rpm, 373.8 rpm, 373.9 rpm, 374 rpm, 374.1 rpm, 374.2 rpm, 374.3 rpm, 374.4 rpm, 374.5 rpm, 374.6 rpm, 374.7 rpm, 374.8 rpm, 374.9 rpm, 375 rpm, 375.1 rpm, 375.2 rpm, 375.3 rpm, 375.4 rpm, 375.5 rpm, 375.6 rpm, 375.7 rpm, 375.8 rpm, 375.9 rpm, 376 rpm, 376.1 rpm, 376.2 rpm, 376.3 rpm, 376.4 rpm, 376.5 rpm, 376.6 rpm, 376.7 rpm, 376.8 rpm, 376.9 rpm, 377 rpm, 377.1 rpm, 377.2 rpm, 377.3 rpm, 377.4 rpm, 377.5 rpm, 377.6 rpm, 377.7 rpm, 377.8 rpm, 377.9 rpm, 378 rpm, 378.1 rpm, 378.2 rpm, 378.3 rpm, 378.4 rpm, 378.5 rpm, 378.6 rpm, 378.7 rpm, 378.8 rpm, 378.9 rpm, 379 rpm, 379.1 rpm, 379.2 rpm, 379.3 rpm, 379.4 rpm, 379.5 rpm, 379.6 rpm, 379.7 rpm, 379.8 rpm, 379.9 rpm, 380 rpm, 380.1 rpm, 380.2 rpm, 380.3 rpm, 380.4 rpm, 380.5 rpm, 380.6 rpm, 380.7 rpm, 380.8 rpm, 380.9 rpm, 381 rpm, 381.1 rpm, 381.2 rpm, 381.3 rpm, 381.4 rpm, 381.5 rpm, 381.6 rpm, 381.7 rpm, 381.8 rpm, 381.9 rpm, 382 rpm, 382.1 rpm, 382.2 rpm, 382.3 rpm, 382.4 rpm, 382.5 rpm, 382.6 rpm, 382.7 rpm, 382.8 rpm, 382.9 rpm, 383 rpm, 383.1 rpm, 383.2 rpm, 383.3 rpm, 383.4 rpm, 383.5 rpm, 383.6 rpm, 383.7 rpm, 383.8 rpm, 383.9 rpm, 384 rpm, 384.1 rpm, 384.2 rpm, 384.3 rpm, 384.4 rpm, 384.5 rpm, 384.6 rpm, 384.7 rpm, 384.8 rpm, 384.9 rpm, 385 rpm, 385.1 rpm, 385.2 rpm, 385.3 rpm, 385.4 rpm, 385.5 rpm, 385.6 rpm, 385.7 rpm, 385.8 rpm, 385.9 rpm, 386 rpm, 386.1 rpm, 386.2 rpm, 386.3 rpm, 386.4 rpm, 386.5 rpm, 386.6 rpm, 386.7 rpm, 386.8 rpm, 386.9 rpm, 387 rpm, 387.1 rpm, 387.2 rpm, 387.3 rpm, 387.4 rpm, 387.5 rpm, 387.6 rpm, 387.7 rpm, 387.8 rpm, 387.9 rpm, 388 rpm, 388.1 rpm, 388.2 rpm, 388.3 rpm, 388.4 rpm, 388.5 rpm, 388.6 rpm, 388.7 rpm, 388.8 rpm, 388.9 rpm, 389 rpm, 389.1 rpm, 389.2 rpm, 389.3 rpm, 389.4 rpm, 389.5 rpm, 389.6 rpm, 389.7 rpm, 389.8 rpm, 389.9 rpm, 390 rpm, 390.1 rpm, 390.2 rpm, 390.3 rpm, 390.4 rpm, 390.5 rpm, 390.6 rpm, 390.7 rpm, 390.8 rpm, 390.9 rpm, 391 rpm, 391.1 rpm, 391.2 rpm, 391.3 rpm, 391.4 rpm, 391.5 rpm, 391.6 rpm, 391.7 rpm, 391.8 rpm, 391.9 rpm, 392 rpm, 392.1 rpm, 392.2 rpm, 392.3 rpm, 392.4 rpm, 392.5 rpm, 392.6 rpm, 392.7 rpm, 392.8 rpm, 392.9 rpm, 393 rpm, 393.1 rpm, 393.2 rpm, 393.3 rpm, 393.4 rpm, 393.5 rpm, 393.6 rpm, 393.7 rpm, 393.8 rpm, 393.9 rpm, 394 rpm, 394.1 rpm, 394.2 rpm, 394.3 rpm, 394.4 rpm, 394.5 rpm, 394.6 rpm, 394.7 rpm, 394.8 rpm, 394.9 rpm, 395 rpm, 395.1 rpm, 395.2 rpm, 395.3 rpm, 395.4 rpm, 395.5 rpm, 395.6 rpm, 395.7 rpm, 395.8 rpm, 395.9 rpm, 396 rpm, 396.1 rpm, 396.2 rpm, 396.3 rpm, 396.4 rpm, 396.5 rpm, 396.6 rpm, 396.7 rpm, 396.8 rpm, 396.9 rpm, 397 rpm, 397.1 rpm, 397.2 rpm, 397.3 rpm, 397.4 rpm, 397.5 rpm, 397.6 rpm, 397.7 rpm, 397.8 rpm, 397.9 rpm, 398 rpm, 398.1 rpm, 398.2 rpm, 398.3 rpm, 398.4 rpm, 398.5 rpm, 398.6 rpm, 398.7 rpm, 398.8 rpm, 398.9 rpm, 399 rpm, 399.1 rpm, 399.2 rpm, 399.3 rpm, 399.4 rpm, 399.5 rpm, 399.6 rpm, 399.7 rpm, 399.8 rpm, 399.9 rpm, 400 rpm, 400.1 rpm, 400.2 rpm, 400.3 rpm, 400.4 rpm, 400.5 rpm, 400.6 rpm, 400.7 rpm, 400.8 rpm, 400.9 rpm, 401 rpm, 401.1 rpm, 401.2 rpm, 401.3 rpm, 401.4 rpm, 401.5 rpm, 401.6 rpm, 401.7 rpm, 401.8 rpm, 401.9 rpm, 402 rpm, 402.1 rpm, 402.2 rpm, 402.3 rpm, 402.4 rpm, 402.5 rpm, 402.6 rpm, 402.7 rpm, 402.8 rpm, 402.9 rpm, 403 rpm, 403.1 rpm, 403.2 rpm, 403.3 rpm, 403.4 rpm, 403.5 rpm, 403.6 rpm, 403.7 rpm, 403.8 rpm, 403.9 rpm, 404 rpm, 404.1 rpm, 404.2 rpm, 404.3 rpm, 404.4 rpm, 404.5 rpm, 404.6 rpm, 404.7 rpm, 404.8 rpm, 404.9 rpm, 405 rpm, 405.1 rpm, 405.2 rpm, 405.3 rpm, 405.4 rpm, 405.5 rpm, 405.6 rpm, 405.7 rpm, 405.8 rpm, 405.9 rpm, 406 rpm, 406.1 rpm, 406.2 rpm, 406.3 rpm, 406.4 rpm, 406.5 rpm, 406.6 rpm, 406.7 rpm, 406.8 rpm, 406.9 rpm, 407 rpm, 407.1 rpm, 407.2 rpm, 407.3 rpm, 407.4 rpm, 407.5 rpm, 407.6 rpm, 407.7 rpm, 407.8 rpm, 407.9 rpm, 408 rpm, 408.1 rpm, 408.2 rpm, 408.3 rpm, 408.4 rpm, 408.5 rpm, 408.6 rpm, 408.7 rpm, 408.8 rpm, 408.9 rpm, 409 rpm, 409.1 rpm, 409.2 rpm, 409.3 rpm, 409.4 rpm, 409.5 rpm, 409.6 rpm, 409.7 rpm, 409.8 rpm, 409.9 rpm, 410 rpm, 410.1 rpm, 410.2 rpm, 410.3 rpm, 410.4 rpm, 410.5 rpm, 410.6 rpm, 410.7 rpm, 410.8 rpm, 410.9 rpm, 411 rpm, 411.1 rpm, 411.2 rpm, 411.3 rpm, 411.4 rpm, 411.5 rpm, 411.6 rpm, 411.7 rpm, 411.8 rpm, 411.9 rpm, 412 rpm, 412.1 rpm, 412.2 rpm, 412.3 rpm, 412.4 rpm, 412.5 rpm, 412.6 rpm, 412.7 rpm, 412.8 rpm, 412.9 rpm, 413 rpm, 413.1 rpm, 413.2 rpm, 413.3 rpm, 413.4 rpm, 413.5 rpm, 413.6 rpm, 413.7 rpm, 413.8 rpm, 413.9 rpm, 414 rpm, 414.1 rpm, 414.2 rpm, 414.3 rpm, 414.4 rpm, 414.5 rpm, 414.6 rpm, 414.7 rpm, 414.8 rpm, 414.9 rpm, 415 rpm, 415.1 rpm, 415.2 rpm, 415.3 rpm, 415.4 rpm, 415.5 rpm, 415.6 rpm, 415.7 rpm, 415.8 rpm, 415.9 rpm, 416 rpm, 416.1 rpm, 416.2 rpm, 416.3 rpm, 416.4 rpm, 416.5 rpm, 416.6 rpm, 416.7 rpm, 416.8 rpm, 416.9 rpm, 417 rpm, 417.1 rpm, 417.2 rpm, 417.3 rpm, 417.4 rpm, 417.5 rpm, 417.6 rpm, 417.7 rpm, 417.8 rpm, 417.9 rpm, 418 rpm, 418.1 rpm, 418.2 rpm, 418.3 rpm, 418.4 rpm, 418.5 rpm, 418.6 rpm, 418.7 rpm, 418.8 rpm, 418.9 rpm, 419 rpm, 419.1 rpm, 419.2 rpm, 419.3 rpm, 419.4 rpm, 419.5 rpm, 419.6 rpm, 419.7 rpm, 419.8 rpm, 419.9 rpm, 420 rpm, 420.1 rpm, 420.2 rpm, 420.3 rpm, 420.4 rpm, 420.5 rpm, 420.6 rpm, 420.7 rpm, 420.8 rpm, 420.9 rpm, 421 rpm, 421.1 rpm, 421.2 rpm, 421.3 rpm, 421.4 rpm, 421.5 rpm, 421.6 rpm, 421.7 rpm, 421.8 rpm, 421.9 rpm, 422 rpm, 422.1 rpm, 422.2 rpm, 422.3 rpm, 422.4 rpm, 422.5 rpm, 422.6 rpm, 422.7 rpm, 422.8 rpm, 422.9 rpm, 423 rpm, 423.1 rpm, 423.2 rpm, 423.3 rpm, 423.4 rpm, 423.5 rpm, 423.6 rpm, 423.7 rpm, 423.8 rpm, 423.9 rpm, 424 rpm, 424.1 rpm, 424.2 rpm, 424.3 rpm, 424.4 rpm, 424.5 rpm, 424.6 rpm, 424.7 rpm, 424.8 rpm, 424.9 rpm, 425 rpm, 425.1 rpm, 425.2 rpm, 425.3 rpm, 425.4 rpm, 425.5 rpm, 425.6 rpm, 425.7 rpm, 425.8 rpm, 425.9 rpm, 426 rpm, 426.1 rpm, 426.2 rpm, 426.3 rpm, 426.4 rpm, 426.5 rpm, 426.6 rpm, 426.7 rpm, 426.8 rpm, 426.9 rpm, 427 rpm, 427.1 rpm, 427.2 rpm, 427.3 rpm, 427.4 rpm, 427.5 rpm, 427.6 rpm, 427.7 rpm, 427.8 rpm, 427.9 rpm, 428 rpm, 428.1 rpm, 428.2 rpm, 428.3 rpm, 428.4 rpm, 428.5 rpm, 428.6 rpm, 428.7 rpm, 428.8 rpm, 428.9 rpm, 429 rpm, 429.1 rpm, 429.2 rpm, 429.3 rpm, 429.4 rpm, 429.5 rpm, 429.6 rpm, 429.7 rpm, 429.8 rpm, 429.9 rpm, 430 rpm, 430.1 rpm, 430.2 rpm, 430.3 rpm, 430.4 rpm, 430.5 rpm, 430.6 rpm, 430.7 rpm, 430.8 rpm, 430.9 rpm, 431 rpm, 431.1 rpm, 431.2 rpm, 431.3 rpm, 431.4 rpm, 431.5 rpm, 431.6 rpm, 431.7 rpm, 431.8 rpm, 431.9 rpm, 432 rpm, 432.1 rpm, 432.2 rpm, 432.3 rpm, 432.4 rpm, 432.5 rpm, 432.6 rpm, 432.7 rpm, 432.8 rpm, 432.9 rpm, 433 rpm, 433.1 rpm, 433.2 rpm, 433.3 rpm, 433.4 rpm, 433.5 rpm, 433.6 rpm, 433.7 rpm, 433.8 rpm, 433.9 rpm, 434 rpm, 434.1 rpm, 434.2 rpm, 434.3 rpm, 434.4 rpm, 434.5 rpm, 434.6 rpm, 434.7 rpm, 434.8 rpm, 434.9 rpm, 435 rpm, 435.1 rpm, 435.2 rpm, 435.3 rpm, 435.4 rpm, 435.5 rpm, 435.6 rpm, 435.7 rpm, 435.8 rpm, 435.9 rpm, 436 rpm, 436.1 rpm, 436.2 rpm, 436.3 rpm, 436.4 rpm, 436.5 rpm, 436.6 rpm, 436.7 rpm, 436.8 rpm, 436.9 rpm, 437 rpm, 437.1 rpm, 437.2 rpm, 437.3 rpm, 437.4 rpm, 437.5 rpm, 437.6 rpm, 437.7 rpm, 437.8 rpm, 437.9 rpm, 438 rpm, 438.1 rpm, 438.2 rpm, 438.3 rpm, 438.4 rpm, 438.5 rpm, 438.6 rpm, 438.7 rpm, 438.8 rpm, 438.9 rpm, 439 rpm, 439.1 rpm, 439.2 rpm, 439.3 rpm, 439.4 rpm, 439.5 rpm, 439.6 rpm, 439.7 rpm, 439.8 rpm, 439.9 rpm, 440 rpm, 440.1 rpm, 440.2 rpm, 440.3 rpm, 440.4 rpm, 440.5 rpm, 440.6 rpm, 440.7 rpm, 440.8 rpm, 440.9 rpm, 441 rpm, 441.1 rpm, 441.2 rpm, 441.3 rpm, 441.4 rpm, 441.5 rpm, 441.6 rpm, 441.7 rpm, 441.8 rpm, 441.9 rpm, 442 rpm, 442.1 rpm, 442.2 rpm, 442.3 rpm, 442.4 rpm, 442.5 rpm, 442.6 rpm, 442.7 rpm, 442.8 rpm, 442.9 rpm, 443 rpm, 443.1 rpm, 443.2 rpm, 443.3 rpm, 443.4 rpm, 443.5 rpm, 443.6 rpm, 443.7 rpm, 443.8 rpm, 443.9 rpm, 444 rpm, 444.1 rpm, 444.2 rpm, 444.3 rpm, 444.4 rpm, 444.5 rpm, 444.6 rpm, 444.7 rpm, 444.8 rpm, 444.9 rpm, 445 rpm, 445.1 rpm, 445.2 rpm, 445.3 rpm, 445.4 rpm, 445.5 rpm, 445.6 rpm, 445.7 rpm, 445.8 rpm, 445.9 rpm, 446 rpm, 446.1 rpm, 446.2 rpm, 446.3 rpm, 446.4 rpm, 446.5 rpm, 446.6 rpm, 446.7 rpm, 446.8 rpm, 446.9 rpm, 447 rpm, 447.1 rpm, 447.2 rpm, 447.3 rpm, 447.4 rpm, 447.5 rpm, 447.6 rpm, 447.7 rpm, 447.8 rpm, 447.9 rpm, 448 rpm, 448.1 rpm, 448.2 rpm, 448.3 rpm, 448.4 rpm, 448.5 rpm, 448.6 rpm, 448.7 rpm, 448.8 rpm, 448.9 rpm, 449 rpm, 449.1 rpm, 449.2 rpm, 449.3 rpm, 449.4 rpm, 449.5 rpm, 449.6 rpm, 449.7 rpm, 449.8 rpm, 449.9 rpm, 450 rpm, 450.1 rpm, 450.2 rpm, 450.3 rpm, 450.4 rpm, 450.5 rpm, 450.6 rpm, 450.7 rpm, 450.8 rpm, 450.9 rpm, 451 rpm, 451.1 rpm, 451.2 rpm, 451.3 rpm, 451.4 rpm, 451.5 rpm, 451.6 rpm, 451.7 rpm, 451.8 rpm, 451.9 rpm, 452 rpm, 452.1 rpm, 452.2 rpm, 452.3 rpm, 452.4 rpm, 452.5 rpm, 452.6 rpm, 452.7 rpm, 452.8 rpm, 452.9 rpm, 453 rpm, 453.1 rpm, 453.2 rpm, 453.3 rpm, 453.4 rpm, 453.5 rpm, 453.6 rpm, 453.7 rpm, 453.8 rpm, 453.9 rpm, 454 rpm, 454.1 rpm, 454.2 rpm, 454.3 rpm, 454.4 rpm, 454.5 rpm, 454.6 rpm, 454.7 rpm, 454.8 rpm, 454.9 rpm, 455 rpm, 455.1 rpm, 455.2 rpm, 455.3 rpm, 455.4 rpm, 455.5 rpm, 455.6 rpm, 455.7 rpm, 455.8 rpm, 455.9 rpm, 456 rpm, 456.1 rpm, 456.2 rpm, 456.3 rpm, 456.4 rpm, 456.5 rpm, 456.6 rpm, 456.7 rpm, 456.8 rpm, 456.9 rpm, 457 rpm, 457.1 rpm, 457.2 rpm, 457.3 rpm, 457.4 rpm, 457.5 rpm, 457.6 rpm, 457.7 rpm, 457.8 rpm, 457.9 rpm, 458 rpm, 458.1 rpm, 458.2 rpm, 458.3 rpm, 458.4 rpm, 458.5 rpm, 458.6 rpm, 458.7 rpm, 458.8 rpm, 458.9 rpm, 459 rpm, 459.1 rpm, 459.2 rpm, 459.3 rpm, 459.4 rpm, 459.5 rpm, 459.6 rpm, 459.7 rpm, 459.8 rpm, 459.9 rpm, 460 rpm, 460.1 rpm, 460.2 rpm, 460.3 rpm, 460.4 rpm, 460.5 rpm, 460.6 rpm, 460.7 rpm, 460.8 rpm, 460.9 rpm, 461 rpm, 461.1 rpm, 461.2 rpm, 461.3 rpm, 461.4 rpm, 461.5 rpm, 461.6 rpm, 461.7 rpm, 461.8 rpm, 461.9 rpm, 462 rpm, 462.1 rpm, 462.2 rpm, 462.3 rpm, 462.4 rpm, 462.5 rpm, 462.6 rpm, 462.7 rpm, 462.8 rpm, 462.9 rpm, 463 rpm, 463.1 rpm, 463.2 rpm, 463.3 rpm, 463.4 rpm, 463.5 rpm, 463.6 rpm, 463.7 rpm, 463.8 rpm, 463.9 rpm, 464 rpm, 464.1 rpm, 464.2 rpm, 464.3 rpm, 464.4 rpm, 464.5 rpm, 464.6 rpm, 464.7 rpm, 464.8 rpm, 464.9 rpm, 465 rpm, 465.1 rpm, 465.2 rpm, 465.3 rpm, 465.4 rpm, 465.5 rpm, 465.6 rpm, 465.7 rpm, 465.8 rpm, 465.9 rpm, 466 rpm, 466.1 rpm, 466.2 rpm, 466.3 rpm, 466.4 rpm, 466.5 rpm, 466.6 rpm, 466.7 rpm, 466.8 rpm, 466.9 rpm, 467 rpm, 467.1 rpm, 467.2 rpm, 467.3 rpm, 467.4 rpm, 467.5 rpm, 467.6 rpm, 467.7 rpm, 467.8 rpm, 467.9 rpm, 468 rpm, 468.1 rpm, 468.2 rpm, 468.3 rpm, 468.4 rpm, 468.5 rpm, 468.6 rpm, 468.7 rpm, 468.8 rpm, 468.9 rpm, 469 rpm, 469.1 rpm, 469.2 rpm, 469.3 rpm, 469.4 rpm, 469.5 rpm, 469.6 rpm, 469.7 rpm, 469.8 rpm, 469.9 rpm, 470 rpm, 470.1 rpm, 470.2 rpm, 470.3 rpm, 470.4 rpm, 470.5 rpm, 470.6 rpm, 470.7 rpm, 470.8 rpm, 470.9 rpm, 471 rpm, 471.1 rpm, 471.2 rpm, 471.3 rpm, 471.4 rpm, 471.5 rpm, 471.6 rpm, 471.7 rpm, 471.8 rpm, 471.9 rpm, 472 rpm, 472.1 rpm, 472.2 rpm, 472.3 rpm, 472.4 rpm, 472.5 rpm, 472.6 rpm, 472.7 rpm, 472.8 rpm, 472.9 rpm, 473 rpm, 473.1 rpm, 473.2 rpm, 473.3 rpm, 473.4 rpm, 473.5 rpm, 473.6 rpm, 473.7 rpm, 473.8 rpm, 473.9 rpm, 474 rpm, 474.1 rpm, 474.2 rpm, 474.3 rpm, 474.4 rpm, 474.5 rpm, 474.6 rpm, 474.7 rpm, 474.8 rpm, 474.9 rpm, 475 rpm, 475.1 rpm, 475.2 rpm, 475.3 rpm, 475.4 rpm, 475.5 rpm, 475.6 rpm, 475.7 rpm, 475.8 rpm, 475.9 rpm, 476 rpm, 476.1 rpm, 476.2 rpm, 476.3 rpm, 476.4 rpm, 476.5 rpm, 476.6 rpm, 476.7 rpm, 476.8 rpm, 476.9 rpm, 477 rpm, 477.1 rpm, 477.2 rpm, 477.3 rpm, 477.4 rpm, 477.5 rpm, 477.6 rpm, 477.7 rpm, 477.8 rpm, 477.9 rpm, 478 rpm, 478.1 rpm, 478.2 rpm, 478.3 rpm, 478.4 rpm, 478.5 rpm, 478.6 rpm, 478.7 rpm, 478.8 rpm, 478.9 rpm, 479 rpm, 479.1 rpm, 479.2 rpm, 479.3 rpm, 479.4 rpm, 479.5 rpm, 479.6 rpm, 479.7 rpm, 479.8 rpm, 479.9 rpm, 480 rpm, 480.1 rpm, 480.2 rpm, 480.3 rpm, 480.4 rpm, 480.5 rpm, 480.6 rpm, 480.7 rpm, 480.8 rpm, 480.9 rpm, 481 rpm, 481.1 rpm, 481.2 rpm, 481.3 rpm, 481.4 rpm, 481.5 rpm, 481.6 rpm, 481.7 rpm, 481.8 rpm, 481.9 rpm, 482 rpm, 482.1 rpm, 482.2 rpm, 482.3 rpm, 482.4 rpm, 482.5 rpm, 482.6 rpm, 482.7 rpm, 482.8 rpm, 482.9 rpm, 483 rpm, 483.1 rpm, 483.2 rpm, 483.3 rpm, 483.4 rpm, 483.5 rpm, 483.6 rpm, 483.7 rpm, 483.8 rpm, 483.9 rpm, 484 rpm, 484.1 rpm, 484.2 rpm, 484.3 rpm, 484.4 rpm, 484.5 rpm, 484.6 rpm, 484.7 rpm, 484.8 rpm, 484.9 rpm, 485 rpm, 485.1 rpm, 485.2 rpm, 485.3 rpm, 485.4 rpm, 485.5 rpm, 485.6 rpm, 485.7 rpm, 485.8 rpm, 485.9 rpm, 486 rpm, 486.1 rpm, 486.2 rpm, 486.3 rpm, 486.4 rpm, 486.5 rpm, 486.6 rpm, 486.7 rpm, 486.8 rpm, 486.9 rpm, 487 rpm, 487.1 rpm, 487.2 rpm, 487.3 rpm, 487.4 rpm, 487.5 rpm, 487.6 rpm, 487.7 rpm, 487.8 rpm, 487.9 rpm, 488 rpm, 488.1 rpm, 488.2 rpm, 488.3 rpm, 488.4 rpm, 488.5 rpm, 488.6 rpm, 488.7 rpm, 488.8 rpm, 488.9 rpm, 489 rpm, 489.1 rpm, 489.2 rpm, 489.3 rpm, 489.4 rpm, 489.5 rpm, 489.6 rpm, 489.7 rpm, 489.8 rpm, 489.9 rpm, 490 rpm, 490.1 rpm, 490.2 rpm, 490.3 rpm, 490.4 rpm, 490.5 rpm, 490.6 rpm, 490.7 rpm, 490.8 rpm, 490.9 rpm, 491 rpm, 491.1 rpm, 491.2 rpm, 491.3 rpm, 491.4 rpm, 491.5 rpm, 491.6 rpm, 491.7 rpm, 491.8 rpm, 491.9 rpm, 492 rpm, 492.1 rpm, 492.2 rpm, 492.3 rpm, 492.4 rpm, 492.5 rpm, 492.6 rpm, 492.7 rpm, 492.8 rpm, 492.9 rpm, 493 rpm, 493.1 rpm, 493.2 rpm, 493.3 rpm, 493.4 rpm, 493.5 rpm, 493.6 rpm, 493.7 rpm, 493.8 rpm, 493.9 rpm, 494 rpm, 494.1 rpm, 494.2 rpm, 494.3 rpm, 494.4 rpm, 494.5 rpm, 494.6 rpm, 494.7 rpm, 494.8 rpm, 494.9 rpm, 495 rpm, 495.1 rpm, 495.2 rpm, 495.3 rpm, 495.4 rpm, 495.5 rpm, 495.6 rpm, 495.7 rpm, 495.8 rpm, 495.9 rpm, 496 rpm, 496.1 rpm, 496.2 rpm, 496.3 rpm, 496.4 rpm, 496.5 rpm, 496.6 rpm, 496.7 rpm, 496.8 rpm, 496.9 rpm, 497 rpm, 497.1 rpm, 497.2 rpm, 497.3 rpm, 497.4 rpm, 497.5 rpm, 497.6 rpm, 497.7 rpm, 497.8 rpm, 497.9 rpm, 498 rpm, 498.1 rpm, 498.2 rpm, 498.3 rpm, 498.4 rpm, 498.5 rpm, 498.6 rpm, 498.7 rpm, 498.8 rpm, 498.9 rpm, 499 rpm, 499.1 rpm, 499.2 rpm, 499.3 rpm, 499.4 rpm, 499.5 rpm, 499.6 rpm, 499.7 rpm, 499.8 rpm, 499.9 rpm, 500 rpm, 500.1 rpm, 500.2 rpm, 500.3 rpm, 500.4 rpm, 500.5 rpm, 500.6 rpm, 500.7 rpm, 500.8 rpm, 500.9 rpm, 501 rpm, 501.1 rpm, 501.2 rpm, 501.3 rpm, 501.4 rpm, 501.5 rpm, 501.6 rpm, 501.7 rpm, 501.8 rpm, 501.9 rpm, 502 rpm, 502.1 rpm, 502.2 rpm, 502.3 rpm, 502.4 rpm, 502.5 rpm, 502.6 rpm, 502.7 rpm, 502.8 rpm, 502.9 rpm, 503 rpm, 503.1 rpm, 503.2 rpm, 503.3 rpm, 503.4 rpm, 503.5 rpm, 503.6 rpm, 503.7 rpm, 503.8 rpm, 503.9 rpm, 504 rpm, 504.1 rpm, 504.2 rpm, 504.3 rpm, 504.4 rpm, 504.5 rpm, 504.6 rpm, 504.7 rpm, 504.8 rpm, 504.9 rpm, 505 rpm, 505.1 rpm, 505.2 rpm, 505.3 rpm, 505.4 rpm, 505.5 rpm, 505.6 rpm, 505.7 rpm, 505.8 rpm, 505.9 rpm, 506 rpm, 506.1 rpm, 506.2 rpm, 506.3 rpm, 506.4 rpm, 506.5 rpm, 506.6 rpm, 506.7 rpm, 506.8 rpm, 506.9 rpm, 507 rpm, 507.1 rpm, 507.2 rpm, 507.3 rpm, 507.4 rpm, 507.5 rpm, 507.6 rpm, 507.7 rpm, 507.8 rpm, 507.9 rpm, 508 rpm, 508.1 rpm, 508.2 rpm, 508.3 rpm, 508.4 rpm, 508.5 rpm, 508.6 rpm, 508.7 rpm, 508.8 rpm, 508.9 rpm, 509 rpm, 509.1 rpm, 509.2 rpm, 509.3 rpm, 509.4 rpm, 509.5 rpm, 509.6 rpm, 509.7 rpm, 509.8 rpm, 509.9 rpm, 510 rpm, 510.1 rpm, 510.2 rpm, 510.3 rpm, 510.4 rpm, 510.5 rpm, 510.6 rpm, 510.7 rpm, 510.8 rpm, 510.9 rpm, 511 rpm, 511.1 rpm, 511.2 rpm, 511.3 rpm, 511.4 rpm, 511.5 rpm, 511.6 rpm, 511.7 rpm, 511.8 rpm, 511.9 rpm, 512 rpm, 512.1 rpm, 512.2 rpm, 512.3 rpm, 512.4 rpm, 512.5 rpm, 512.6 rpm, 512.7 rpm, 512.8 rpm, 512.9 rpm, 513 rpm, 513.1 rpm, 513.2 rpm, 513.3 rpm, 513.4 rpm, 513.5 rpm, 513.6 rpm, 513.7 rpm, 513.8 rpm, 513.9 rpm, 514 rpm, 514.1 rpm, 514.2 rpm, 514.3 rpm, 514.4 rpm, 514.5 rpm, 514.6 rpm, 514.7 rpm, 514.8 rpm, 514.9 rpm, 515 rpm, 515.1 rpm, 515.2 rpm, 515.3 rpm, 515.4 rpm, 515.5 rpm, 515.6 rpm, 515.7 rpm, 515.8 rpm, 515.9 rpm, 516 rpm, 516.1 rpm, 516.2 rpm, 516.3 rpm, 516.4 rpm, 516.5 rpm, 516.6 rpm, 516.7 rpm, 516.8 rpm, 516.9 rpm, 517 rpm, 517.1 rpm, 517.2 rpm, 517.3 rpm, 517.4 rpm, 517.5 rpm, 517.6 rpm, 517.7 rpm, 517.8 rpm, 517.9 rpm, 518 rpm, 518.1 rpm, 518.2 rpm, 518.3 rpm, 518.4 rpm, 518.5 rpm, 518.6 rpm, 518.7 rpm, 518.8 rpm, 518.9 rpm, 519 rpm, 519.1 rpm, 519.2 rpm, 519.3 rpm, 519.4 rpm, 519.5 rpm, 519.6 rpm, 519.7 rpm, 519.8 rpm, 519.9 rpm, 520 rpm, 520.1 rpm, 520.2 rpm, 520.3 rpm, 520.4 rpm, 520.5 rpm, 520.6 rpm, 520.7 rpm, 520.8 rpm, 520.9 rpm, 521 rpm, 521.1 rpm, 521.2 rpm, 521.3 rpm, 521.4 rpm, 521.5 rpm, 521.6 rpm, 521.7 rpm, 521.8 rpm, 521.9 rpm, 522 rpm, 522.1 rpm, 522.2 rpm, 522.3 rpm, 522.4 rpm, 522.5 rpm, 522.6 rpm, 522.7 rpm, 522.8 rpm, 522.9 rpm, 523 rpm, 523.1 rpm, 523.2 rpm, 523.3 rpm, 523.4 rpm, 523.5 rpm, 523.6 rpm, 523.7 rpm, 523.8 rpm, 523.9 rpm, 524 rpm, 524.1 rpm, 524.2 rpm, 524.3 rpm, 524.4 rpm, 524.5 rpm, 524.6 rpm, 524.7 rpm, 524.8 rpm, 524.9 rpm, 525 rpm, 525.1 rpm, 525.2 rpm, 525.3 rpm, 525.4 rpm, 525.5 rpm, 525.6 rpm, 525.7 rpm, 525.8 rpm, 525.9 rpm, 526 rpm, 526.1 rpm, 526.2 rpm, 526.3 rpm, 526.4 rpm, 526.5 rpm, 526.6 rpm, 526.7 rpm, 526.8 rpm, 526.9 rpm, 527 rpm, 527.1 rpm, 527.2 rpm, 527.3 rpm, 527.4 rpm, 527.5 rpm, 527.6 rpm, 527.7 rpm, 527.8 rpm, 527.9 rpm, 528 rpm, 528.1 rpm, 528.2 rpm, 528.3 rpm, 528.4 rpm, 528.5 rpm, 528.6 rpm, 528.7 rpm, 528.8 rpm, 528.9 rpm, 529 rpm, 529.1 rpm, 529.2 rpm, 529.3 rpm, 529.4 rpm, 529.5 rpm, 529.6 rpm, 529.7 rpm, 529.8 rpm, 529.9 rpm, 530 rpm, 530.1 rpm, 530.2 rpm, 530.3 rpm, 530.4 rpm, 530.5 rpm, 530.6 rpm, 530.7 rpm, 530.8 rpm, 530.9 rpm, 531 rpm, 531.1 rpm, 531.2 rpm, 531.3 rpm, 531.4 rpm, 531.5 rpm, 531.6 rpm, 531.7 rpm, 531.8 rpm, 531.9 rpm, 532 rpm, 532.1 rpm, 532.2 rpm, 532.3 rpm, 532.4 rpm, 532.5 rpm, 532.6 rpm, 532.7 rpm, 532.8 rpm, 532.9 rpm, 533 rpm, 533.1 rpm, 533.2 rpm, 533.3 rpm, 533.4 rpm, 533.5 rpm, 533.6 rpm, 533.7 rpm, 533.8 rpm, 533.9 rpm, 534 rpm, 534.1 rpm, 534.2 rpm, 534.3 rpm, 534.4 rpm, 534.5 rpm, 534.6 rpm, 534.7 rpm, 534.8 rpm, 534.9 rpm, 535 rpm, 535.1 rpm, 535.2 rpm, 535.3 rpm, 535.4 rpm, 535.5 rpm, 535.6 rpm, 535.7 rpm, 535.8 rpm, 535.9 rpm, 536 rpm, 536.1 rpm, 536.2 rpm, 536.3 rpm, 536.4 rpm, 536.5 rpm, 536.6 rpm, 536.7 rpm, 536.8 rpm, 536.9 rpm, 537 rpm, 537.1 rpm, 537.2 rpm, 537.3 rpm, 537.4 rpm, 537.5 rpm, 537.6 rpm, 537.7 rpm, 537.8 rpm, 537.9 rpm, 538 rpm, 538.1 rpm, 538.2 rpm, 538.3 rpm, 538.4 rpm, 538.5 rpm, 538.6 rpm, 538.7 rpm, 538.8 rpm, 538.9 rpm, 539 rpm, 539.1 rpm, 539.2 rpm, 539.3 rpm, 539.4 rpm, 539.5 rpm, 539.6 rpm, 539.7 rpm, 539.8 rpm, 539.9 rpm, 540 rpm, 540.1 rpm, 540.2 rpm, 540.3 rpm, 540.4 rpm, 540.5 rpm, 540.6 rpm, 540.7 rpm, 540.8 rpm, 540.9 rpm, 541 rpm, 541.1 rpm, 541.2 rpm, 541.3 rpm, 541.4 rpm, 541.5 rpm, 541.6 rpm, 541.7 rpm, 541.8 rpm, 541.9 rpm, 542 rpm, 542.1 rpm, 542.2 rpm, 542.3 rpm, 542.4 rpm, 542.5 rpm, 542.6 rpm, 542.7 rpm, 542.8 rpm, 542.9 rpm, 543 rpm, 543.1 rpm, 543.2 rpm, 543.3 rpm, 543.4 rpm, 543.5 rpm, 543.6 rpm, 543.7 rpm, 543.8 rpm, 543.9 rpm, 544 rpm, 544.1 rpm, 544.2 rpm, 544.3 rpm, 544.4 rpm, 544.5 rpm, 544.6 rpm, 544.7 rpm, 544.8 rpm, 544.9 rpm, 545 rpm, 545.1 rpm, 545.2 rpm, 545.3 rpm, 545.4 rpm, 545.5 rpm, 545.6 rpm, 545.7 rpm, 545.8 rpm, 545.9 rpm, 546 rpm, 546.1 rpm, 546.2 rpm, 546.3 rpm, 546.4 rpm, 546.5 rpm, 546.6 rpm, 546.7 rpm, 546.8 rpm, 546.9 rpm, 547 rpm, 547.1 rpm, 547.2 rpm, 547.3 rpm, 547.4 rpm, 547.5 rpm, 547.6 rpm, 547.7 rpm, 547.8 rpm, 547.9 rpm, 548 rpm, 548.1 rpm, 548.2 rpm, 548.3 rpm, 548.4 rpm, 548.5 rpm, 548.6 rpm, 548.7 rpm, 548.8 rpm, 548.9 rpm, 549 rpm, 549.1 rpm, 549.2 rpm, 549.3 rpm, 549.4 rpm, 549.5 rpm, 549.6 rpm, 549.7 rpm, 549.8 rpm, 549.9 rpm, 550 rpm, 550.1 rpm, 550.2 rpm, 550.3 rpm, 550.4 rpm, 550.5 rpm, 550.6 rpm, 550.7 rpm, 550.8 rpm, 550.9 rpm, 551 rpm, 551.1 rpm, 551.2 rpm, 551.3 rpm, 551.4 rpm, 551.5 rpm, 551.6 rpm, 551.7 rpm, 551.8 rpm, 551.9 rpm, 552 rpm, 552.1 rpm, 552.2 rpm, 552.3 rpm, 552.4 rpm, 552.5 rpm, 552.6 rpm, 552.7 rpm, 552.8 rpm, 552.9 rpm, 553 rpm, 553.1 rpm, 553.2 rpm, 553.3 rpm, 553.4 rpm, 553.5 rpm, 553.6 rpm, 553.7 rpm, 553.8 rpm, 553.9 rpm, 554 rpm, 554.1 rpm, 554.2 rpm, 554.3 rpm, 554.4 rpm, 554.5 rpm, 554.6 rpm, 554.7 rpm, 554.8 rpm, 554.9 rpm, 555 rpm, 555.1 rpm, 555.2 rpm, 555.3 rpm, 555.4 rpm, 555.5 rpm, 555.6 rpm, 555.7 rpm, 555.8 rpm, 555.9 rpm, 556 rpm, 556.1 rpm, 556.2 rpm, 556.3 rpm, 556.4 rpm, 556.5 rpm, 556.6 rpm, 556.7 rpm, 556.8 rpm, 556.9 rpm, 557 rpm, 557.1 rpm, 557.2 rpm, 557.3 rpm, 557.4 rpm, 557.5 rpm, 557.6 rpm, 557.7 rpm, 557.8 rpm, 557.9 rpm, 558 rpm, 558.1 rpm, 558.2 rpm, 558.3 rpm, 558.4 rpm, 558.5 rpm, 558.6 rpm, 558.7 rpm, 558.8 rpm, 558.9 rpm, 559 rpm, 559.1 rpm, 559.2 rpm, 559.3 rpm, 559.4 rpm, 559.5 rpm, 559.6 rpm, 559.7 rpm, 559.8 rpm, 559.9 rpm, 560 rpm, 560.1 rpm, 560.2 rpm, 560.3 rpm, 560.4 rpm, 560.5 rpm, 560.6 rpm, 560.7 rpm, 560.8 rpm, 560.9 rpm, 561 rpm, 561.1 rpm, 561.2 rpm, 561.3 rpm, 561.4 rpm, 561.5 rpm, 561.6 rpm, 561.7 rpm, 561.8 rpm, 561.9 rpm, 562 rpm, 562.1 rpm, 562.2 rpm, 562.3 rpm, 562.4 rpm, 562.5 rpm, 562.6 rpm, 562.7 rpm, 562.8 rpm, 562.9 rpm, 563 rpm, 563.1 rpm, 563.2 rpm, 563.3 rpm, 563.4 rpm, 563.5 rpm, 563.6 rpm, 563.7 rpm, 563.8 rpm, 563.9 rpm, 564 rpm, 564.1 rpm, 564.2 rpm, 564.3 rpm, 564.4 rpm, 564.5 rpm, 564.6 rpm, 564.7 rpm, 564.8 rpm, 564.9 rpm, 565 rpm, 565.1 rpm, 565.2 rpm, 565.3 rpm, 565.4 rpm, 565.5 rpm, 565.6 rpm, 565.7 rpm, 565.8 rpm, 565.9 rpm, 566 rpm, 566.1 rpm, 566.2 rpm, 566.3 rpm, 566.4 rpm, 566.5 rpm, 566.6 rpm, 566.7 rpm, 566.8 rpm, 566.9 rpm, 567 rpm, 567.1 rpm, 567.2 rpm, 567.3 rpm, 567.4 rpm, 567.5 rpm, 567.6 rpm, 567.7 rpm, 567.8 rpm, 567.9 rpm, 568 rpm, 568.1 rpm, 568.2 rpm, 568.3 rpm, 568.4 rpm, 568.5 rpm, 568.6 rpm, 568.7 rpm, 568.8 rpm, 568.9 rpm, 569 rpm, 569.1 rpm, 569.2 rpm, 569.3 rpm, 569.4 rpm, 569.5 rpm, 569.6 rpm, 569.7 rpm, 569.8 rpm, 569.9 rpm, 570 rpm, 570.1 rpm, 570.2 rpm, 570.3 rpm, 570.4 rpm, 570.5 rpm, 570.6 rpm, 570.7 rpm, 570.8 rpm, 570.9 rpm, 571 rpm, 571.1 rpm, 571.2 rpm, 571.3 rpm, 571.4 rpm, 571.5 rpm, 571.6 rpm, 571.7 rpm, 571.8 rpm, 571.9 rpm, 572 rpm, 572.1 rpm, 572.2 rpm, 572.3 rpm, 572.4 rpm, 572.5 rpm, 572.6 rpm, 572.7 rpm, 572.8 rpm, 572.9 rpm, 573 rpm, 573.1 rpm, 573.2 rpm, 573.3 rpm, 573.4 rpm, 573.5 rpm, 573.6 rpm, 573.7 rpm, 573.8 rpm, 573.9 rpm, 574 rpm, 574.1 rpm, 574.2 rpm, 574.3 rpm, 574.4 rpm, 574.5 rpm, 574.6 rpm, 574.7 rpm, 574.8 rpm, 574.9 rpm, 575 rpm, 575.1 rpm, 575.2 rpm, 575.3 rpm, 575.4 rpm, 575.5 rpm, 575.6 rpm, 575.7 rpm, 575.8 rpm, 575.9 rpm, 576 rpm, 576.1 rpm, 576.2 rpm, 576.3 rpm, 576.4 rpm, 576.5 rpm, 576.6 rpm, 576.7 rpm, 576.8 rpm, 576.9 rpm, 577 rpm, 577.1 rpm, 577.2 rpm, 577.3 rpm, 577.4 rpm, 577.5 rpm, 577.6 rpm, 577.7 rpm, 577.8 rpm, 577.9 rpm, 578 rpm, 578.1 rpm, 578.2 rpm, 578.3 rpm, 578.4 rpm, 578.5 rpm, 578.6 rpm, 578.7 rpm, 578.8 rpm, 578.9 rpm, 579 rpm, 579.1 rpm, 579.2 rpm, 579.3 rpm, 579.4 rpm, 579.5 rpm, 579.6 rpm, 579.7 rpm, 579.8 rpm, 579.9 rpm, 580 rpm, 580.1 rpm, 580.2 rpm, 580.3 rpm, 580.4 rpm, 580.5 rpm, 580.6 rpm, 580.7 rpm, 580.8 rpm, 580.9 rpm, 581 rpm, 581.1 rpm, 581.2 rpm, 581.3 rpm, 581.4 rpm, 581.5 rpm, 581.6 rpm, 581.7 rpm, 581.8 rpm, 581.9 rpm, 582 rpm, 582.1 rpm, 582.2 rpm, 582.3 rpm, 582.4 rpm, 582.5 rpm, 582.6 rpm, 582.7 rpm, 582.8 rpm, 582.9 rpm, 583 rpm, 583.1 rpm, 583.2 rpm, 583.3 rpm, 583.4 rpm, 583.5 rpm, 583.6 rpm, 583.7 rpm, 583.8 rpm, 583.9 rpm, 584 rpm, 584.1 rpm, 584.2 rpm, 584.3 rpm, 584.4 rpm, 584.5 rpm, 584.6 rpm, 584.7 rpm, 584.8 rpm, 584.9 rpm, 585 rpm, 585.1 rpm, 585.2 rpm, 585.3 rpm, 585.4 rpm, 585.5 rpm, 585.6 rpm, 585.7 rpm, 585.8 rpm, 585.9 rpm, 586 rpm, 586.1 rpm, 586.2 rpm, 586.3 rpm, 586.4 rpm, 586.5 rpm, 586.6 rpm, 586.7 rpm, 586.8 rpm, 586.9 rpm, 587 rpm, 587.1 rpm, 587.2 rpm, 587.3 rpm, 587.4 rpm, 587.5 rpm, 587.6 rpm, 587.7 rpm, 587.8 rpm, 587.9 rpm, 588 rpm, 588.1 rpm, 588.2 rpm, 588.3 rpm, 588.4 rpm, 588.5 rpm, 588.6 rpm, 588.7 rpm, 588.8 rpm, 588.9 rpm, 589 rpm, 589.1 rpm, 589.2 rpm, 589.3 rpm, 589.4 rpm, 589.5 rpm, 589.6 rpm, 589.7 rpm, 589.8 rpm, 589.9 rpm, 590 rpm, 590.1 rpm, 590.2 rpm, 590.3 rpm, 590.4 rpm, 590.5 rpm, 590.6 rpm, 590.7 rpm, 590.8 rpm, 590.9 rpm, 591 rpm, 591.1 rpm, 591.2 rpm, 591.3 rpm, 591.4 rpm, 591.5 rpm, 591.6 rpm, 591.7 rpm, 591.8 rpm, 591.9 rpm, 592 rpm, 592.1 rpm, 592.2 rpm, 592.3 rpm, 592.4 rpm, 592.5 rpm, 592.6 rpm, 592.7 rpm, 592.8 rpm, 592.9 rpm, 593 rpm, 593.1 rpm, 593.2 rpm, 593.3 rpm, 593.4 rpm, 593.5 rpm, 593.6 rpm, 593.7 rpm, 593.8 rpm, 593.9 rpm, 594 rpm, 594.1 rpm, 594.2 rpm, 594.3 rpm, 594.4 rpm, 594.5 rpm, 594.6 rpm, 594.7 rpm, 594.8 rpm, 594.9 rpm, 595 rpm, 595.1 rpm, 595.2 rpm, 595.3 rpm, 595.4 rpm, 595.5 rpm, 595.6 rpm, 595.7 rpm, 595.8 rpm, 595.9 rpm, 596 rpm, 596.1 rpm, 596.2 rpm, 596.3 rpm, 596.4 rpm, 596.5 rpm, 596.6 rpm, 596.7 rpm, 596.8 rpm, 596.9 rpm, 597 rpm, 597.1 rpm, 597.2 rpm, 597.3 rpm, 597.4 rpm, 597.5 rpm, 597.6 rpm, 597.7 rpm, 597.8 rpm, 597.9 rpm, 598 rpm, 598.1 rpm, 598.2 rpm, 598.3 rpm, 598.4 rpm, 598.5 rpm, 598.6 rpm, 598.7 rpm, 598.8 rpm, 598.9 rpm, 599 rpm, 599.1 rpm, 599.2 rpm, 599.3 rpm, 599.4 rpm, 599.5 rpm, 599.6 rpm, 599.7 rpm, 599.8 rpm, 599.9 rpm, 600 rpm, 600.1 rpm, 600.2 rpm, 600.3 rpm, 600.4 rpm, 600.5 rpm, 600.6 rpm, 600.7 rpm, 600.8 rpm, 600.9 rpm, 601 rpm, 601.1 rpm, 601.2 rpm, 601.3 rpm, 601.4 rpm, 601.5 rpm, 601.6 rpm, 601.7 rpm, 601.8 rpm, 601.9 rpm, 602 rpm, 602.1 rpm, 602.2 rpm, 602.3 rpm, 602.4 rpm, 602.5 rpm, 602.6 rpm, 602.7 rpm, 602.8 rpm, 602.9 rpm, 603 rpm, 603.1 rpm, 603.2 rpm, 603.3 rpm, 603.4 rpm, 603.5 rpm, 603.6 rpm, 603.7 rpm, 603.8 rpm, 603.9 rpm, 604 rpm, 604.1 rpm, 604.2 rpm, 604.3 rpm, 604.4 rpm, 604.5 rpm, 604.6 rpm, 604.7 rpm, 604.8 rpm, 604.9 rpm, 605 rpm, 605.1 rpm, 605.2 rpm, 605.3 rpm, 605.4 rpm, 605.5 rpm, 605.6 rpm, 605.7 rpm, 605.8 rpm, 605.9 rpm, 606 rpm, 606.1 rpm, 606.2 rpm, 606.3 rpm, 606.4 rpm, 606.5 rpm, 606.6 rpm, 606.7 rpm, 606.8 rpm, 606.9 rpm, 607 rpm, 607.1 rpm, 607.2 rpm, 607.3 rpm, 607.4 rpm, 607.5 rpm, 607.6 rpm, 607.7 rpm, 607.8 rpm, 607.9 rpm, 608 rpm, 608.1 rpm, 608.2 rpm, 608.3 rpm, 608.4 rpm, 608.5 rpm, 608.6 rpm, 608.7 rpm, 608.8 rpm, 608.9 rpm, 609 rpm, 609.1 rpm, 609.2 rpm, 609.3 rpm, 609.4 rpm, 609.5 rpm, 609.6 rpm, 609.7 rpm, 609.8 rpm, 609.9 rpm, 610 rpm, 610.1 rpm, 610.2 rpm, 610.3 rpm, 610.4 rpm, 610.5 rpm, 610.6 rpm, 610.7 rpm, 610.8 rpm, 610.9 rpm, 611 rpm, 611.1 rpm, 611.2 rpm, 611.3 rpm, 611.4 rpm, 611.5 rpm, 611.6 rpm, 611.7 rpm, 611.8 rpm, 611.9 rpm, 612 rpm, 612.1 rpm, 612.2 rpm, 612.3 rpm, 612.4 rpm, 612.5 rpm, 612.6 rpm, 612.7 rpm, 612.8 rpm, 612.9 rpm, 613 rpm, 613.1 rpm, 613.2 rpm, 613.3 rpm, 613.4 rpm, 613.5 rpm, 613.6 rpm, 613.7 rpm, 613.8 rpm, 613.9 rpm, 614 rpm, 614.1 rpm, 614.2 rpm, 614.3 rpm, 614.4 rpm, 614.5 rpm, 614.6 rpm, 614.7 rpm, 614.8 rpm, 614.9 rpm, 615 rpm, 615.1 rpm, 615.2 rpm, 615.3 rpm, 615.4 rpm, 615.5 rpm, 615.6 rpm, 615.7 rpm, 615.8 rpm, 615.9 rpm, 616 rpm, 616.1 rpm, 616.2 rpm, 616.3 rpm, 616.4 rpm, 616.5 rpm, 616.6 rpm, 616.7 rpm, 616.8 rpm, 616.9 rpm, 617 rpm, 617.1 rpm, 617.2 rpm, 617.3 rpm, 617.4 rpm, 617.5 rpm, 617.6 rpm, 617.7 rpm, 617.8 rpm, 617.9 rpm, 618 rpm, 618.1 rpm, 618.2 rpm, 618.3 rpm, 618.4 rpm, 618.5 rpm, 618.6 rpm, 618.7 rpm, 618.8 rpm, 618.9 rpm, 619 rpm, 619.1 rpm, 619.2 rpm, 619.3 rpm, 619.4 rpm, 619.5 rpm, 619.6 rpm, 619.7 rpm, 619.8 rpm, 619.9 rpm, 620 rpm, 620.1 rpm, 620.2 rpm, 620.3 rpm, 620.4 rpm, 620.5 rpm, 620.6 rpm, 620.7 rpm, 620.8 rpm, 620.9 rpm, 621 rpm, 621.1 rpm, 621.2 rpm, 621.3 rpm, 621.4 rpm, 621.5 rpm, 621.6 rpm, 621.7 rpm, 621.8 rpm, 621.9 rpm, 622 rpm, 622.1 rpm, 622.2 rpm, 622.3 rpm, 622.4 rpm, 622.5 rpm, 622.6 rpm, 622.7 rpm, 622.8 rpm, 622.9 rpm, 623 rpm, 623.1 rpm, 623.2 rpm, 623.3 rpm, 623.4 rpm, 623.5 rpm, 623.6 rpm, 623.7 rpm, 623.8 rpm, 623.9 rpm, 624 rpm, 624.1 rpm, 624.2 rpm, 624.3 rpm, 624.4 rpm, 624.5 rpm, 624.6 rpm, 624.7 rpm, 624.8 rpm, 624.9 rpm, 625 rpm, 625.1 rpm, 625.2 rpm, 625.3 rpm, 625.4 rpm, 625.5 rpm, 625.6 rpm, 625.7 rpm, 625.8 rpm, 625.9 rpm, 626 rpm, 626.1 rpm, 626.2 rpm, 626.3 rpm, 626.4 rpm, 626.5 rpm, 626.6 rpm, 626.7 rpm, 626.8 rpm, 626.9 rpm, 627 rpm, 627.1 rpm, 627.2 rpm, 627.3 rpm, 627.4 rpm, 627.5 rpm, 627.6 rpm, 627.7 rpm, 627.8 rpm, 627.9 rpm, 628 rpm, 628.1 rpm, 628.2 rpm, 628.3 rpm, 628.4 rpm, 628.5 rpm, 628.6 rpm, 628.7 rpm, 628.8 rpm, 628.9 rpm, 629 rpm, 629.1 rpm, 629.2 rpm, 629.3 rpm, 629.4 rpm, 629.5 rpm, 629.6 rpm, 629.7 rpm, 629.8 rpm, 629.9 rpm, 630 rpm, 630.1 rpm, 630.2 rpm, 630.3 rpm, 630.4 rpm, 630.5 rpm, 630.6 rpm, 630.7 rpm, 630.8 rpm, 630.9 rpm, 631 rpm, 631.1 rpm, 631.2 rpm, 631.3 rpm, 631.4 rpm, 631.5 rpm, 631.6 rpm, 631.7 rpm, 631.8 rpm, 631.9 rpm, 632 rpm, 632.1 rpm, 632.2 rpm, 632.3 rpm, 632.4 rpm, 632.5 rpm, 632.6 rpm, 632.7 rpm, 632.8 rpm, 632.9 rpm, 633 rpm, 633.1 rpm, 633.2 rpm, 633.3 rpm, 633.4 rpm, 633.5 rpm, 633.6 rpm, 633.7 rpm, 633.8 rpm, 633.9 rpm, 634 rpm, 634.1 rpm, 634.2 rpm, 634.3 rpm, 634.4 rpm, 634.5 rpm, 634.6 rpm, 634.7 rpm, 634.8 rpm, 634.9 rpm, 635 rpm, 635.1 rpm, 635.2 rpm, 635.3 rpm, 635.4 rpm, 635.5 rpm, 635.6 rpm, 635.7 rpm, 635.8 rpm, 635.9 rpm, 636 rpm, 636.1 rpm, 636.2 rpm, 636.3 rpm, 636.4 rpm, 636.5 rpm, 636.6 rpm, 636.7 rpm, 636.8 rpm, 636.9 rpm, 637 rpm, 637.1 rpm, 637.2 rpm, 637.3 rpm, 637.4 rpm, 637.5 rpm, 637.6 rpm, 637.7 rpm, 637.8 rpm, 637.9 rpm, 638 rpm, 638.1 rpm, 638.2 rpm, 638.3 rpm, 638.4 rpm, 638.5 rpm, 638.6 rpm, 638.7 rpm, 638.8 rpm, 638.9 rpm, 639 rpm, 639.1 rpm, 639.2 rpm, 639.3 rpm, 639.4 rpm, 639.5 rpm, 639.6 rpm, 639.7 rpm, 639.8 rpm, 639.9 rpm, 640 rpm, 640.1 rpm, 640.2 rpm, 640.3 rpm, 640.4 rpm, 640.5 rpm, 640.6 rpm, 640.7 rpm, 640.8 rpm, 640.9 rpm, 641 rpm, 641.1 rpm, 641.2 rpm, 641.3 rpm, 641.4 rpm, 641.5 rpm, 641.6 rpm, 641.7 rpm, 641.8 rpm, 641.9 rpm, 642 rpm, 642.1 rpm, 642.2 rpm, 642.3 rpm, 642.4 rpm, 642.5 rpm, 642.6 rpm, 642.7 rpm, 642.8 rpm, 642.9 rpm, 643 rpm, 643.1 rpm, 643.2 rpm, 643.3 rpm, 643.4 rpm, 643.5 rpm, 643.6 rpm, 643.7 rpm, 643.8 rpm, 643.9 rpm, 644 rpm, 644.1 rpm, 644.2 rpm, 644.3 rpm, 644.4 rpm, 644.5 rpm, 644.6 rpm, 644.7 rpm, 644.8 rpm, 644.9 rpm, 645 rpm, 645.1 rpm, 645.2 rpm, 645.3 rpm, 645.4 rpm, 645.5 rpm, 645.6 rpm, 645.7 rpm, 645.8 rpm, 645.9 rpm, 646 rpm, 646.1 rpm, 646.2 rpm, 646.3 rpm, 646.4 rpm, 646.5 rpm, 646.6 rpm, 646.7 rpm, 646.8 rpm, 646.9 rpm, 647 rpm, 647.1 rpm, 647.2 rpm, 647.3 rpm, 647.4 rpm, 647.5 rpm, 647.6 rpm, 647.7 rpm, 647.8 rpm, 647.9 rpm, 648 rpm, 648.1 rpm, 648.2 rpm, 648.3 rpm, 648.4 rpm, 648.5 rpm, 648.6 rpm, 648.7 rpm, 648.8 rpm, 648.9 rpm, 649 rpm, 649.1 rpm, 649.2 rpm, 649.3 rpm, 649.4 rpm, 649.5 rpm, 649.6 rpm, 649.7 rpm, 649.8 rpm, 649.9 rpm, 650 rpm, 650.1 rpm, 650.2 rpm, 650.3 rpm, 650.4 rpm, 650.5 rpm, 650.6 rpm, 650.7 rpm, 650.8 rpm, 650.9 rpm, 651 rpm, 651.1 rpm, 651.2 rpm, 651.3 rpm, 651.4 rpm, 651.5 rpm, 651.6 rpm, 651.7 rpm, 651.8 rpm, 651.9 rpm, 652 rpm, 652.1 rpm, 652.2 rpm, 652.3 rpm, 652.4 rpm, 652.5 rpm, 652.6 rpm, 652.7 rpm, 652.8 rpm, 652.9 rpm, 653 rpm, 653.1 rpm, 653.2 rpm, 653.3 rpm, 653.4 rpm, 653.5 rpm, 653.6 rpm, 653.7 rpm, 653.8 rpm, 653.9 rpm, 654 rpm, 654.1 rpm, 654.2 rpm, 654.3 rpm, 654.4 rpm, 654.5 rpm, 654.6 rpm, 654.7 rpm, 654.8 rpm, 654.9 rpm, 655 rpm, 655.1 rpm, 655.2 rpm, 655.3 rpm, 655.4 rpm, 655.5 rpm, 655.6 rpm, 655.7 rpm, 655.8 rpm, 655.9 rpm, 656 rpm, 656.1 rpm, 656.2 rpm, 656.3 rpm, 656.4 rpm, 656.5 rpm, 656.6 rpm, 656.7 rpm, 656.8 rpm, 656.9 rpm, 657 rpm, 657.1 rpm, 657.2 rpm, 657.3 rpm, 657.4 rpm, 657.5 rpm, 657.6 rpm, 657.7 rpm, 657.8 rpm, 657.9 rpm, 658 rpm, 658.1 rpm, 658.2 rpm, 658.3 rpm, 658.4 rpm, 658.5 rpm, 658.6 rpm, 658.7 rpm, 658.8 rpm, 658.9 rpm, 659 rpm, 659.1 rpm, 659.2 rpm, 659.3 rpm, 659.4 rpm, 659.5 rpm, 659.6 rpm, 659.7 rpm, 659.8 rpm, 659.9 rpm, 660 rpm, 660.1 rpm, 660.2 rpm, 660.3 rpm, 660.4 rpm, 660.5 rpm, 660.6 rpm, 660.7 rpm, 660.8 rpm, 660.9 rpm, 661 rpm, 661.1 rpm, 661.2 rpm, 661.3 rpm, 661.4 rpm, 661.5 rpm, 661.6 rpm, 661.7 rpm, 661.8 rpm, 661.9 rpm, 662 rpm, 662.1 rpm, 662.2 rpm, 662.3 rpm, 662.4 rpm, 662.5 rpm, 662.6 rpm, 662.7 rpm, 662.8 rpm, 662.9 rpm, 663 rpm, 663.1 rpm, 663.2 rpm, 663.3 rpm, 663.4 rpm, 663.5 rpm, 663.6 rpm, 663.7 rpm, 663.8 rpm, 663.9 rpm, 664 rpm, 664.1 rpm, 664.2 rpm, 664.3 rpm, 664.4 rpm, 664.5 rpm, 664.6 rpm, 664.7 rpm, 664.8 rpm, 664.9 rpm, 665 rpm, 665.1 rpm, 665.2 rpm, 665.3 rpm, 665.4 rpm, 665.5 rpm, 665.6 rpm, 665.7 rpm, 665.8 rpm, 665.9 rpm, 666 rpm, 666.1 rpm, 666.2 rpm, 666.3 rpm, 666.4 rpm, 666.5 rpm, 666.6 rpm, 666.7 rpm, 666.8 rpm, 666.9 rpm, 667 rpm, 667.1 rpm, 667.2 rpm, 667.3 rpm, 667.4 rpm, 667.5 rpm, 667.6 rpm, 667.7 rpm, 667.8 rpm, 667.9 rpm, 668 rpm, 668.1 rpm, 668.2 rpm, 668.3 rpm, 668.4 rpm, 668.5 rpm, 668.6 rpm, 668.7 rpm, 668.8 rpm, 668.9 rpm, 669 rpm, 669.1 rpm, 669.2 rpm, 669.3 rpm, 669.4 rpm, 669.5 rpm, 669.6 rpm, 669.7 rpm, 669.8 rpm, 669.9 rpm, 670 rpm, 670.1 rpm, 670.2 rpm, 670.3 rpm, 670.4 rpm, 670.5 rpm, 670.6 rpm, 670.7 rpm, 670.8 rpm, 670.9 rpm, 671 rpm, 671.1 rpm, 671.2 rpm, 671.3 rpm, 671.4 rpm, 671.5 rpm, 671.6 rpm, 671.7 rpm, 671.8 rpm, 671.9 rpm, 672 rpm, 672.1 rpm, 672.2 rpm, 672.3 rpm, 672.4 rpm, 672.5 rpm, 672.6 rpm, 672.7 rpm, 672.8 rpm, 672.9 rpm, 673 rpm, 673.1 rpm, 673.2 rpm, 673.3 rpm, 673.4 rpm, 673.5 rpm, 673.6 rpm, 673.7 rpm, 673.8 rpm, 673.9 rpm, 674 rpm, 674.1 rpm, 674.2 rpm, 674.3 rpm, 674.4 rpm, 674.5 rpm, 674.6 rpm, 674.7 rpm, 674.8 rpm, 674.9 rpm, 675 rpm, 675.1 rpm, 675.2 rpm, 675.3 rpm, 675.4 rpm, 675.5 rpm, 675.6 rpm, 675.7 rpm, 675.8 rpm, 675.9 rpm, 676 rpm, 676.1 rpm, 676.2 rpm, 676.3 rpm, 676.4 rpm, 676.5 rpm, 676.6 rpm, 676.7 rpm, 676.8 rpm, 676.9 rpm, 677 rpm, 677.1 rpm, 677.2 rpm, 677.3 rpm, 677.4 rpm, 677.5 rpm, 677.6 rpm, 677.7 rpm, 677.8 rpm, 677.9 rpm, 678 rpm, 678.1 rpm, 678.2 rpm, 678.3 rpm, 678.4 rpm, 678.5 rpm, 678.6 rpm, 678.7 rpm, 678.8 rpm, 678.9 rpm, 679 rpm, 679.1 rpm, 679.2 rpm, 679.3 rpm, 679.4 rpm, 679.5 rpm, 679.6 rpm, 679.7 rpm, 679.8 rpm, 679.9 rpm, 680 rpm, 680.1 rpm, 680.2 rpm, 680.3 rpm, 680.4 rpm, 680.5 rpm, 680.6 rpm, 680.7 rpm, 680.8 rpm, 680.9 rpm, 681 rpm, 681.1 rpm, 681.2 rpm, 681.3 rpm, 681.4 rpm, 681.5 rpm, 681.6 rpm, 681.7 rpm, 681.8 rpm, 681.9 rpm, 682 rpm, 682.1 rpm, 682.2 rpm, 682.3 rpm, 682.4 rpm, 682.5 rpm, 682.6 rpm, 682.7 rpm, 682.8 rpm, 682.9 rpm, 683 rpm, 683.1 rpm, 683.2 rpm, 683.3 rpm, 683.4 rpm, 683.5 rpm, 683.6 rpm, 683.7 rpm, 683.8 rpm, 683.9 rpm, 684 rpm, 684.1 rpm, 684.2 rpm, 684.3 rpm, 684.4 rpm, 684.5 rpm, 684.6 rpm, 684.7 rpm, 684.8 rpm, 684.9 rpm, 685 rpm, 685.1 rpm, 685.2 rpm, 685.3 rpm, 685.4 rpm, 685.5 rpm, 685.6 rpm, 685.7 rpm, 685.8 rpm, 685.9 rpm, 686 rpm, 686.1 rpm, 686.2 rpm, 686.3 rpm, 686.4 rpm, 686.5 rpm, 686.6 rpm, 686.7 rpm, 686.8 rpm, 686.9 rpm, 687 rpm, 687.1 rpm, 687.2 rpm, 687.3 rpm, 687.4 rpm, 687.5 rpm, 687.6 rpm, 687.7 rpm, 687.8 rpm, 687.9 rpm, 688 rpm, 688.1 rpm, 688.2 rpm, 688.3 rpm, 688.4 rpm, 688.5 rpm, 688.6 rpm, 688.7 rpm, 688.8 rpm, 688.9 rpm, 689 rpm, 689.1 rpm, 689.2 rpm, 689.3 rpm, 689.4 rpm, 689.5 rpm, 689.6 rpm, 689.7 rpm, 689.8 rpm, 689.9 rpm, 690 rpm, 690.1 rpm, 690.2 rpm, 690.3 rpm, 690.4 rpm, 690.5 rpm, 690.6 rpm, 690.7 rpm, 690.8 rpm, 690.9 rpm, 691 rpm, 691.1 rpm, 691.2 rpm, 691.3 rpm, 691.4 rpm, 691.5 rpm, 691.6 rpm, 691.7 rpm, 691.8 rpm, 691.9 rpm, 692 rpm, 692.1 rpm, 692.2 rpm, 692.3 rpm, 692.4 rpm, 692.5 rpm, 692.6 rpm, 692.7 rpm, 692.8 rpm, 692.9 rpm, 693 rpm, 693.1 rpm, 693.2 rpm, 693.3 rpm, 693.4 rpm, 693.5 rpm, 693.6 rpm, 693.7 rpm, 693.8 rpm, 693.9 rpm, 694 rpm, 694.1 rpm, 694.2 rpm, 694.3 rpm, 694.4 rpm, 694.5 rpm, 694.6 rpm, 694.7 rpm, 694.8 rpm, 694.9 rpm, 695 rpm, 695.1 rpm, 695.2 rpm, 695.3 rpm, 695.4 rpm, 695.5 rpm, 695.6 rpm, 695.7 rpm, 695.8 rpm, 695.9 rpm, 696 rpm, 696.1 rpm, 696.2 rpm, 696.3 rpm, 696.4 rpm, 696.5 rpm, 696.6 rpm, 696.7 rpm, 696.8 rpm, 696.9 rpm, 697 rpm, 697.1 rpm, 697.2 rpm, 697.3 rpm, 697.4 rpm, 697.5 rpm, 697.6 rpm, 697.7 rpm, 697.8 rpm, 697.9 rpm, 698 rpm, 698.1 rpm, 698.2 rpm, 698.3 rpm, 698.4 rpm, 698.5 rpm, 698.6 rpm, 698.7 rpm, 698.8 rpm, 698.9 rpm, 699 rpm, 699.1 rpm, 699.2 rpm, 699.3 rpm, 699.4 rpm, 699.5 rpm, 699.6 rpm, 699.7 rpm, 699.8 rpm, 699.9 rpm, 700 rpm, 700.1 rpm, 700.2 rpm, 700.3 rpm, 700.4 rpm, 700.5 rpm, 700.6 rpm, 700.7 rpm, 700.8 rpm, 700.9 rpm, 701 rpm, 701.1 rpm, 701.2 rpm, 701.3 rpm, 701.4 rpm, 701.5 rpm, 701.6 rpm, 701.7 rpm, 701.8 rpm, 701.9 rpm, 702 rpm, 702.1 rpm, 702.2 rpm, 702.3 rpm, 702.4 rpm, 702.5 rpm, 702.6 rpm, 702.7 rpm, 702.8 rpm, 702.9 rpm, 703 rpm, 703.1 rpm, 703.2 rpm, 703.3 rpm, 703.4 rpm, 703.5 rpm, 703.6 rpm, 703.7 rpm, 703.8 rpm, 703.9 rpm, 704 rpm, 704.1 rpm, 704.2 rpm, 704.3 rpm, 704.4 rpm, 704.5 rpm, 704.6 rpm, 704.7 rpm, 704.8 rpm, 704.9 rpm, 705 rpm, 705.1 rpm, 705.2 rpm, 705.3 rpm, 705.4 rpm, 705.5 rpm, 705.6 rpm, 705.7 rpm, 705.8 rpm, 705.9 rpm, 706 rpm, 706.1 rpm, 706.2 rpm, 706.3 rpm, 706.4 rpm, 706.5 rpm, 706.6 rpm, 706.7 rpm, 706.8 rpm, 706.9 rpm, 707 rpm, 707.1 rpm, 707.2 rpm, 707.3 rpm, 707.4 rpm, 707.5 rpm, 707.6 rpm, 707.7 rpm, 707.8 rpm, 707.9 rpm, 708 rpm, 708.1 rpm, 708.2 rpm, 708.3 rpm, 708.4 rpm, 708.5 rpm, 708.6 rpm, 708.7 rpm, 708.8 rpm, 708.9 rpm, 709 rpm, 709.1 rpm, 709.2 rpm, 709.3 rpm, 709.4 rpm, 709.5 rpm, 709.6 rpm, 709.7 rpm, 709.8 rpm, 709.9 rpm, 710 rpm, 710.1 rpm, 710.2 rpm, 710.3 rpm, 710.4 rpm, 710.5 rpm, 710.6 rpm, 710.7 rpm, 710.8 rpm, 710.9 rpm, 711 rpm, 711.1 rpm, 711.2 rpm, 711.3 rpm, 711.4 rpm, 711.5 rpm, 711.6 rpm, 711.7 rpm, 711.8 rpm, 711.9 rpm, 712 rpm, 712.1 rpm, 712.2 rpm, 712.3 rpm, 712.4 rpm, 712.5 rpm, 712.6 rpm, 712.7 rpm, 712.8 rpm, 712.9 rpm, 713 rpm, 713.1 rpm, 713.2 rpm, 713.3 rpm, 713.4 rpm, 713.5 rpm, 713.6 rpm, 713.7 rpm, 713.8 rpm, 713.9 rpm, 714 rpm, 714.1 rpm, 714.2 rpm, 714.3 rpm, 714.4 rpm, 714.5 rpm, 714.6 rpm, 714.7 rpm, 714.8 rpm, 714.9 rpm, 715 rpm, 715.1 rpm, 715.2 rpm, 715.3 rpm, 715.4 rpm, 715.5 rpm, 715.6 rpm, 715.7 rpm, 715.8 rpm, 715.9 rpm, 716 rpm, 716.1 rpm, 716.2 rpm, 716.3 rpm, 716.4 rpm, 716.5 rpm, 716.6 rpm, 716.7 rpm, 716.8 rpm, 716.9 rpm, 717 rpm, 717.1 rpm, 717.2 rpm, 717.3 rpm, 717.4 rpm, 717.5 rpm, 717.6 rpm, 717.7 rpm, 717.8 rpm, 717.9 rpm, 718 rpm, 718.1 rpm, 718.2 rpm, 718.3 rpm, 718.4 rpm, 718.5 rpm, 718.6 rpm, 718.7 rpm, 718.8 rpm, 718.9 rpm, 719 rpm, 719.1 rpm, 719.2 rpm, 719.3 rpm, 719.4 rpm, 719.5 rpm, 719.6 rpm, 719.7 rpm, 719.8 rpm, 719.9 rpm, 720 rpm, 720.1 rpm, 720.2 rpm, 720.3 rpm, 720.4 rpm, 720.5 rpm, 720.6 rpm, 720.7 rpm, 720.8 rpm, 720.9 rpm, 721 rpm, 721.1 rpm, 721.2 rpm, 721.3 rpm, 721.4 rpm, 721.5 rpm, 721.6 rpm, 721.7 rpm, 721.8 rpm, 721.9 rpm, 722 rpm, 722.1 rpm, 722.2 rpm, 722.3 rpm, 722.4 rpm, 722.5 rpm, 722.6 rpm, 722.7 rpm, 722.8 rpm, 722.9 rpm, 723 rpm, 723.1 rpm, 723.2 rpm, 723.3 rpm, 723.4 rpm, 723.5 rpm, 723.6 rpm, 723.7 rpm, 723.8 rpm, 723.9 rpm, 724 rpm, 724.1 rpm, 724.2 rpm, 724.3 rpm, 724.4 rpm, 724.5 rpm, 724.6 rpm, 724.7 rpm, 724.8 rpm, 724.9 rpm, 725 rpm, 725.1 rpm, 725.2 rpm, 725.3 rpm, 725.4 rpm, 725.5 rpm, 725.6 rpm, 725.7 rpm, 725.8 rpm, 725.9 rpm, 726 rpm, 726.1 rpm, 726.2 rpm, 726.3 rpm, 726.4 rpm, 726.5 rpm, 726.6 rpm, 726.7 rpm, 726.8 rpm, 726.9 rpm, 727 rpm, 727.1 rpm, 727.2 rpm, 727.3 rpm, 727.4 rpm, 727.5 rpm, 727.6 rpm, 727.7 rpm, 727.8 rpm, 727.9 rpm, 728 rpm, 728.1 rpm, 728.2 rpm, 728.3 rpm, 728.4 rpm, 728.5 rpm, 728.6 rpm, 728.7 rpm, 728.8 rpm, 728.9 rpm, 729 rpm, 729.1 rpm, 729.2 rpm, 729.3 rpm, 729.4 rpm, 729.5 rpm, 729.6 rpm, 729.7 rpm, 729.8 rpm, 729.9 rpm, 730 rpm, 730.1 rpm, 730.2 rpm, 730.3 rpm, 730.4 rpm, 730.5 rpm, 730.6 rpm, 730.7 rpm, 730.8 rpm, 730.9 rpm, 731 rpm, 731.1 rpm, 731.2 rpm, 731.3 rpm, 731.4 rpm, 731.5 rpm, 731.6 rpm, 731.7 rpm, 731.8 rpm, 731.9 rpm, 732 rpm, 732.1 rpm, 732.2 rpm, 732.3 rpm, 732.4 rpm, 732.5 rpm, 732.6 rpm, 732.7 rpm, 732.8 rpm, 732.9 rpm, 733 rpm, 733.1 rpm, 733.2 rpm, 733.3 rpm, 733.4 rpm, 733.5 rpm, 733.6 rpm, 733.7 rpm, 733.8 rpm, 733.9 rpm, 734 rpm, 734.1 rpm, 734.2 rpm, 734.3 rpm, 734.4 rpm, 734.5 rpm, 734.6 rpm, 734.7 rpm, 734.8 rpm, 734.9 rpm, 735 rpm, 735.1 rpm, 735.2 rpm, 735.3 rpm, 735.4 rpm, 735.5 rpm, 735.6 rpm, 735.7 rpm, 735.8 rpm, 735.9 rpm, 736 rpm, 736.1 rpm, 736.2 rpm, 736.3 rpm, 736.4 rpm, 736.5 rpm, 736.6 rpm, 736.7 rpm, 736.8 rpm, 736.9 rpm, 737 rpm, 737.1 rpm, 737.2 rpm, 737.3 rpm, 737.4 rpm, 737.5 rpm, 737.6 rpm, 737.7 rpm, 737.8 rpm, 737.9 rpm, 738 rpm, 738.1 rpm, 738.2 rpm, 738.3 rpm, 738.4 rpm, 738.5 rpm, 738.6 rpm, 738.7 rpm, 738.8 rpm, 738.9 rpm, 739 rpm, 739.1 rpm, 739.2 rpm, 739.3 rpm, 739.4 rpm, 739.5 rpm, 739.6 rpm, 739.7 rpm, 739.8 rpm, 739.9 rpm, 740 rpm, 740.1 rpm, 740.2 rpm, 740.3 rpm, 740.4 rpm, 740.5 rpm, 740.6 rpm, 740.7 rpm, 740.8 rpm, 740.9 rpm, 741 rpm, 741.1 rpm, 741.2 rpm, 741.3 rpm, 741.4 rpm, 741.5 rpm, 741.6 rpm, 741.7 rpm, 741.8 rpm, 741.9 rpm, 742 rpm, 742.1 rpm, 742.2 rpm, 742.3 rpm, 742.4 rpm, 742.5 rpm, 742.6 rpm, 742.7 rpm, 742.8 rpm, 742.9 rpm, 743 rpm, 743.1 rpm, 743.2 rpm, 743.3 rpm, 743.4 rpm, 743.5 rpm, 743.6 rpm, 743.7 rpm, 743.8 rpm, 743.9 rpm, 744 rpm, 744.1 rpm, 744.2 rpm, 744.3 rpm, 744.4 rpm, 744.5 rpm, 744.6 rpm, 744.7 rpm, 744.8 rpm, 744.9 rpm, 745 rpm, 745.1 rpm, 745.2 rpm, 745.3 rpm, 745.4 rpm, 745.5 rpm, 745.6 rpm, 745.7 rpm, 745.8 rpm, 745.9 rpm, 746 rpm, 746.1 rpm, 746.2 rpm, 746.3 rpm, 746.4 rpm, 746.5 rpm, 746.6 rpm, 746.7 rpm, 746.8 rpm, 746.9 rpm, 747 rpm, 747.1 rpm, 747.2 rpm, 747.3 rpm, 747.4 rpm, 747.5 rpm, 747.6 rpm, 747.7 rpm, 747.8 rpm, 747.9 rpm, 748 rpm, 748.1 rpm, 748.2 rpm, 748.3 rpm, 748.4 rpm, 748.5 rpm, 748.6 rpm, 748.7 rpm, 748.8 rpm, 748.9 rpm, 749 rpm, 749.1 rpm, 749.2 rpm, 749.3 rpm, 749.4 rpm, 749.5 rpm, 749.6 rpm, 749.7 rpm, 749.8 rpm, 749.9 rpm, 750 rpm, 750.1 rpm, 750.2 rpm, 750.3 rpm, 750.4 rpm, 750.5 rpm, 750.6 rpm, 750.7 rpm, 750.8 rpm, 750.9 rpm, 751 rpm, 751.1 rpm, 751.2 rpm, 751.3 rpm, 751.4 rpm, 751.5 rpm, 751.6 rpm, 751.7 rpm, 751.8 rpm, 751.9 rpm, 752 rpm, 752.1 rpm, 752.2 rpm, 752.3 rpm, 752.4 rpm, 752.5 rpm, 752.6 rpm, 752.7 rpm, 752.8 rpm, 752.9 rpm, 753 rpm, 753.1 rpm, 753.2 rpm, 753.3 rpm, 753.4 rpm, 753.5 rpm, 753.6 rpm, 753.7 rpm, 753.8 rpm, 753.9 rpm, 754 rpm, 754.1 rpm, 754.2 rpm, 754.3 rpm, 754.4 rpm, 754.5 rpm, 754.6 rpm, 754.7 rpm, 754.8 rpm, 754.9 rpm, 755 rpm, 755.1 rpm, 755.2 rpm, 755.3 rpm, 755.4 rpm, 755.5 rpm, 755.6 rpm, 755.7 rpm, 755.8 rpm, 755.9 rpm, 756 rpm, 756.1 rpm, 756.2 rpm, 756.3 rpm, 756.4 rpm, 756.5 rpm, 756.6 rpm, 756.7 rpm, 756.8 rpm, 756.9 rpm, 757 rpm, 757.1 rpm, 757.2 rpm, 757.3 rpm, 757.4 rpm, 757.5 rpm, 757.6 rpm, 757.7 rpm, 757.8 rpm, 757.9 rpm, 758 rpm, 758.1 rpm, 758.2 rpm, 758.3 rpm, 758.4 rpm, 758.5 rpm, 758.6 rpm, 758.7 rpm, 758.8 rpm, 758.9 rpm, 759 rpm, 759.1 rpm, 759.2 rpm, 759.3 rpm, 759.4 rpm, 759.5 rpm, 759.6 rpm, 759.7 rpm, 759.8 rpm, 759.9 rpm, 760 rpm, 760.1 rpm, 760.2 rpm, 760.3 rpm, 760.4 rpm, 760.5 rpm, 760.6 rpm, 760.7 rpm, 760.8 rpm, 760.9 rpm, 761 rpm, 761.1 rpm, 761.2 rpm, 761.3 rpm, 761.4 rpm, 761.5 rpm, 761.6 rpm, 761.7 rpm, 761.8 rpm, 761.9 rpm, 762 rpm, 762.1 rpm, 762.2 rpm, 762.3 rpm, 762.4 rpm, 762.5 rpm, 762.6 rpm, 762.7 rpm, 762.8 rpm, 762.9 rpm, 763 rpm, 763.1 rpm, 763.2 rpm, 763.3 rpm, 763.4 rpm, 763.5 rpm, 763.6 rpm, 763.7 rpm, 763.8 rpm, 763.9 rpm, 764 rpm, 764.1 rpm, 764.2 rpm, 764.3 rpm, 764.4 rpm, 764.5 rpm, 764.6 rpm, 764.7 rpm, 764.8 rpm, 764.9 rpm, 765 rpm, 765.1 rpm, 765.2 rpm, 765.3 rpm, 765.4 rpm, 765.5 rpm, 765.6 rpm, 765.7 rpm, 765.8 rpm, 765.9 rpm, 766 rpm, 766.1 rpm, 766.2 rpm, 766.3 rpm, 766.4 rpm, 766.5 rpm, 766.6 rpm, 766.7 rpm, 766.8 rpm, 766.9 rpm, 767 rpm, 767.1 rpm, 767.2 rpm, 767.3 rpm, 767.4 rpm, 767.5 rpm, 767.6 rpm, 767.7 rpm, 767.8 rpm, 767.9 rpm, 768 rpm, 768.1 rpm, 768.2 rpm, 768.3 rpm, 768.4 rpm, 768.5 rpm, 768.6 rpm, 768.7 rpm, 768.8 rpm, 768.9 rpm, 769 rpm, 769.1 rpm, 769.2 rpm, 769.3 rpm, 769.4 rpm, 769.5 rpm, 769.6 rpm, 769.7 rpm, 769.8 rpm, 769.9 rpm, 770 rpm, 770.1 rpm, 770.2 rpm, 770.3 rpm, 770.4 rpm, 770.5 rpm, 770.6 rpm, 770.7 rpm, 770.8 rpm, 770.9 rpm, 771 rpm, 771.1 rpm, 771.2 rpm, 771.3 rpm, 771.4 rpm, 771.5 rpm, 771.6 rpm, 771.7 rpm, 771.8 rpm, 771.9 rpm, 772 rpm, 772.1 rpm, 772.2 rpm, 772.3 rpm, 772.4 rpm, 772.5 rpm, 772.6 rpm, 772.7 rpm, 772.8 rpm, 772.9 rpm, 773 rpm, 773.1 rpm, 773.2 rpm, 773.3 rpm, 773.4 rpm, 773.5 rpm, 773.6 rpm, 773.7 rpm, 773.8 rpm, 773.9 rpm, 774 rpm, 774.1 rpm, 774.2 rpm, 774.3 rpm, 774.4 rpm, 774.5 rpm, 774.6 rpm, 774.7 rpm, 774.8 rpm, 774.9 rpm, 775 rpm, 775.1 rpm, 775.2 rpm, 775.3 rpm, 775.4 rpm, 775.5 rpm, 775.6 rpm, 775.7 rpm, 775.8 rpm, 775.9 rpm, 776 rpm, 776.1 rpm, 776.2 rpm, 776.3 rpm, 776.4 rpm, 776.5 rpm, 776.6 rpm, 776.7 rpm, 776.8 rpm, 776.9 rpm, 777 rpm, 777.1 rpm, 777.2 rpm, 777.3 rpm, 777.4 rpm, 777.5 rpm, 777.6 rpm, 777.7 rpm, 777.8 rpm, 777.9 rpm, 778 rpm, 778.1 rpm, 778.2 rpm, 778.3 rpm, 778.4 rpm, 778.5 rpm, 778.6 rpm, 778.7 rpm, 778.8 rpm, 778.9 rpm, 779 rpm, 779.1 rpm, 779.2 rpm, 779.3 rpm, 779.4 rpm, 779.5 rpm, 779.6 rpm, 779.7 rpm, 779.8 rpm, 779.9 rpm, 780 rpm, 780.1 rpm, 780.2 rpm, 780.3 rpm, 780.4 rpm, 780.5 rpm, 780.6 rpm, 780.7 rpm, 780.8 rpm, 780.9 rpm, 781 rpm, 781.1 rpm, 781.2 rpm, 781.3 rpm, 781.4 rpm, 781.5 rpm, 781.6 rpm, 781.7 rpm, 781.8 rpm, 781.9 rpm, 782 rpm, 782.1 rpm, 782.2 rpm, 782.3 rpm, 782.4 rpm, 782.5 rpm, 782.6 rpm, 782.7 rpm, 782.8 rpm, 782.9 rpm, 783 rpm, 783.1 rpm, 783.2 rpm, 783.3 rpm, 783.4 rpm, 783.5 rpm, 783.6 rpm, 783.7 rpm, 783.8 rpm, 783.9 rpm, 784 rpm, 784.1 rpm, 784.2 rpm, 784.3 rpm, 784.4 rpm, 784.5 rpm, 784.6 rpm, 784.7 rpm, 784.8 rpm, 784.9 rpm, 785 rpm, 785.1 rpm, 785.2 rpm, 785.3 rpm, 785.4 rpm, 785.5 rpm, 785.6 rpm, 785.7 rpm, 785.8 rpm, 785.9 rpm, 786 rpm, 786.1 rpm, 786.2 rpm, 786.3 rpm, 786.4 rpm, 786.5 rpm, 786.6 rpm, 786.7 rpm, 786.8 rpm, 786.9 rpm, 787 rpm, 787.1 rpm, 787.2 rpm, 787.3 rpm, 787.4 rpm, 787.5 rpm, 787.6 rpm, 787.7 rpm, 787.8 rpm, 787.9 rpm, 788 rpm, 788.1 rpm, 788.2 rpm, 788.3 rpm, 788.4 rpm, 788.5 rpm, 788.6 rpm, 788.7 rpm, 788.8 rpm, 788.9 rpm, 789 rpm, 789.1 rpm, 789.2 rpm, 789.3 rpm, 789.4 rpm, 789.5 rpm, 789.6 rpm, 789.7 rpm, 789.8 rpm, 789.9 rpm, 790 rpm, 790.1 rpm, 790.2 rpm, 790.3 rpm, 790.4 rpm, 790.5 rpm, 790.6 rpm, 790.7 rpm, 790.8 rpm, 790.9 rpm, 791 rpm, 791.1 rpm, 791.2 rpm, 791.3 rpm, 791.4 rpm, 791.5 rpm, 791.6 rpm, 791.7 rpm, 791.8 rpm, 791.9 rpm, 792 rpm, 792.1 rpm, 792.2 rpm, 792.3 rpm, 792.4 rpm, 792.5 rpm, 792.6 rpm, 792.7 rpm, 792.8 rpm, 792.9 rpm, 793 rpm, 793.1 rpm, 793.2 rpm, 793.3 rpm, 793.4 rpm, 793.5 rpm, 793.6 rpm, 793.7 rpm, 793.8 rpm, 793.9 rpm, 794 rpm, 794.1 rpm, 794.2 rpm, 794.3 rpm, 794.4 rpm, 794.5 rpm, 794.6 rpm, 794.7 rpm, 794.8 rpm, 794.9 rpm, 795 rpm, 795.1 rpm, 795.2 rpm, 795.3 rpm, 795.4 rpm, 795.5 rpm, 795.6 rpm, 795.7 rpm, 795.8 rpm, 795.9 rpm, 796 rpm, 796.1 rpm, 796.2 rpm, 796.3 rpm, 796.4 rpm, 796.5 rpm, 796.6 rpm, 796.7 rpm, 796.8 rpm, 796.9 rpm, 797 rpm, 797.1 rpm, 797.2 rpm, 797.3 rpm, 797.4 rpm, 797.5 rpm, 797.6 rpm, 797.7 rpm, 797.8 rpm, 797.9 rpm, 798 rpm, 798.1 rpm, 798.2 rpm, 798.3 rpm, 798.4 rpm, 798.5 rpm, 798.6 rpm, 798.7 rpm, 798.8 rpm, 798.9 rpm, 799 rpm, 799.1 rpm, 799.2 rpm, 799.3 rpm, 799.4 rpm, 799.5 rpm, 799.6 rpm, 799.7 rpm, 799.8 rpm, 799.9 rpm, 800 rpm, 800.1 rpm, 800.2 rpm, 800.3 rpm, 800.4 rpm, 800.5 rpm, 800.6 rpm, 800.7 rpm, 800.8 rpm, 800.9 rpm, 801 rpm, 801.1 rpm, 801.2 rpm, 801.3 rpm, 801.4 rpm, 801.5 rpm, 801.6 rpm, 801.7 rpm, 801.8 rpm, 801.9 rpm, 802 rpm, 802.1 rpm, 802.2 rpm, 802.3 rpm, 802.4 rpm, 802.5 rpm, 802.6 rpm, 802.7 rpm, 802.8 rpm, 802.9 rpm, 803 rpm, 803.1 rpm, 803.2 rpm, 803.3 rpm, 803.4 rpm, 803.5 rpm, 803.6 rpm, 803.7 rpm, 803.8 rpm, 803.9 rpm, 804 rpm, 804.1 rpm, 804.2 rpm, 804.3 rpm, 804.4 rpm, 804.5 rpm, 804.6 rpm, 804.7 rpm, 804.8 rpm, 804.9 rpm, 805 rpm, 805.1 rpm, 805.2 rpm, 805.3 rpm, 805.4 rpm, 805.5 rpm, 805.6 rpm, 805.7 rpm, 805.8 rpm, 805.9 rpm, 806 rpm, 806.1 rpm, 806.2 rpm, 806.3 rpm, 806.4 rpm, 806.5 rpm, 806.6 rpm, 806.7 rpm, 806.8 rpm, 806.9 rpm, 807 rpm, 807.1 rpm, 807.2 rpm, 807.3 rpm, 807.4 rpm, 807.5 rpm, 807.6 rpm, 807.7 rpm, 807.8 rpm, 807.9 rpm, 808 rpm, 808.1 rpm, 808.2 rpm, 808.3 rpm, 808.4 rpm, 808.5 rpm, 808.6 rpm, 808.7 rpm, 808.8 rpm, 808.9 rpm, 809 rpm, 809.1 rpm, 809.2 rpm, 809.3 rpm, 809.4 rpm, 809.5 rpm, 809.6 rpm, 809.7 rpm, 809.8 rpm, 809.9 rpm, 810 rpm, 810.1 rpm, 810.2 rpm, 810.3 rpm, 810.4 rpm, 810.5 rpm, 810.6 rpm, 810.7 rpm, 810.8 rpm, 810.9 rpm, 811 rpm, 811.1 rpm, 811.2 rpm, 811.3 rpm, 811.4 rpm, 811.5 rpm, 811.6 rpm, 811.7 rpm, 811.8 rpm, 811.9 rpm, 812 rpm, 812.1 rpm, 812.2 rpm, 812.3 rpm, 812.4 rpm, 812.5 rpm, 812.6 rpm, 812.7 rpm, 812.8 rpm, 812.9 rpm, 813 rpm, 813.1 rpm, 813.2 rpm, 813.3 rpm, 813.4 rpm, 813.5 rpm, 813.6 rpm, 813.7 rpm, 813.8 rpm, 813.9 rpm, 814 rpm, 814.1 rpm, 814.2 rpm, 814.3 rpm, 814.4 rpm, 814.5 rpm, 814.6 rpm, 814.7 rpm, 814.8 rpm, 814.9 rpm, 815 rpm, 815.1 rpm, 815.2 rpm, 815.3 rpm, 815.4 rpm, 815.5 rpm, 815.6 rpm, 815.7 rpm, 815.8 rpm, 815.9 rpm, 816 rpm, 816.1 rpm, 816.2 rpm, 816.3 rpm, 816.4 rpm, 816.5 rpm, 816.6 rpm, 816.7 rpm, 816.8 rpm, 816.9 rpm, 817 rpm, 817.1 rpm, 817.2 rpm, 817.3 rpm, 817.4 rpm, 817.5 rpm, 817.6 rpm, 817.7 rpm, 817.8 rpm, 817.9 rpm, 818 rpm, 818.1 rpm, 818.2 rpm, 818.3 rpm, 818.4 rpm, 818.5 rpm, 818.6 rpm, 818.7 rpm, 818.8 rpm, 818.9 rpm, 819 rpm, 819.1 rpm, 819.2 rpm, 819.3 rpm, 819.4 rpm, 819.5 rpm, 819.6 rpm, 819.7 rpm, 819.8 rpm, 819.9 rpm, 820 rpm, 820.1 rpm, 820.2 rpm, 820.3 rpm, 820.4 rpm, 820.5 rpm, 820.6 rpm, 820.7 rpm, 820.8 rpm, 820.9 rpm, 821 rpm, 821.1 rpm, 821.2 rpm, 821.3 rpm, 821.4 rpm, 821.5 rpm, 821.6 rpm, 821.7 rpm, 821.8 rpm, 821.9 rpm, 822 rpm, 822.1 rpm, 822.2 rpm, 822.3 rpm, 822.4 rpm, 822.5 rpm, 822.6 rpm, 822.7 rpm, 822.8 rpm, 822.9 rpm, 823 rpm, 823.1 rpm, 823.2 rpm, 823.3 rpm, 823.4 rpm, 823.5 rpm, 823.6 rpm, 823.7 rpm, 823.8 rpm, 823.9 rpm, 824 rpm, 824.1 rpm, 824.2 rpm, 824.3 rpm, 824.4 rpm, 824.5 rpm, 824.6 rpm, 824.7 rpm, 824.8 rpm, 824.9 rpm, 825 rpm, 825.1 rpm, 825.2 rpm, 825.3 rpm, 825.4 rpm, 825.5 rpm, 825.6 rpm, 825.7 rpm, 825.8 rpm, 825.9 rpm, 826 rpm, 826.1 rpm, 826.2 rpm, 826.3 rpm, 826.4 rpm, 826.5 rpm, 826.6 rpm, 826.7 rpm, 826.8 rpm, 826.9 rpm, 827 rpm, 827.1 rpm, 827.2 rpm, 827.3 rpm, 827.4 rpm, 827.5 rpm, 827.6 rpm, 827.7 rpm, 827.8 rpm, 827.9 rpm, 828 rpm, 828.1 rpm, 828.2 rpm, 828.3 rpm, 828.4 rpm, 828.5 rpm, 828.6 rpm, 828.7 rpm, 828.8 rpm, 828.9 rpm, 829 rpm, 829.1 rpm, 829.2 rpm, 829.3 rpm, 829.4 rpm, 829.5 rpm, 829.6 rpm, 829.7 rpm, 829.8 rpm, 829.9 rpm, 830 rpm, 830.1 rpm, 830.2 rpm, 830.3 rpm, 830.4 rpm, 830.5 rpm, 830.6 rpm, 830.7 rpm, 830.8 rpm, 830.9 rpm, 831 rpm, 831.1 rpm, 831.2 rpm, 831.3 rpm, 831.4 rpm, 831.5 rpm, 831.6 rpm, 831.7 rpm, 831.8 rpm, 831.9 rpm, 832 rpm, 832.1 rpm, 832.2 rpm, 832.3 rpm, 832.4 rpm, 832.5 rpm, 832.6 rpm, 832.7 rpm, 832.8 rpm, 832.9 rpm, 833 rpm, 833.1 rpm, 833.2 rpm, 833.3 rpm, 833.4 rpm, 833.5 rpm, 833.6 rpm, 833.7 rpm, 833.8 rpm, 833.9 rpm, 834 rpm, 834.1 rpm, 834.2 rpm, 834.3 rpm, 834.4 rpm, 834.5 rpm, 834.6 rpm, 834.7 rpm, 834.8 rpm, 834.9 rpm, 835 rpm, 835.1 rpm, 835.2 rpm, 835.3 rpm, 835.4 rpm, 835.5 rpm, 835.6 rpm, 835.7 rpm, 835.8 rpm, 835.9 rpm, 836 rpm, 836.1 rpm, 836.2 rpm, 836.3 rpm, 836.4 rpm, 836.5 rpm, 836.6 rpm, 836.7 rpm, 836.8 rpm, 836.9 rpm, 837 rpm, 837.1 rpm, 837.2 rpm, 837.3 rpm, 837.4 rpm, 837.5 rpm, 837.6 rpm, 837.7 rpm, 837.8 rpm, 837.9 rpm, 838 rpm, 838.1 rpm, 838.2 rpm, 838.3 rpm, 838.4 rpm, 838.5 rpm, 838.6 rpm, 838.7 rpm, 838.8 rpm, 838.9 rpm, 839 rpm, 839.1 rpm, 839.2 rpm, 839.3 rpm, 839.4 rpm, 839.5 rpm, 839.6 rpm, 839.7 rpm, 839.8 rpm, 839.9 rpm, 840 rpm, 840.1 rpm, 840.2 rpm, 840.3 rpm, 840.4 rpm, 840.5 rpm, 840.6 rpm, 840.7 rpm, 840.8 rpm, 840.9 rpm, 841 rpm, 841.1 rpm, 841.2 rpm, 841.3 rpm, 841.4 rpm, 841.5 rpm, 841.6 rpm, 841.7 rpm, 841.8 rpm, 841.9 rpm, 842 rpm, 842.1 rpm, 842.2 rpm, 842.3 rpm, 842.4 rpm, 842.5 rpm, 842.6 rpm, 842.7 rpm, 842.8 rpm, 842.9 rpm, 843 rpm, 843.1 rpm, 843.2 rpm, 843.3 rpm, 843.4 rpm, 843.5 rpm, 843.6 rpm, 843.7 rpm, 843.8 rpm, 843.9 rpm, 844 rpm, 844.1 rpm, 844.2 rpm, 844.3 rpm, 844.4 rpm, 844.5 rpm, 844.6 rpm, 844.7 rpm, 844.8 rpm, 844.9 rpm, 845 rpm, 845.1 rpm, 845.2 rpm, 845.3 rpm, 845.4 rpm, 845.5 rpm, 845.6 rpm, 845.7 rpm, 845.8 rpm, 845.9 rpm, 846 rpm, 846.1 rpm, 846.2 rpm, 846.3 rpm, 846.4 rpm, 846.5 rpm, 846.6 rpm, 846.7 rpm, 846.8 rpm, 846.9 rpm, 847 rpm, 847.1 rpm, 847.2 rpm, 847.3 rpm, 847.4 rpm, 847.5 rpm, 847.6 rpm, 847.7 rpm, 847.8 rpm, 847.9 rpm, 848 rpm, 848.1 rpm, 848.2 rpm, 848.3 rpm, 848.4 rpm, 848.5 rpm, 848.6 rpm, 848.7 rpm, 848.8 rpm, 848.9 rpm, 849 rpm, 849.1 rpm, 849.2 rpm, 849.3 rpm, 849.4 rpm, 849.5 rpm, 849.6 rpm, 849.7 rpm, 849.8 rpm, 849.9 rpm, 850 rpm, 850.1 rpm, 850.2 rpm, 850.3 rpm, 850.4 rpm, 850.5 rpm, 850.6 rpm, 850.7 rpm, 850.8 rpm, 850.9 rpm, 851 rpm, 851.1 rpm, 851.2 rpm, 851.3 rpm, 851.4 rpm, 851.5 rpm, 851.6 rpm, 851.7 rpm, 851.8 rpm, 851.9 rpm, 852 rpm, 852.1 rpm, 852.2 rpm, 852.3 rpm, 852.4 rpm, 852.5 rpm, 852.6 rpm, 852.7 rpm, 852.8 rpm, 852.9 rpm, 853 rpm, 853.1 rpm, 853.2 rpm, 853.3 rpm, 853.4 rpm, 853.5 rpm, 853.6 rpm, 853.7 rpm, 853.8 rpm, 853.9 rpm, 854 rpm, 854.1 rpm, 854.2 rpm, 854.3 rpm, 854.4 rpm, 854.5 rpm, 854.6 rpm, 854.7 rpm, 854.8 rpm, 854.9 rpm, 855 rpm, 855.1 rpm, 855.2 rpm, 855.3 rpm, 855.4 rpm, 855.5 rpm, 855.6 rpm, 855.7 rpm, 855.8 rpm, 855.9 rpm, 856 rpm, 856.1 rpm, 856.2 rpm, 856.3 rpm, 856.4 rpm, 856.5 rpm, 856.6 rpm, 856.7 rpm, 856.8 rpm, 856.9 rpm, 857 rpm, 857.1 rpm, 857.2 rpm, 857.3 rpm, 857.4 rpm, 857.5 rpm, 857.6 rpm, 857.7 rpm, 857.8 rpm, 857.9 rpm, 858 rpm, 858.1 rpm, 858.2 rpm, 858.3 rpm, 858.4 rpm, 858.5 rpm, 858.6 rpm, 858.7 rpm, 858.8 rpm, 858.9 rpm, 859 rpm, 859.1 rpm, 859.2 rpm, 859.3 rpm, 859.4 rpm, 859.5 rpm, 859.6 rpm, 859.7 rpm, 859.8 rpm, 859.9 rpm, 860 rpm, 860.1 rpm, 860.2 rpm, 860.3 rpm, 860.4 rpm, 860.5 rpm, 860.6 rpm, 860.7 rpm, 860.8 rpm, 860.9 rpm, 861 rpm, 861.1 rpm, 861.2 rpm, 861.3 rpm, 861.4 rpm, 861.5 rpm, 861.6 rpm, 861.7 rpm, 861.8 rpm, 861.9 rpm, 862 rpm, 862.1 rpm, 862.2 rpm, 862.3 rpm, 862.4 rpm, 862.5 rpm, 862.6 rpm, 862.7 rpm, 862.8 rpm, 862.9 rpm, 863 rpm, 863.1 rpm, 863.2 rpm, 863.3 rpm, 863.4 rpm, 863.5 rpm, 863.6 rpm, 863.7 rpm, 863.8 rpm, 863.9 rpm, 864 rpm, 864.1 rpm, 864.2 rpm, 864.3 rpm, 864.4 rpm, 864.5 rpm, 864.6 rpm, 864.7 rpm, 864.8 rpm, 864.9 rpm, 865 rpm, 865.1 rpm, 865.2 rpm, 865.3 rpm, 865.4 rpm, 865.5 rpm, 865.6 rpm, 865.7 rpm, 865.8 rpm, 865.9 rpm, 866 rpm, 866.1 rpm, 866.2 rpm, 866.3 rpm, 866.4 rpm, 866.5 rpm, 866.6 rpm, 866.7 rpm, 866.8 rpm, 866.9 rpm, 867 rpm, 867.1 rpm, 867.2 rpm, 867.3 rpm, 867.4 rpm, 867.5 rpm, 867.6 rpm, 867.7 rpm, 867.8 rpm, 867.9 rpm, 868 rpm, 868.1 rpm, 868.2 rpm, 868.3 rpm, 868.4 rpm, 868.5 rpm, 868.6 rpm, 868.7 rpm, 868.8 rpm, 868.9 rpm, 869 rpm, 869.1 rpm, 869.2 rpm, 869.3 rpm, 869.4 rpm, 869.5 rpm, 869.6 rpm, 869.7 rpm, 869.8 rpm, 869.9 rpm, 870 rpm, 870.1 rpm, 870.2 rpm, 870.3 rpm, 870.4 rpm, 870.5 rpm, 870.6 rpm, 870.7 rpm, 870.8 rpm, 870.9 rpm, 871 rpm, 871.1 rpm, 871.2 rpm, 871.3 rpm, 871.4 rpm, 871.5 rpm, 871.6 rpm, 871.7 rpm, 871.8 rpm, 871.9 rpm, 872 rpm, 872.1 rpm, 872.2 rpm, 872.3 rpm, 872.4 rpm, 872.5 rpm, 872.6 rpm, 872.7 rpm, 872.8 rpm, 872.9 rpm, 873 rpm, 873.1 rpm, 873.2 rpm, 873.3 rpm, 873.4 rpm, 873.5 rpm, 873.6 rpm, 873.7 rpm, 873.8 rpm, 873.9 rpm, 874 rpm, 874.1 rpm, 874.2 rpm, 874.3 rpm, 874.4 rpm, 874.5 rpm, 874.6 rpm, 874.7 rpm, 874.8 rpm, 874.9 rpm, 875 rpm, 875.1 rpm, 875.2 rpm, 875.3 rpm, 875.4 rpm, 875.5 rpm, 875.6 rpm, 875.7 rpm, 875.8 rpm, 875.9 rpm, 876 rpm, 876.1 rpm, 876.2 rpm, 876.3 rpm, 876.4 rpm, 876.5 rpm, 876.6 rpm, 876.7 rpm, 876.8 rpm, 876.9 rpm, 877 rpm, 877.1 rpm, 877.2 rpm, 877.3 rpm, 877.4 rpm, 877.5 rpm, 877.6 rpm, 877.7 rpm, 877.8 rpm, 877.9 rpm, 878 rpm, 878.1 rpm, 878.2 rpm, 878.3 rpm, 878.4 rpm, 878.5 rpm, 878.6 rpm, 878.7 rpm, 878.8 rpm, 878.9 rpm, 879 rpm, 879.1 rpm, 879.2 rpm, 879.3 rpm, 879.4 rpm, 879.5 rpm, 879.6 rpm, 879.7 rpm, 879.8 rpm, 879.9 rpm, 880 rpm, 880.1 rpm, 880.2 rpm, 880.3 rpm, 880.4 rpm, 880.5 rpm, 880.6 rpm, 880.7 rpm, 880.8 rpm, 880.9 rpm, 881 rpm, 881.1 rpm, 881.2 rpm, 881.3 rpm, 881.4 rpm, 881.5 rpm, 881.6 rpm, 881.7 rpm, 881.8 rpm, 881.9 rpm, 882 rpm, 882.1 rpm, 882.2 rpm, 882.3 rpm, 882.4 rpm, 882.5 rpm, 882.6 rpm, 882.7 rpm, 882.8 rpm, 882.9 rpm, 883 rpm, 883.1 rpm, 883.2 rpm, 883.3 rpm, 883.4 rpm, 883.5 rpm, 883.6 rpm, 883.7 rpm, 883.8 rpm, 883.9 rpm, 884 rpm, 884.1 rpm, 884.2 rpm, 884.3 rpm, 884.4 rpm, 884.5 rpm, 884.6 rpm, 884.7 rpm, 884.8 rpm, 884.9 rpm, 885 rpm, 885.1 rpm, 885.2 rpm, 885.3 rpm, 885.4 rpm, 885.5 rpm, 885.6 rpm, 885.7 rpm, 885.8 rpm, 885.9 rpm, 886 rpm, 886.1 rpm, 886.2 rpm, 886.3 rpm, 886.4 rpm, 886.5 rpm, 886.6 rpm, 886.7 rpm, 886.8 rpm, 886.9 rpm, 887 rpm, 887.1 rpm, 887.2 rpm, 887.3 rpm, 887.4 rpm, 887.5 rpm, 887.6 rpm, 887.7 rpm, 887.8 rpm, 887.9 rpm, 888 rpm, 888.1 rpm, 888.2 rpm, 888.3 rpm, 888.4 rpm, 888.5 rpm, 888.6 rpm, 888.7 rpm, 888.8 rpm, 888.9 rpm, 889 rpm, 889.1 rpm, 889.2 rpm, 889.3 rpm, 889.4 rpm, 889.5 rpm, 889.6 rpm, 889.7 rpm, 889.8 rpm, 889.9 rpm, 890 rpm, 890.1 rpm, 890.2 rpm, 890.3 rpm, 890.4 rpm, 890.5 rpm, 890.6 rpm, 890.7 rpm, 890.8 rpm, 890.9 rpm, 891 rpm, 891.1 rpm, 891.2 rpm, 891.3 rpm, 891.4 rpm, 891.5 rpm, 891.6 rpm, 891.7 rpm, 891.8 rpm, 891.9 rpm, 892 rpm, 892.1 rpm, 892.2 rpm, 892.3 rpm, 892.4 rpm, 892.5 rpm, 892.6 rpm, 892.7 rpm, 892.8 rpm, 892.9 rpm, 893 rpm, 893.1 rpm, 893.2 rpm, 893.3 rpm, 893.4 rpm, 893.5 rpm, 893.6 rpm, 893.7 rpm, 893.8 rpm, 893.9 rpm, 894 rpm, 894.1 rpm, 894.2 rpm, 894.3 rpm, 894.4 rpm, 894.5 rpm, 894.6 rpm, 894.7 rpm, 894.8 rpm, 894.9 rpm, 895 rpm, 895.1 rpm, 895.2 rpm, 895.3 rpm, 895.4 rpm, 895.5 rpm, 895.6 rpm, 895.7 rpm, 895.8 rpm, 895.9 rpm, 896 rpm, 896.1 rpm, 896.2 rpm, 896.3 rpm, 896.4 rpm, 896.5 rpm, 896.6 rpm, 896.7 rpm, 896.8 rpm, 896.9 rpm, 897 rpm, 897.1 rpm, 897.2 rpm, 897.3 rpm, 897.4 rpm, 897.5 rpm, 897.6 rpm, 897.7 rpm, 897.8 rpm, 897.9 rpm, 898 rpm, 898.1 rpm, 898.2 rpm, 898.3 rpm, 898.4 rpm, 898.5 rpm, 898.6 rpm, 898.7 rpm, 898.8 rpm, 898.9 rpm, 899 rpm, 899.1 rpm, 899.2 rpm, 899.3 rpm, 899.4 rpm, 899.5 rpm, 899.6 rpm, 899.7 rpm, 899.8 rpm, 899.9 rpm, 900 rpm, 900.1 rpm, 900.2 rpm, 900.3 rpm, 900.4 rpm, 900.5 rpm, 900.6 rpm, 900.7 rpm, 900.8 rpm, 900.9 rpm, 901 rpm, 901.1 rpm, 901.2 rpm, 901.3 rpm, 901.4 rpm, 901.5 rpm, 901.6 rpm, 901.7 rpm, 901.8 rpm, 901.9 rpm, 902 rpm, 902.1 rpm, 902.2 rpm, 902.3 rpm, 902.4 rpm, 902.5 rpm, 902.6 rpm, 902.7 rpm, 902.8 rpm, 902.9 rpm, 903 rpm, 903.1 rpm, 903.2 rpm, 903.3 rpm, 903.4 rpm, 903.5 rpm, 903.6 rpm, 903.7 rpm, 903.8 rpm, 903.9 rpm, 904 rpm, 904.1 rpm, 904.2 rpm, 904.3 rpm, 904.4 rpm, 904.5 rpm, 904.6 rpm, 904.7 rpm, 904.8 rpm, 904.9 rpm, 905 rpm, 905.1 rpm, 905.2 rpm, 905.3 rpm, 905.4 rpm, 905.5 rpm, 905.6 rpm, 905.7 rpm, 905.8 rpm, 905.9 rpm, 906 rpm, 906.1 rpm, 906.2 rpm, 906.3 rpm, 906.4 rpm, 906.5 rpm, 906.6 rpm, 906.7 rpm, 906.8 rpm, 906.9 rpm, 907 rpm, 907.1 rpm, 907.2 rpm, 907.3 rpm, 907.4 rpm, 907.5 rpm, 907.6 rpm, 907.7 rpm, 907.8 rpm, 907.9 rpm, 908 rpm, 908.1 rpm, 908.2 rpm, 908.3 rpm, 908.4 rpm, 908.5 rpm, 908.6 rpm, 908.7 rpm, 908.8 rpm, 908.9 rpm, 909 rpm, 909.1 rpm, 909.2 rpm, 909.3 rpm, 909.4 rpm, 909.5 rpm, 909.6 rpm, 909.7 rpm, 909.8 rpm, 909.9 rpm, 910 rpm, 910.1 rpm, 910.2 rpm, 910.3 rpm, 910.4 rpm, 910.5 rpm, 910.6 rpm, 910.7 rpm, 910.8 rpm, 910.9 rpm, 911 rpm, 911.1 rpm, 911.2 rpm, 911.3 rpm, 911.4 rpm, 911.5 rpm, 911.6 rpm, 911.7 rpm, 911.8 rpm, 911.9 rpm, 912 rpm, 912.1 rpm, 912.2 rpm, 912.3 rpm, 912.4 rpm, 912.5 rpm, 912.6 rpm, 912.7 rpm, 912.8 rpm, 912.9 rpm, 913 rpm, 913.1 rpm, 913.2 rpm, 913.3 rpm, 913.4 rpm, 913.5 rpm, 913.6 rpm, 913.7 rpm, 913.8 rpm, 913.9 rpm, 914 rpm, 914.1 rpm, 914.2 rpm, 914.3 rpm, 914.4 rpm, 914.5 rpm, 914.6 rpm, 914.7 rpm, 914.8 rpm, 914.9 rpm, 915 rpm, 915.1 rpm, 915.2 rpm, 915.3 rpm, 915.4 rpm, 915.5 rpm, 915.6 rpm, 915.7 rpm, 915.8 rpm, 915.9 rpm, 916 rpm, 916.1 rpm, 916.2 rpm, 916.3 rpm, 916.4 rpm, 916.5 rpm, 916.6 rpm, 916.7 rpm, 916.8 rpm, 916.9 rpm, 917 rpm, 917.1 rpm, 917.2 rpm, 917.3 rpm, 917.4 rpm, 917.5 rpm, 917.6 rpm, 917.7 rpm, 917.8 rpm, 917.9 rpm, 918 rpm, 918.1 rpm, 918.2 rpm, 918.3 rpm, 918.4 rpm, 918.5 rpm, 918.6 rpm, 918.7 rpm, 918.8 rpm, 918.9 rpm, 919 rpm, 919.1 rpm, 919.2 rpm, 919.3 rpm, 919.4 rpm, 919.5 rpm, 919.6 rpm, 919.7 rpm, 919.8 rpm, 919.9 rpm, 920 rpm, 920.1 rpm, 920.2 rpm, 920.3 rpm, 920.4 rpm, 920.5 rpm, 920.6 rpm, 920.7 rpm, 920.8 rpm, 920.9 rpm, 921 rpm, 921.1 rpm, 921.2 rpm, 921.3 rpm, 921.4 rpm, 921.5 rpm, 921.6 rpm, 921.7 rpm, 921.8 rpm, 921.9 rpm, 922 rpm, 922.1 rpm, 922.2 rpm, 922.3 rpm, 922.4 rpm, 922.5 rpm, 922.6 rpm, 922.7 rpm, 922.8 rpm, 922.9 rpm, 923 rpm, 923.1 rpm, 923.2 rpm, 923.3 rpm, 923.4 rpm, 923.5 rpm, 923.6 rpm, 923.7 rpm, 923.8 rpm, 923.9 rpm, 924 rpm, 924.1 rpm, 924.2 rpm, 924.3 rpm, 924.4 rpm, 924.5 rpm, 924.6 rpm, 924.7 rpm, 924.8 rpm, 924.9 rpm, 925 rpm, 925.1 rpm, 925.2 rpm, 925.3 rpm, 925.4 rpm, 925.5 rpm, 925.6 rpm, 925.7 rpm, 925.8 rpm, 925.9 rpm, 926 rpm, 926.1 rpm, 926.2 rpm, 926.3 rpm, 926.4 rpm, 926.5 rpm, 926.6 rpm, 926.7 rpm, 926.8 rpm, 926.9 rpm, 927 rpm, 927.1 rpm, 927.2 rpm, 927.3 rpm, 927.4 rpm, 927.5 rpm, 927.6 rpm, 927.7 rpm, 927.8 rpm, 927.9 rpm, 928 rpm, 928.1 rpm, 928.2 rpm, 928.3 rpm, 928.4 rpm, 928.5 rpm, 928.6 rpm, 928.7 rpm, 928.8 rpm, 928.9 rpm, 929 rpm, 929.1 rpm, 929.2 rpm, 929.3 rpm, 929.4 rpm, 929.5 rpm, 929.6 rpm, 929.7 rpm, 929.8 rpm, 929.9 rpm, 930 rpm, 930.1 rpm, 930.2 rpm, 930.3 rpm, 930.4 rpm, 930.5 rpm, 930.6 rpm, 930.7 rpm, 930.8 rpm, 930.9 rpm, 931 rpm, 931.1 rpm, 931.2 rpm, 931.3 rpm, 931.4 rpm, 931.5 rpm, 931.6 rpm, 931.7 rpm, 931.8 rpm, 931.9 rpm, 932 rpm, 932.1 rpm, 932.2 rpm, 932.3 rpm, 932.4 rpm, 932.5 rpm, 932.6 rpm, 932.7 rpm, 932.8 rpm, 932.9 rpm, 933 rpm, 933.1 rpm, 933.2 rpm, 933.3 rpm, 933.4 rpm, 933.5 rpm, 933.6 rpm, 933.7 rpm, 933.8 rpm, 933.9 rpm, 934 rpm, 934.1 rpm, 934.2 rpm, 934.3 rpm, 934.4 rpm, 934.5 rpm, 934.6 rpm, 934.7 rpm, 934.8 rpm, 934.9 rpm, 935 rpm, 935.1 rpm, 935.2 rpm, 935.3 rpm, 935.4 rpm, 935.5 rpm, 935.6 rpm, 935.7 rpm, 935.8 rpm, 935.9 rpm, 936 rpm, 936.1 rpm, 936.2 rpm, 936.3 rpm, 936.4 rpm, 936.5 rpm, 936.6 rpm, 936.7 rpm, 936.8 rpm, 936.9 rpm, 937 rpm, 937.1 rpm, 937.2 rpm, 937.3 rpm, 937.4 rpm, 937.5 rpm, 937.6 rpm, 937.7 rpm, 937.8 rpm, 937.9 rpm, 938 rpm, 938.1 rpm, 938.2 rpm, 938.3 rpm, 938.4 rpm, 938.5 rpm, 938.6 rpm, 938.7 rpm, 938.8 rpm, 938.9 rpm, 939 rpm, 939.1 rpm, 939.2 rpm, 939.3 rpm, 939.4 rpm, 939.5 rpm, 939.6 rpm, 939.7 rpm, 939.8 rpm, 939.9 rpm, 940 rpm, 940.1 rpm, 940.2 rpm, 940.3 rpm, 940.4 rpm, 940.5 rpm, 940.6 rpm, 940.7 rpm, 940.8 rpm, 940.9 rpm, 941 rpm, 941.1 rpm, 941.2 rpm, 941.3 rpm, 941.4 rpm, 941.5 rpm, 941.6 rpm, 941.7 rpm, 941.8 rpm, 941.9 rpm, 942 rpm, 942.1 rpm, 942.2 rpm, 942.3 rpm, 942.4 rpm, 942.5 rpm, 942.6 rpm, 942.7 rpm, 942.8 rpm, 942.9 rpm, 943 rpm, 943.1 rpm, 943.2 rpm, 943.3 rpm, 943.4 rpm, 943.5 rpm, 943.6 rpm, 943.7 rpm, 943.8 rpm, 943.9 rpm, 944 rpm, 944.1 rpm, 944.2 rpm, 944.3 rpm, 944.4 rpm, 944.5 rpm, 944.6 rpm, 944.7 rpm, 944.8 rpm, 944.9 rpm, 945 rpm, 945.1 rpm, 945.2 rpm, 945.3 rpm, 945.4 rpm, 945.5 rpm, 945.6 rpm, 945.7 rpm, 945.8 rpm, 945.9 rpm, 946 rpm, 946.1 rpm, 946.2 rpm, 946.3 rpm, 946.4 rpm, 946.5 rpm, 946.6 rpm, 946.7 rpm, 946.8 rpm, 946.9 rpm, 947 rpm, 947.1 rpm, 947.2 rpm, 947.3 rpm, 947.4 rpm, 947.5 rpm, 947.6 rpm, 947.7 rpm, 947.8 rpm, 947.9 rpm, 948 rpm, 948.1 rpm, 948.2 rpm, 948.3 rpm, 948.4 rpm, 948.5 rpm, 948.6 rpm, 948.7 rpm, 948.8 rpm, 948.9 rpm, 949 rpm, 949.1 rpm, 949.2 rpm, 949.3 rpm, 949.4 rpm, 949.5 rpm, 949.6 rpm, 949.7 rpm, 949.8 rpm, 949.9 rpm, 950 rpm, 950.1 rpm, 950.2 rpm, 950.3 rpm, 950.4 rpm, 950.5 rpm, 950.6 rpm, 950.7 rpm, 950.8 rpm, 950.9 rpm, 951 rpm, 951.1 rpm, 951.2 rpm, 951.3 rpm, 951.4 rpm, 951.5 rpm, 951.6 rpm, 951.7 rpm, 951.8 rpm, 951.9 rpm, 952 rpm, 952.1 rpm, 952.2 rpm, 952.3 rpm, 952.4 rpm, 952.5 rpm, 952.6 rpm, 952.7 rpm, 952.8 rpm, 952.9 rpm, 953 rpm, 953.1 rpm, 953.2 rpm, 953.3 rpm, 953.4 rpm, 953.5 rpm, 953.6 rpm, 953.7 rpm, 953.8 rpm, 953.9 rpm, 954 rpm, 954.1 rpm, 954.2 rpm, 954.3 rpm, 954.4 rpm, 954.5 rpm, 954.6 rpm, 954.7 rpm, 954.8 rpm, 954.9 rpm, 955 rpm, 955.1 rpm, 955.2 rpm, 955.3 rpm, 955.4 rpm, 955.5 rpm, 955.6 rpm, 955.7 rpm, 955.8 rpm, 955.9 rpm, 956 rpm, 956.1 rpm, 956.2 rpm, 956.3 rpm, 956.4 rpm, 956.5 rpm, 956.6 rpm, 956.7 rpm, 956.8 rpm, 956.9 rpm, 957 rpm, 957.1 rpm, 957.2 rpm, 957.3 rpm, 957.4 rpm, 957.5 rpm, 957.6 rpm, 957.7 rpm, 957.8 rpm, 957.9 rpm, 958 rpm, 958.1 rpm, 958.2 rpm, 958.3 rpm, 958.4 rpm, 958.5 rpm, 958.6 rpm, 958.7 rpm, 958.8 rpm, 958.9 rpm, 959 rpm, 959.1 rpm, 959.2 rpm, 959.3 rpm, 959.4 rpm, 959.5 rpm, 959.6 rpm, 959.7 rpm, 959.8 rpm, 959.9 rpm, 960 rpm, 960.1 rpm, 960.2 rpm, 960.3 rpm, 960.4 rpm, 960.5 rpm, 960.6 rpm, 960.7 rpm, 960.8 rpm, 960.9 rpm, 961 rpm, 961.1 rpm, 961.2 rpm, 961.3 rpm, 961.4 rpm, 961.5 rpm, 961.6 rpm, 961.7 rpm, 961.8 rpm, 961.9 rpm, 962 rpm, 962.1 rpm, 962.2 rpm, 962.3 rpm, 962.4 rpm, 962.5 rpm, 962.6 rpm, 962.7 rpm, 962.8 rpm, 962.9 rpm, 963 rpm, 963.1 rpm, 963.2 rpm, 963.3 rpm, 963.4 rpm, 963.5 rpm, 963.6 rpm, 963.7 rpm, 963.8 rpm, 963.9 rpm, 964 rpm, 964.1 rpm, 964.2 rpm, 964.3 rpm, 964.4 rpm, 964.5 rpm, 964.6 rpm, 964.7 rpm, 964.8 rpm, 964.9 rpm, 965 rpm, 965.1 rpm, 965.2 rpm, 965.3 rpm, 965.4 rpm, 965.5 rpm, 965.6 rpm, 965.7 rpm, 965.8 rpm, 965.9 rpm, 966 rpm, 966.1 rpm, 966.2 rpm, 966.3 rpm, 966.4 rpm, 966.5 rpm, 966.6 rpm, 966.7 rpm, 966.8 rpm, 966.9 rpm, 967 rpm, 967.1 rpm, 967.2 rpm, 967.3 rpm, 967.4 rpm, 967.5 rpm, 967.6 rpm, 967.7 rpm, 967.8 rpm, 967.9 rpm, 968 rpm, 968.1 rpm, 968.2 rpm, 968.3 rpm, 968.4 rpm, 968.5 rpm, 968.6 rpm, 968.7 rpm, 968.8 rpm, 968.9 rpm, 969 rpm, 969.1 rpm, 969.2 rpm, 969.3 rpm, 969.4 rpm, 969.5 rpm, 969.6 rpm, 969.7 rpm, 969.8 rpm, 969.9 rpm, 970 rpm, 970.1 rpm, 970.2 rpm, 970.3 rpm, 970.4 rpm, 970.5 rpm, 970.6 rpm, 970.7 rpm, 970.8 rpm, 970.9 rpm, 971 rpm, 971.1 rpm, 971.2 rpm, 971.3 rpm, 971.4 rpm, 971.5 rpm, 971.6 rpm, 971.7 rpm, 971.8 rpm, 971.9 rpm, 972 rpm, 972.1 rpm, 972.2 rpm, 972.3 rpm, 972.4 rpm, 972.5 rpm, 972.6 rpm, 972.7 rpm, 972.8 rpm, 972.9 rpm, 973 rpm, 973.1 rpm, 973.2 rpm, 973.3 rpm, 973.4 rpm, 973.5 rpm, 973.6 rpm, 973.7 rpm, 973.8 rpm, 973.9 rpm, 974 rpm, 974.1 rpm, 974.2 rpm, 974.3 rpm, 974.4 rpm, 974.5 rpm, 974.6 rpm, 974.7 rpm, 974.8 rpm, 974.9 rpm, 975 rpm, 975.1 rpm, 975.2 rpm, 975.3 rpm, 975.4 rpm, 975.5 rpm, 975.6 rpm, 975.7 rpm, 975.8 rpm, 975.9 rpm, 976 rpm, 976.1 rpm, 976.2 rpm, 976.3 rpm, 976.4 rpm, 976.5 rpm, 976.6 rpm, 976.7 rpm, 976.8 rpm, 976.9 rpm, 977 rpm, 977.1 rpm, 977.2 rpm, 977.3 rpm, 977.4 rpm, 977.5 rpm, 977.6 rpm, 977.7 rpm, 977.8 rpm, 977.9 rpm, 978 rpm, 978.1 rpm, 978.2 rpm, 978.3 rpm, 978.4 rpm, 978.5 rpm, 978.6 rpm, 978.7 rpm, 978.8 rpm, 978.9 rpm, 979 rpm, 979.1 rpm, 979.2 rpm, 979.3 rpm, 979.4 rpm, 979.5 rpm, 979.6 rpm, 979.7 rpm, 979.8 rpm, 979.9 rpm, 980 rpm, 980.1 rpm, 980.2 rpm, 980.3 rpm, 980.4 rpm, 980.5 rpm, 980.6 rpm, 980.7 rpm, 980.8 rpm, 980.9 rpm, 981 rpm, 981.1 rpm, 981.2 rpm, 981.3 rpm, 981.4 rpm, 981.5 rpm, 981.6 rpm, 981.7 rpm, 981.8 rpm, 981.9 rpm, 982 rpm, 982.1 rpm, 982.2 rpm, 982.3 rpm, 982.4 rpm, 982.5 rpm, 982.6 rpm, 982.7 rpm, 982.8 rpm, 982.9 rpm, 983 rpm, 983.1 rpm, 983.2 rpm, 983.3 rpm, 983.4 rpm, 983.5 rpm, 983.6 rpm, 983.7 rpm, 983.8 rpm, 983.9 rpm, 984 rpm, 984.1 rpm, 984.2 rpm, 984.3 rpm, 984.4 rpm, 984.5 rpm, 984.6 rpm, 984.7 rpm, 984.8 rpm, 984.9 rpm, 985 rpm, 985.1 rpm, 985.2 rpm, 985.3 rpm, 985.4 rpm, 985.5 rpm, 985.6 rpm, 985.7 rpm, 985.8 rpm, 985.9 rpm, 986 rpm, 986.1 rpm, 986.2 rpm, 986.3 rpm, 986.4 rpm, 986.5 rpm, 986.6 rpm, 986.7 rpm, 986.8 rpm, 986.9 rpm, 987 rpm, 987.1 rpm, 987.2 rpm, 987.3 rpm, 987.4 rpm, 987.5 rpm, 987.6 rpm, 987.7 rpm, 987.8 rpm, 987.9 rpm, 988 rpm, 988.1 rpm, 988.2 rpm, 988.3 rpm, 988.4 rpm, 988.5 rpm, 988.6 rpm, 988.7 rpm, 988.8 rpm, 988.9 rpm, 989 rpm, 989.1 rpm, 989.2 rpm, 989.3 rpm, 989.4 rpm, 989.5 rpm, 989.6 rpm, 989.7 rpm, 989.8 rpm, 989.9 rpm, 990 rpm, 990.1 rpm, 990.2 rpm, 990.3 rpm, 990.4 rpm, 990.5 rpm, 990.6 rpm, 990.7 rpm, 990.8 rpm, 990.9 rpm, 991 rpm, 991.1 rpm, 991.2 rpm, 991.3 rpm, 991.4 rpm, 991.5 rpm, 991.6 rpm, 991.7 rpm, 991.8 rpm, 991.9 rpm, 992 rpm, 992.1 rpm, 992.2 rpm, 992.3 rpm, 992.4 rpm, 992.5 rpm, 992.6 rpm, 992.7 rpm, 992.8 rpm, 992.9 rpm, 993 rpm, 993.1 rpm, 993.2 rpm, 993.3 rpm, 993.4 rpm, 993.5 rpm, 993.6 rpm, 993.7 rpm, 993.8 rpm, 993.9 rpm, 994 rpm, 994.1 rpm, 994.2 rpm, 994.3 rpm, 994.4 rpm, 994.5 rpm, 994.6 rpm, 994.7 rpm, 994.8 rpm, 994.9 rpm, 995 rpm, 995.1 rpm, 995.2 rpm, 995.3 rpm, 995.4 rpm, 995.5 rpm, 995.6 rpm, 995.7 rpm, 995.8 rpm, 995.9 rpm, 996 rpm, 996.1 rpm, 996.2 rpm, 996.3 rpm, 996.4 rpm, 996.5 rpm, 996.6 rpm, 996.7 rpm, 996.8 rpm, 996.9 rpm, 997 rpm, 997.1 rpm, 997.2 rpm, 997.3 rpm, 997.4 rpm, 997.5 rpm, 997.6 rpm, 997.7 rpm, 997.8 rpm, 997.9 rpm, 998 rpm, 998.1 rpm, 998.2 rpm, 998.3 rpm, 998.4 rpm, 998.5 rpm, 998.6 rpm, 998.7 rpm, 998.8 rpm, 998.9 rpm, 999 rpm, 999.1 rpm, 999.2 rpm, 999.3 rpm, 999.4 rpm, 999.5 rpm, 999.6 rpm, 999.7 rpm, 999.8 rpm, 999.9 rpm, or 1000 rpm. Examples of the frequency for circulation is on during both charging and discharging steps, circulation is on during charging and off during discharging, circulation is off during charging and on during discharging. In some example embodiments, the circulation controller 220 starts or stops circulation based, at least in part, on the voltage of battery 300. For example, in certain example embodiments, the circulation controller 220 begins circulation when the charging voltage reaches a predetermined cut-on voltage, which in some embodiments may be one or more of 1.5V, 1.6V or 1.7V. In example embodiments, the circulation continues on until charging finishes. In some embodiments, the circulation controller 220 starts circulating when the discharging voltages reaches a predetermined cut-on voltage, which in some embodiments may be one or more of 1.4 V, 1.3V or 1.2V. In some embodiments, the circulation turns on until discharging is finished. In some embodiments, the circulation depends on time of charging and discharging. In example embodiments, circulation is on for 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min, 31 min, 32 min, 33 min, 34 min, 35 min, 36 min, 37 min, 38 min, 39 min, 40 min, 41 min, 42 min, 43 min, 44 min, 45 min, 46 min, 47 min, 48 min, 49 min, 50 min, 51 min, 52 min, 53 min, 54 min, 55 min, 56 min, 57 min, 58 min, 59 min, 60 min, 61 min, 62 min, 63 min, 64 min, 65 min, 66 min, 67 min, 68 min, 69 min, 70 min, 71 min, 72 min, 73 min, 74 min, 75 min, 76 min, 77 min, 78 min, 79 min, 80 min, 81 min, 82 min, 83 min, 84 min, 85 min, 86 min, 87 min, 88 min, 89 min, 90 min, 91 min, 92 min, 93 min, 94 min, 95 min, 96 min, 97 min, 98 min, 99 min, 100 min, 101 min, 102 min, 103 min, 104 min, 105 min, 106 min, 107 min, 108 min, 109 min, 110 min, 111 min, 112 min, 113 min, 114 min, 115 min, 116 min, 117 min, 118 min, 119 min, or 120 min, then off for 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min, 31 min, 32 min, 33 min, 34 min, 35 min, 36 min, 37 min, 38 min, 39 min, 40 min, 41 min, 42 min, 43 min, 44 min, 45 min, 46 min, 47 min, 48 min, 49 min, 50 min, 51 min, 52 min, 53 min, 54 min, 55 min, 56 min, 57 min, 58 min, 59 min, 60 min, 61 min, 62 min, 63 min, 64 min, 65 min, 66 min, 67 min, 68 min, 69 min, 70 min, 71 min, 72 min, 73 min, 74 min, 75 min, 76 min, 77 min, 78 min, 79 min, 80 min, 81 min, 82 min, 83 min, 84 min, 85 min, 86 min, 87 min, 88 min, 89 min, 90 min, 91 min, 92 min, 93 min, 94 min, 95 min, 96 min, 97 min, 98 min, 99 min, 100 min, 101 min, 102 min, 103 min, 104 min, 105 min, 106 min, 107 min, 108 min, 109 min, 110 min, 111 min, 112 min, 113 min, 114 min, 115 min, 116 min, 117 min, 118 min, 119 min, or 120 min. In some embodiments, this cycle repeats until charging or discharging is finished.

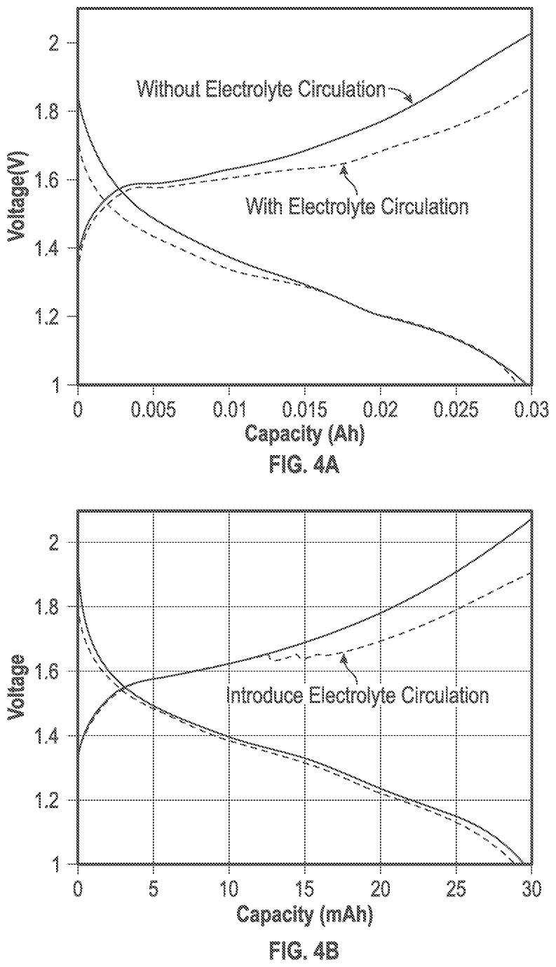

FIGS. 4A and 4B are graphs of voltage (V) versus capacity (Ah or mAh) for charging and discharging battery system with and without electrolyte circulation. FIGS. 4A and 4B are graphs of voltage (V) versus capacity (Ah or mAh) for charging and discharging battery system with and without electrolyte circulation. FIG. 4A is a graph of battery voltage-capacity profile at 1C rate without electrolyte circulation and with electrolyte circulation. FIG. 4B is a graph of battery voltage-capacity profile at 1C rate showing electrolyte circulation to improve battery performance. The figures show that electrolyte circulation may be beneficial to the overall battery performances. The example battery is composed of MnO2 cathode on graphite felt, Zn metal anode, aqueous solution electrolyte with 1M ZnSO4 and 0.1M MnSO4. The battery is charging and discharging at 1C current rate. When there is no electrolyte circulation, the battery charging voltage needs to go above 2V to reach 30 mAh capacity, while with electrolyte circulation at for example 33 mL/min/Ah, the battery charging voltage goes below 1.9V to achieve 30 mAh capacity. This confirms the improvement of battery kinetics and results in higher energy efficiency with shrinking charging-discharge voltage differences. The efficiency without electrolyte circulation is around 79% while it increases to around 81% with circulation. Such effect is further proved by starting electrolyte circulation at mid of charging step. FIG. 4B shows that when introducing electrolyte circulation at mid of charging, the voltage is apparently decreased, leading to improved kinetics and higher energy efficiency.

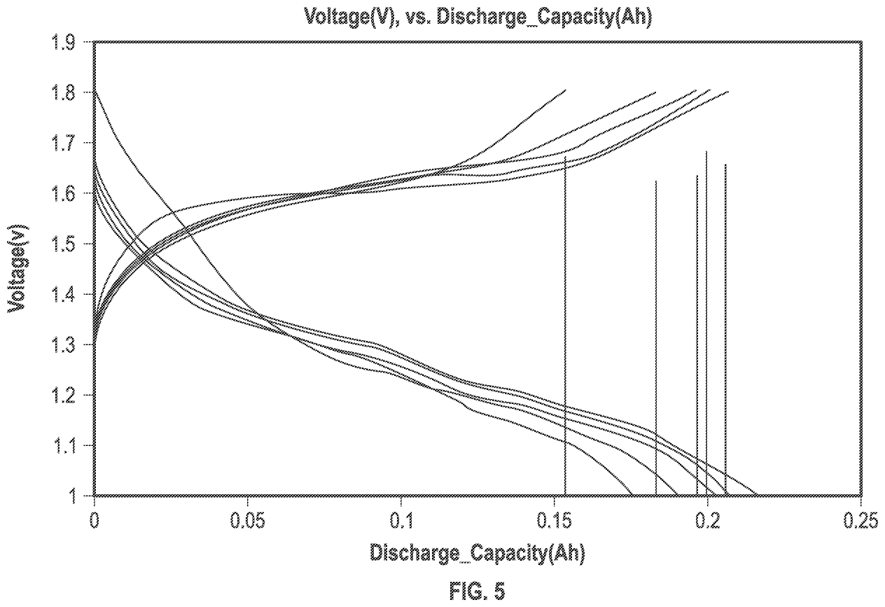

FIG. 5 is a battery voltage-capacity profile with electrolyte circulation at 0.125C. In particular, FIG. 5 shows voltage (V) virus discharge capacity (Ah). In the example battery, the electrode area is 4 cm2 with areal capacity of 50 mAh/cm2.

By applying electrolyte circulation, the improved electrolyte kinetics is capable of achieving higher areal capacity. FIG. 5 shows the battery voltage-capacity profile of one example battery that is composed of MnO2 cathode on graphite felt, Zn anode, ZnSO4/MnSO4 solution electrolyte. The battery is charging and discharging at 0.125C current rate. The battery is capable of delivering 50 mAh/cm2 areal capacity with voltage window 1-1.8V and energy efficiency around 80%.

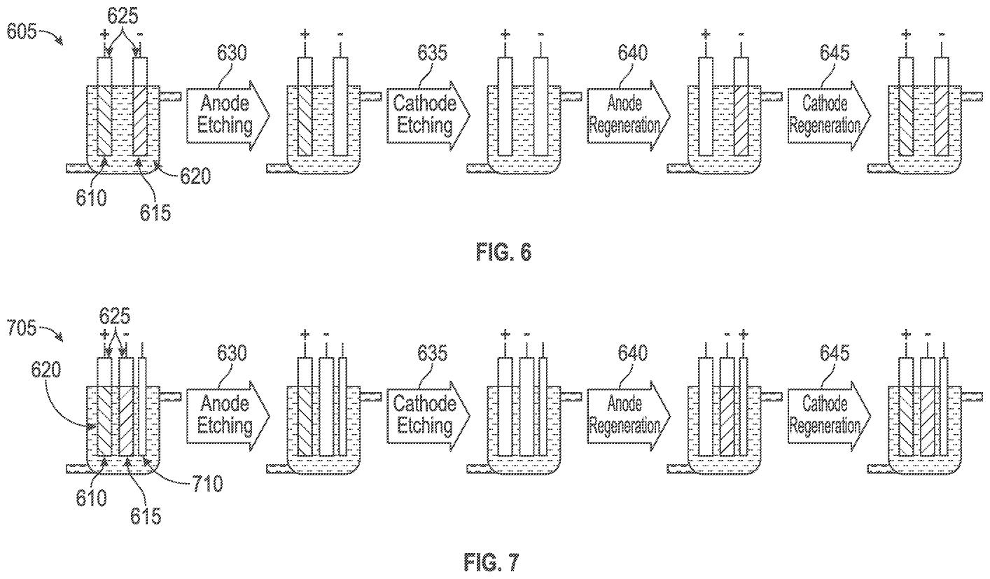

Example battery regeneration techniques are provided to regenerate the battery electrodes. Example techniques include etching and regenerating both electrodes in certain sequence through a process as shown in FIG. 6 and FIG. 7. In example embodiments, the process is designed through simply switching electrolyte and controlling battery operation, examples of the process are realized onsite or in-situ. Example embodiments are performed without battery dissembling. In other example embodiments, the battery is moved to factory for facile regeneration.

FIG. 6 is a process diagram of an example onsite or in-situ electrode regeneration with two-electrode configuration. An example battery 605 that is targeted for regeneration is composed of a cathode 610 with cathode active materials such as manganese oxide deposited onto current collector, and anode 615 with active materials such as Zn deposited onto current collector Current collectors 625 are composed of carbon felt, carbon cloth, stainless steel foil or mesh, copper foil or mesh, brass foil or mesh, titanium foil or mesh, Cu—Mn alloy foil. In block 630, anode etching may be performed by switching the electrolyte 620 with an anode etching acid, such as H2SO4, HCl. After this step, anode active materials are etched out and leave exposed current collector. In block 635, cathode etching may be performed using acids such as H2SO4, HCl, oxalic acid, etc. After this step, regeneration of the new active materials can be performed. For example, in block 640, anode regeneration is conducted by applying specified voltage and current and switching anode regeneration electrolyte containing zinc ion-based solution such as ZnSO4, Zn acetate, ZnCO3, ZnCl2, Zn(NO3)2, Na₂SO₄ or boric acid. After anode regeneration, cathode regeneration is performed in block 645 by switching to cathode regeneration electrolyte containing manganese ion based solution such as ZnSO4, Na2SO4, MnSO4, Mn acetate, MnCl2, MnCO3, or Mn(NO3)2. After regeneration, battery operating electrolyte is added to finish the regeneration process and obtain a newly regenerated battery.

Another example regeneration process for a three-electrode battery 705 as shown in FIG. 7. The three-electrode battery may include a counter electrode 710. Example counter electrodes are in mesh, rod or foil format that is composed of stainless steel, graphite, glassy carbon, Indium tin oxide, Ti, Pt or Au. The etching step is same with that described in FIG. 6, while the difference is upon anode regeneration, positive side is connected to counter electrode and negative side is connected to anode current collector to realize stable electrodeposition. After finished, battery is reconnected to cathode and anode and continue with cathode regeneration step. With three-electrode configuration, the anode regeneration can be performed independently as well.

As illustrated in FIG. 8, after etching of the anode (block 805), for example Zn, is finished, the anode regeneration liquid is filled in that the deposition of new Zn anode can be performed (block 810). The regeneration liquid is composed of ZnSO4, boric acid, Zn acetate, Zn nitrate, H2SO4, etc. The anode regeneration process can avoid preloading large amount of Zn metal with higher capital cost, and etched Zn can be directly recycled for regenerating new anode through electrodeposition method. Similarly, etched MnO2 can be conveniently converted to MnSO4 or other Mn solution to regenerate new cathode materials. During the etching and regenerating process, one or more physical treatments selected from the group consisting of applied electric field, heating, circulation, and sonication are performed to improve the efficiency.

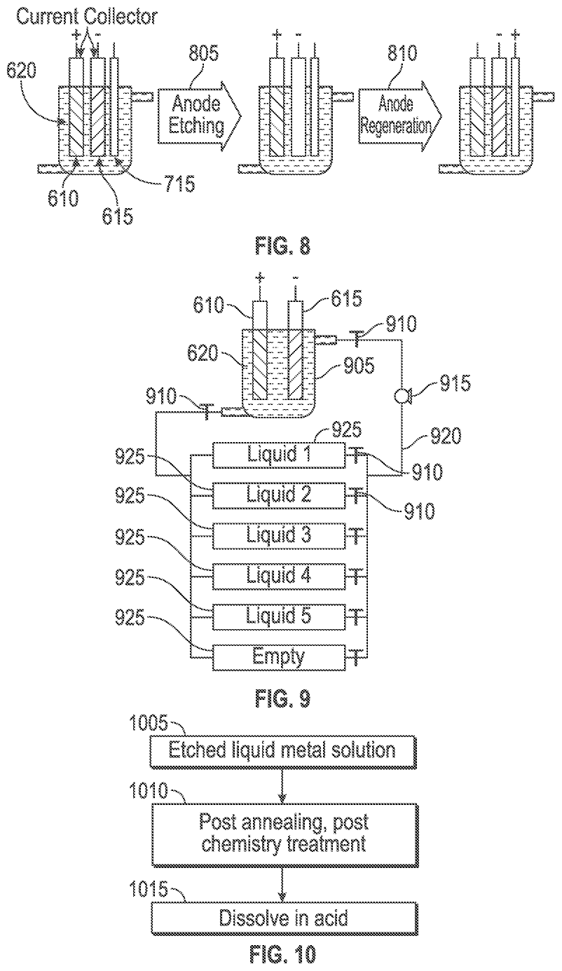

FIG. 9 is a block diagram of an example cell configuration that can control electrolyte composition and electrolyte liquid switching. The battery case 905 has connections with external liquids through tubes 920 connecting to tanks 925 storing different types of liquid. The valves 910 and pumps 915 are applied to control the desired liquid that to be injected into the battery electrolyte to tune the electrolyte composition. An empty tank is designed as a media for electrolyte switching. The desired liquid in the tanks is composed of water, MnSO4 solution, ZnSO4 solution, Na2SO4 solution, acid solution, Zn acetate solution, Mn acetate solution, Na acetate solution, ZnCl2 solution, Zn nitrate solution, boric acid, and their combinations. The configuration is capable of maintaining a consistent concentration, composition, level and volume of the battery electrolyte at all times. It is also configured to add liquid at predefined intervals i.e. every 100 cycle, 200 cycles, 300 cycles, 400 cycles, 500 cycles, 600 cycles, 700 cycles, 800 cycles, 900 cycles, 1000 cycles, 1100 cycles, 1200 cycles, 1300 cycles, 1400 cycles, 1500 cycles, 1600 cycles, 1700 cycles, 1800 cycles, 1900 cycles, or 2000 cycles.

FIG. 10 is a flow chart of an example process for post-treating the etched cathode or anode solution. Post annealing or mixture with other chemicals are followed to decompose the salts or obtain specific salt chemicals. The post annealing process includes heating the solution to 400° C., to 1500° C. under air, O2, N2 or Argon environment for 1 hour to 24 hours. In certain example embodiments, the post annealing process may including heating the solution to about 300° C., 305° C., 310° C., 315° C., 320° C., 325° C., 330° C., 335° C., 340° C., 345° C., 350° C., 355° C., 360° C., 365° C., 370° C., 375° C., 380° C., 385° C., 390° C., 395° C., 400° C., 405° C., 410° C., 415° C., 420° C., 425° C., 430° C., 435° C., 440° C., 445° C., 450° C., 455° C., 460° C., 465° C., 470° C., 475° C., 480° C., 485° C., 490° C., 495° C., 500° C., 505° C., 510° C., 515° C., 520° C., 525° C., 530° C., 535° C., 540° C., 545° C., 550° C., 555° C., 560° C., 565° C., 570° C., 575° C., 580° C., 585° C., 590° C., 595° C., 600° C., 605° C., 610° C., 615° C., 620° C., 625° C., 630° C., 635° C., 640° C., 645° C., 650° C., 655° C., 660° C., 665° C., 670° C., 675° C., 680° C., 685° C., 690° C., 695° C., 700° C., 705° C., 710° C., 715° C., 720° C., 725° C., 730° C., 735° C., 740° C., 745° C., 750° C., 755° C., 760° C., 765° C., 770° C., 775° C., 780° C., 785° C., 790° C., 795° C., 800° C., 805° C., 810° C., 815° C., 820° C., 825° C., 830° C., 835° C., 840° C., 845° C., 850° C., 855° C., 860° C., 865° C., 870° C., 875° C., 880° C., 885° C., 890° C., 895° C., 900° C., 905° C., 910° C., 915° C., 920° C., 925° C., 930° C., 935° C., 940° C., 945° C., 950° C., 955° C., 960° C., 965° C., 970° C., 975° C., 980° C., 985° C., 990° C., 995° C., 1000° C., 1005° C., 1010° C., 1015° C., 1020° C., 1025° C., 1030° C., 1035° C., 1040° C., 1045° C., 1050° C., 1055° C., 1060° C., 1065° C., 1070° C., 1075° C., 1080° C., 1085° C., 1090° C., 1095° C., 1100° C., 1105° C., 1110° C., 1115° C., 1120° C., 1125° C., 1130° C., 1135° C., 1140° C., 1145° C., 1150° C., 1155° C., 1160° C., 1165° C., 1170° C., 1175° C., 1180° C., 1185° C., 1190° C., 1195° C., 1200° C., 1205° C., 1210° C., 1215° C., 1220° C., 1225° C., 1230° C., 1235° C., 1240° C., 1245° C., 1250° C., 1255° C., 1260° C., 1265° C., 1270° C., 1275° C., 1280° C., 1285° C., 1290° C., 1295° C., 1300° C., 1305° C., 1310° C., 1315° C., 1320° C., 1325° C., 1330° C., 1335° C., 1340° C., 1345° C., 1350° C., 1355° C., 1360° C., 1365° C., 1370° C., 1375° C., 1380° C., 1385° C., 1390° C., 1395° C., 1400° C., 1405° C., 1410° C., 1415° C., 1420° C., 1425° C., 1430° C., 1435° C., 1440° C., 1445° C., 1450° C., 1455° C., 1460° C., 1465° C., 1470° C., 1475° C., 1480° C., 1485° C., 1490° C., 1495° C., or 1500° C., under air, O2, N2 or Argon environment. In example embodiments, the post anneal process may heat the solution at the temperature for about 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, or 24 hours. An example etched electrode solution is composed of MnC2O4, MnSO4 and ZnSO4 mixed salts through acid etching of MnO2 and Zn electrodes. The mixture is decomposed under 1000° C. in the air for 10 hours. The resulted products are composed of manganese oxides and zinc oxides which are then dissolved in H2SO4 to form the targeted MnSO4 and ZnSO4 solutions. The post chemistry treatment involves adding chemical additive that selectively reacts with metal ions for metal separation. One example is to increase the solution PH by adding, for example, NaOH salt into the etched electrode solution, for example, solution composed of MnC2O4, MnSO4 and ZnSO4 salts. The NaOH will precipitate Mn(OH)2 and Zn(OH)2 solids, which can be converted to MnSO4 and ZnSO4 through adding one or more of H2SO4, HNO3 and HCl acid.

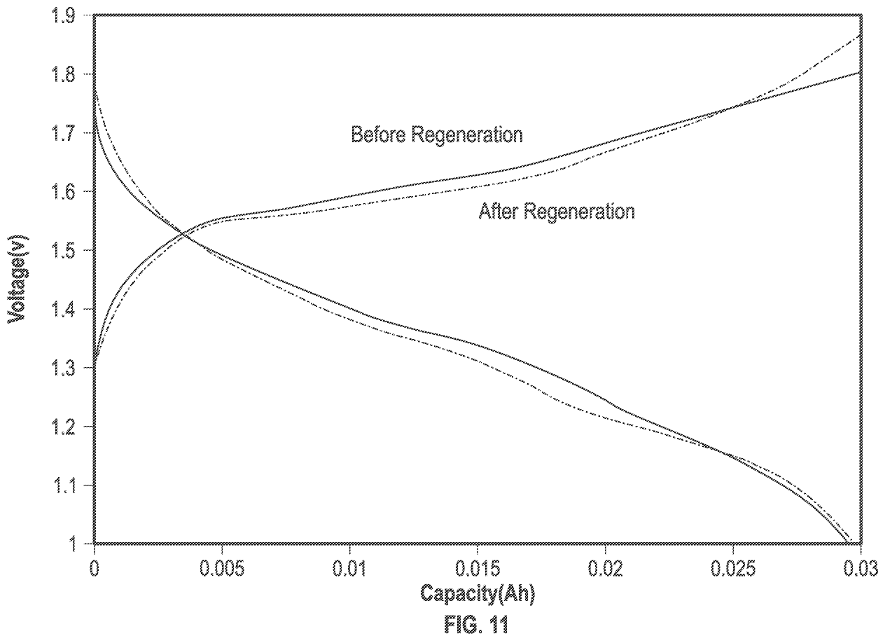

FIG. 11 is a battery voltage-capacity profile before and after cathode regeneration. Testing is performed at 1C current rate. The regeneration is demonstrated with an example battery that is composed of MnO2 cathode on graphite felt, Zn anode, and ZnSO4/MnSO4 solution electrolyte. The illustrated tests are performed at 1C current rate with areal capacity of 5 mAh/cm2. FIG. 11 compares the voltage-capacity profile before and after cathode regeneration. The regeneration well reproduced the battery performance with similar voltage window and capacity.

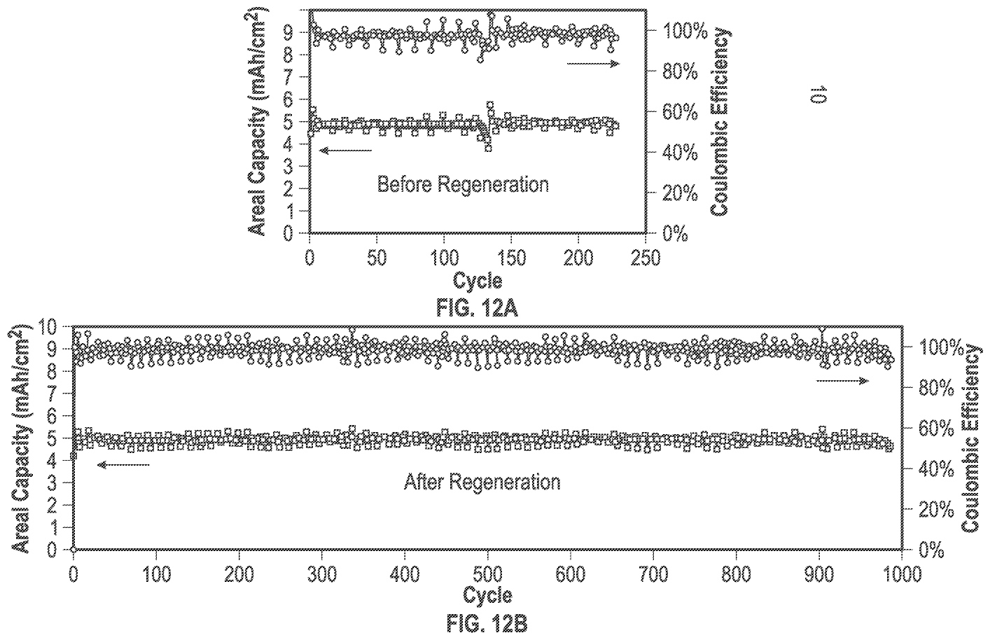

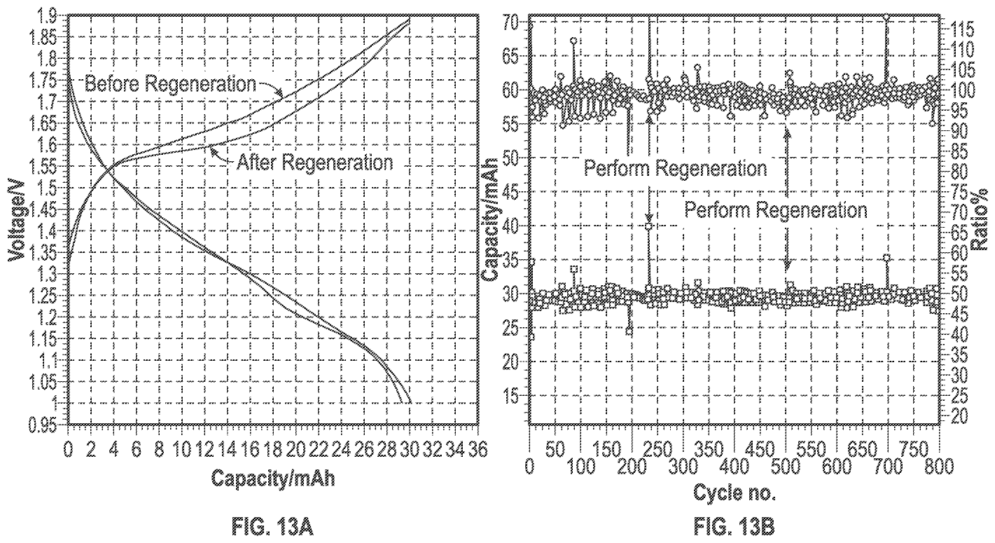

FIGS. 12A and 12B are charts of areal capacity versus cycles of cycling durability test before and after cathode regeneration. The testing is performed at 1C current rate. FIG. 12 shows that the durability after regeneration is not affected. Both before and after regeneration shows high cycling durability with consistent areal capacity at 5 mAh/cm2 and coulombic efficiency over 99%. FIG. 13 demonstrates the anode regeneration. FIG. 13a compares the voltage-capacity profile before and after anode regeneration. The regeneration well reproduced the battery performance with similar voltage window between 1 V and 1.9 V, and capacity at 30 mAh. FIG. 13b further shows that the regeneration keeps the high battery durability, with consistent areal capacity at 30 mAh and coulombic efficiency over 99%.

FIG. 13A is a chart of voltage versus capacity for charging and discharging for a battery before and after anode regeneration. FIG. 13B is a chart of cycling durability test before and after anode regenerations. The testing is performed at 1C current rate. An interface layered is coated onto current collector to improve battery performance.

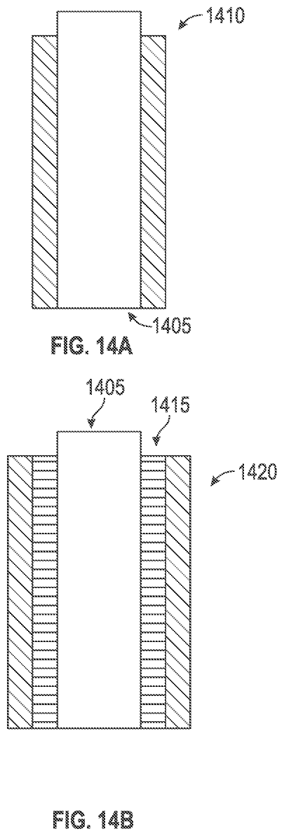

In certain example embodiments, the capacity regeneration reaction will consume Mn salts that leads to operational materials cost. By improving the current collector and active materials interface stability, the utilization frequency of capacity regeneration reaction can be reduced, thus lower Mn salts consumption. To address this issue, in example embodiments, a bonding interface between active materials and current collector is introduced. One example is MnO2 active cathode materials and current collector is graphite felt or graphite cloth that is composed of graphite fiber which provides high surface area. While MnO2 and bare fiber binding is not strong and lead to mechanical instability and particle falling off upon cycling, the carbon fiber surface pretreatment through oxidation, conductive polymer coating, oxide coating and carbon nanotubes growth is performed. These treatments can strengthen the surface chemical binding with MnO2 and increase physical roughness for higher mechanical stability, thus stabilizing the cathode electrode. The concept is illustrated in FIGS. 14A and 14B. FIGS. 14A and 14B are block diagram of example current collectors. In FIG. 14A, carbon fiber 1405 is coating in deposited electrode materials 1410. In FIG. 14B, before growing electrode active materials 1420 onto carbon fiber 1405, an interface layer 1415 on the fiber is firstly coated. In example embodiments, the interface layer 1415 is composed of conductive polymer, carbon nanotubes, black carbon, graphite, carbon fibers, indium tin oxide, indium oxide, tin oxide, lead oxide, tungsten carbide.

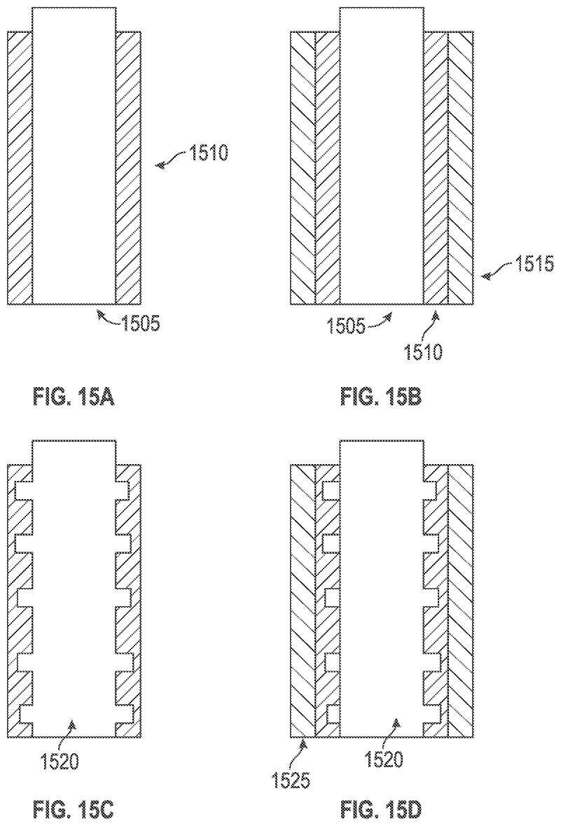

Example battery systems include 3D current collectors combining with a surface coating layer is applied to improve metal anode performance. In example 3D current collectors, the substrate has multiple surfaces, instead of foil and sheet that is 2D substrate with only single surface. Both foam, mesh, porous carbon, porous metal substrate are 3D current collectors. Example materials for current collectors includes one or more of carbon paper, carbon cloth, carbon felt, carbon foil, carbon foam, conductive polymers, Ni, carbon steel, Cr, copper, aluminum, manganese, stainless steel and their alloys. The 3D current collector can increase surface area for more zinc seeding sites that reduce dendrite growth rate. An example surface coating layer through chemical or electrochemical deposition can help protect anode surface corrosion and acidic etching. The surface layer can also be applied through in-situ electrodeposition method by introducing electrolyte additives such as surfactants and monomers that shows good effects in suppressing metal dendrite growth. The concepts have been illustrated in FIGS. 15A-D. FIGS. 15A and 15B are non-3D current collectors with metal substrate 1505, deposited electrode materials 1510, and surface coating 1515. Example embodiments of battery systems may include these non-3D current collectors. FIGS. 15C and 15D are block diagrams of 3D current collectors with a 3D substrate 1520, deposited electrode material 1520 and surface coating 1525. Example battery systems of the present disclosure may include these 3D substrates 1520. The beneficial effects of 3D current collector versus 2D foil current collector are proved with an example battery cell composed of Zn—Zn symmetric electrodes in ZnSO4 solution electrolyte. The Zn is electrodeposited onto Cu metal substrate.

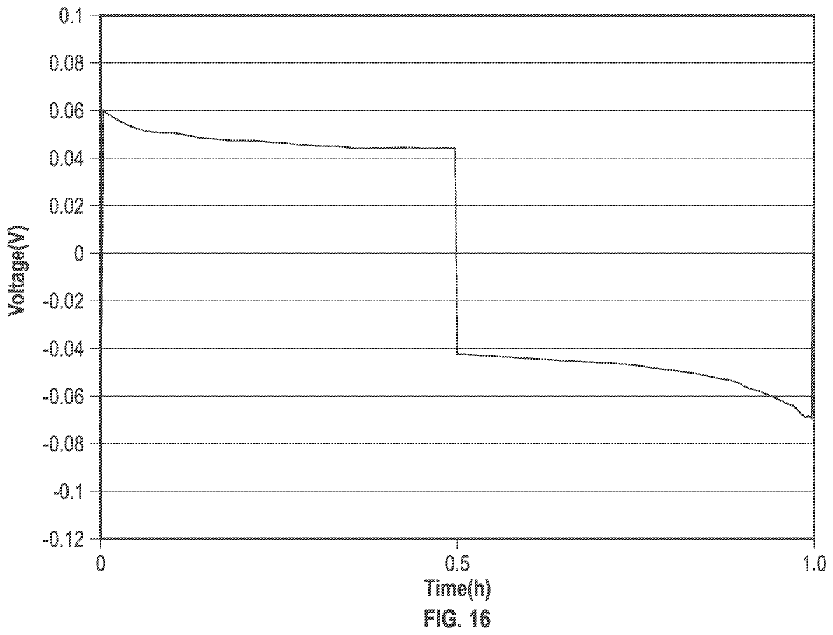

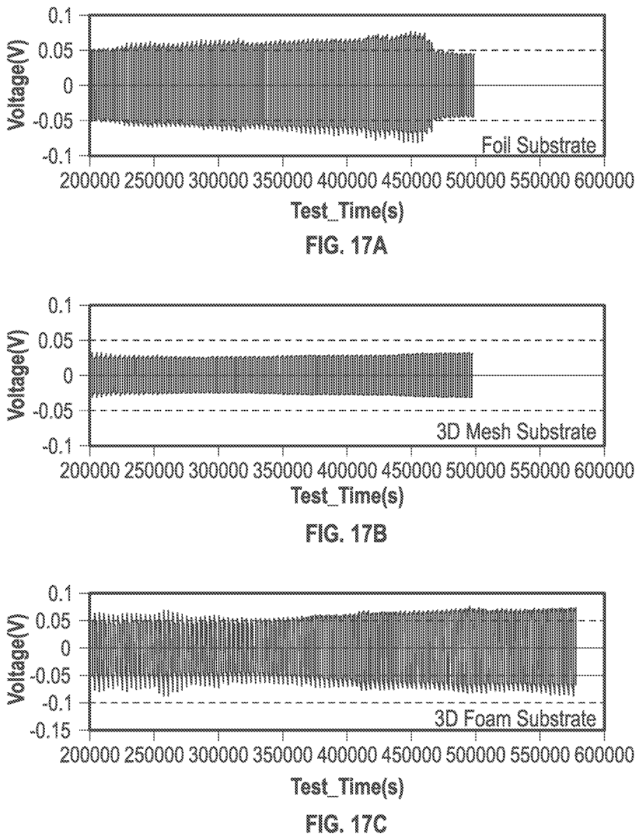

FIG. 16 is a plot of the voltage-time profile of the cell with 3D substrate, for example, Cu foam, as the current collector. The charging/discharging test is performed at 2C rate with 50% Zn utilization. The cell shows good conductivity with a symmetric average voltage of 50 mV. When performing durability test, the 3D substrate demonstrates better performance than 2D substrate. As shown in FIG. 17A, the Zn deposited onto 2D Cu foil substrate shows short-circuit after 470,000 s of operation whereas the 3D foam substrate (FIG. 17C) shows the longest cycling life over 570,000 s of operation.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims. Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee. The indefinite articles “a” or “an,” as used in the claims, are each defined herein to mean one or more than one of the elements that it introduces.

A number of examples have been described. Nevertheless, it will be understood that various modifications can be made. Accordingly, other implementations are within the scope of the following claims.

What is claimed is:

1. A battery system, comprising:
a battery comprising a plurality of cells, each cell comprising:
a cathode comprising cathode electrode materials disposed on a first current collector;
an anode comprising anode electrode materials disposed on a second current collector;
a separator or spacer disposed between the cathode and the anode;
an electrolyte to fill the battery in the spaces between electrodes; and
an electrolyte circulation system.

2. The battery system of claim 1, wherein the electrolyte circulation system comprises a controller with a processor and a memory, the memory including executable instructions that, when executed, cause the processor to control one or more of a circulation time and a circulation frequency.

3. The battery system of claim 2 wherein the controller further includes executable instructions that, when executed cause the processor to control one or more of a flow rate, an electrolyte level, an electrolyte volume, an electrolyte concentration, and an electrolyte composition.

4. The battery system of claim 2 wherein the controller further includes executable instructions that, when executed cause the processor to performing a healing reaction in the battery.

5. The battery system of claim 1, wherein one or more of the first current collector and second current collector comprise conductive materials selected from the group consisting of carbon paper, carbon cloth, carbon felt, carbon foil, carbon foam, conductive polymers, metal sheet, metal mesh, mesh screen, metal foam, wherein metal in the metal sheet, metal mesh, metal screen, or metal foam includes one or more of Ni, carbon steel, Cr, copper, aluminum, and stainless steel.

6. The battery system of claim 1, the first current collector and the second current collector each comprise a surface coated in one or more of carbon black, conductive graphite, carbon nanotube, activated carbon, amorphous carbon, conductive polymer, metal particles, Ni, Cr, copper, aluminum, stainless steel.

7. The battery system of claim 1, wherein the cathode electrode materials comprise one or more of manganese oxide, nickel oxide, vanadium oxide, titanium oxide, iron oxide and further wherein the cathode electrode materials further comprise metal doping selected from the group consisting of aluminum, nickel, lead, magnesium, boron, cobalt, titanium, chromium, vanadium.

8. The battery system of claim 1, wherein the anode electrode materials comprise one or more of zinc, aluminum, copper, nickel, lead, magnesium, boron, cobalt, titanium, chromium, vanadium, carbon nanotube, carbon black, amorphous carbon, activated carbon, hard carbon, polyvinylidene fluoride (PVDF), polytetrafluoroethylene (PTFE), conductive polymers, and sodium vanadium phosphate.

9. The battery system of claim 8, further comprising a current collector comprising multiple dimensions of surfaces, metal foam, metal mesh, carbon felt, and cloth.

10. The battery system of claim 8, wherein the anode electrode materials is coated with conductive polymers, oxides, carbides, carbon, surfactants.

11. The battery system of claim 1, wherein the electrolyte comprises:
one or more solvents selected from the group consisting of water and organic solvents;
one or more additive cations selected from the group consisting of Zn2+, Mn2+, proton, Al3+, Na+, K+, Mg2+, Ni2+, Cu2+, Fe3+, Co2+, and NH4+; and
anions selected from the group consisting of PO43−, SO42−, CH3COO−, Cl−, Br− and NO3−; and
one or more polymer additives selected from the group consisting of ionomers, pyrrole, aniline, carbonate, vinyl acetate, ethylene glycol, and methyl methacrylate.

12. The battery system of claim 1, wherein the separator comprises one or more of filter paper, fiberglass paper, fiber cloths, cellulose, wood fibers, polyethylene separator, and plastic mesh.

13. The battery system of claim 1, wherein the electrolyte circulation system comprises one or more of liquid transfer tubes connected to battery case, pumps, propellers, circulation controllers, valves and liquid tanks.

14. The battery system in claim 13, wherein pump comprises one or more of a rotary lobe pump, a progressive cavity pump, a rotary gear pump, a piston pump, a diaphragm pump, a screw pump, a gear pump, a hydraulic pump, a rotary vane pump, a peristaltic pump, a rope pump, a flexible impeller pump, and a magnetic pump.

15. The battery system in claim 13, wherein the circulation controller is configured to determine one or more of battery voltage, current, capacity, power, time to control the pump on/off time/frequency and flow rate.

16. The battery system of claim 1, wherein the electrode comprises a current collector, electrode materials, and an interface coating layer in-between.

17. The battery system of claim 13, wherein the interface coating comprises one or more of a conductive polymer, carbon nanotubes, black carbon, graphite, carbon fibers, indium tin oxide, indium oxide, tin oxide, lead oxide, and tungsten carbide.

18. A battery regeneration method, comprising:
etching an anode by providing an anode etching liquid in a battery case;
etching a cathode by providing an cathode etching liquid in the battery case;
regenerating an anode by providing an anode regeneration liquid in the battery case; and
regenerating a cathode by providing a cathode regeneration liquid in the battery case.

19. The method of claim 18, wherein one or more of the anode etching liquid or the cathode etching liquid comprise:
one or more acidic solvents selected from the group consisting of hydrochloric acid, sulfuric acid, nitric acid, phosphoric acid, oxalic acid, citric acid; and wherein the method further comprises:
preforming one or more physical treatments selected from the group consisting of applied electric field, heating, circulation, and sonication during etching.

20. The method in claim 18, wherein one or more of the cathode regeneration liquid and the anode regeneration liquid comprise:
one or more solvents selected from the group consisting of water and organic solvents; additive cations selected from the group consisting of Zn2+, Mn2+, proton, Al3+, Na+, K+, Mg2+, Ni2+, Cu2+, Fe3+, Co2+, and NH4+; and
anions selected from the group consisting of PO43−, SO42−, CH3COO−, Cl−, Br− and NO3−; and wherein the method further comprises:
preforming one or more physical treatments selected from the group consisting of applied electric field, heating, circulation, and sonication during regeneration.

21. The method in claim 18, wherein the battery comprises a cathode and an anode.

22. The method of claim 18 wherein the comprises a cathode, an anode and a counter electrode, wherein the counter electrode comprises one or more of stainless steel, graphite, glassy carbon, Ti, Pt and Au.

23. The method in claim 18, further comprising:
heating a solution to between 400° C. and 1200° C. under air, O2, N2 or Argon environment for 1 hour to 24 hours;
adding a NaOH salt to the solution for metal solid precipitation; and
adding an acid comprising one or more of H2SO4, HNO3 and HCl to dissolve precipitated solid and decomposed metal oxide.
